(19) United States
(12) Patent Application Publication
(10) Pub. No.: US 2026/0099051 A1
(43) Pub. Date: Apr. 9, 2026

(54) INJECTION MOLDED LIGHT-GUIDING MEMBER AND HEAD-MOUNTED DISPLAY

(71) Applicant: ASAHI KASEI KABUSHIKI KAISHA, Tokyo (JP)

(72) Inventors: Yutaka TADA, Tokyo (JP); Yuta YAMAHATA, Tokyo (JP); Akito NAKAI, Tokyo (JP)

(73) Assignee: ASAHI KASEI KABUSHIKI KAISHA, Tokyo (JP)

(21) Appl. No.: 19/350,293

(22) Filed: Oct. 6, 2025

(30) Foreign Application Priority Data
Oct. 9, 2024 (JP) 2024-177492
Aug. 12, 2025 (JP) 2025-134511

(51) Int. Cl. G02B 27/01; B29D 11/00; B29K 33/00

(52) U.S. Cl. CPC G02B 27/0172; B29D 11/00663; B29K 2033/12

(57) ABSTRACT

Provided is an injection molded light-guiding member including a substrate section, an input coupler for causing light from an image display element to enter the light-guiding member, two surfaces of a wave-guiding section that are opposite to each other and that guide incident light through repeated reflection, and an output coupler for extracting light toward an eye of an observer from a light-guiding body through any function among refraction, diffraction, and reflection of guided light, wherein an absolute value of a photoelastic coefficient is 10×10⁻¹² Pa⁻¹ or less, and a partial reflecting mirror that transmits a portion and reflects a remaining portion of light is formed at at least one surface among a total of three surfaces consisting of the two surfaces of the wave-guiding section and a surface of the output coupler.

### TECHNICAL FIELD

The present disclosure relates to an injection molded light-guiding member and a head-mounted display.

### BACKGROUND

In recent years, much effort has been focused on the development of devices for virtual reality (hereinafter, referred to as “VR”) and augmented reality (hereinafter, referred to as “AR”), and also for extended reality (hereinafter, referred to as “XR”), which is used as a general term encompassing VR and AR.

Although the boundaries of the frameworks of these devices are being blurred, a device with which the real world is visible in a see-through manner through a lens in front of an eye (eyepoint) of an observer, in particular, belongs to the category of AR head-mounted displays. A specific example of an optical system in the basic configuration of an AR head-mounted display is illustrated in FIG. 1.

Referring to FIG. 1, in the basic configuration of an AR head-mounted display, image light is created by an image display device 12, this image light is then caused to enter a transparent light-guiding member 11 using a prism, mirror, diffraction grating, or holographic element as an input coupler installed at a light entry section 111 of the transparent light-guiding member 11, is guided through total internal reflection by a wave-guiding section (outer side wave-guiding section 113 and eye side wave-guiding section 112) inside of the light-guiding member 11, is output toward an eye of a user by a mirror, diffraction grating, or holographic element serving as an output coupler 114 arranged such as to disrupt total internal reflection, and is extracted through a light extraction section 115 such that the real world (external light 14) can be observed by a pupil 13 of an observer in a see-through manner from a transparent waveguide while the image light can also be observed by the pupil 13 of the observer in a superimposed form with the real world through the optical system described above. Examples of such devices are disclosed in Patent Literature (PTL) 1 and 2.

These devices are required to be comfortable to wear for the observer without causing discomfort and to display an image in a manner that does not feel unnatural during viewing. There is also demand for reducing the overall weight, size, and thickness of these devices while also achieving an optical system with a wide viewing angle in order that large screen display of an image with various information can be achieved. Moreover, optical systems having the guiding of image light inside of a thin-walled light-guiding member as a feature are an indispensable technology for the realization of thin and light devices, and the realization of such optical systems to a high level is expected to contribute to the post-smartphone era.

As one example of such an optical system, PTL 1 discloses an optical system in which image light is collimated and caused to enter a waveguide, is guided by total internal reflection in the waveguide using diffraction by a volume hologram recorded as an interference pattern with an inclined refractive index distribution that is formed as an input coupler, and then light is diffracted by a volume hologram formed as an output coupler at an eye side and is extracted toward an eye of an observer. In another example, PTL 2 discloses a configuration in which a plurality of wire grid mirrors are arranged with reflection axes alternately orthogonal at an output coupler.

### CITATION LIST

### Patent Literature

PTL 1: WO 2018/012108 A1
PTL 2: JP 2019-101370 A
PTL 3: JP 2021-162621 A
PTL 4: WO 2021/182598 A1
PTL 5: JP 2023-059010 A

### SUMMARY

However, with an optical system such as described above, there is a concern that in a case in which a prism, mirror, diffraction grating, or holographic element used in the input coupler or output coupler has polarization selectivity, disruption of polarization or localized polarization of image light may arise while the image light is being guided inside of the light-guiding member, and this may have a negative influence on image light that is extracted by the output coupler. Although the use of a light-guiding member made of glass means that the effect of polarization selectivity is small and enables the extraction of image light as designed, high refractive index and high flatness glass that is designed for waveguides is extremely expensive, and this is a major factor impeding the proliferation of AR headsets aimed at succeeding smartphones. For this reason, there is demand for the use of resin waveguides and resin light-guiding members, but the effect of polarization selectivity has not been adequately verified.

Moreover, in a situation in which a resin light-guiding member is used when total internal reflection is to be used to guide image light at a wave-guiding section such as in a configuration disclosed in PTL 3, there is a lack of selection choices of materials having a large refractive index such as glass when using a resin composition, and the refractive index of a substrate is small, resulting in a problem of a large critical angle. Moreover, since it is necessary to guide light at an incident angle that is not less than the critical angle in order to maintain total internal reflection, it is not possible to design a fine eye box because an image cannot be guided at a fine pitch, and there is also a problem that the viewing angle related to the size of a virtual image (angle of view of virtual image) can also not be widened.

The use of a resin light-guiding member is also problematic due to the difficulty of obtaining a molded piece having high flatness (parallelism). The production of a cast plate by causing methyl methacrylate (MMA) monomer to flow into a synthetic quartz cell having high specularity and a thickness tolerance of 1 μm and curing the monomer by radical polymerization and of a transparent plate having high flatness through chemical polishing of such a cast plate is a conventional technique that has previously been studied (PTL 3 and 4). However, there is strong demand for a light-guiding member obtained by injection molding because the aforementioned technique has poor productivity due to mold durability and processing process length, and also because it is not possible to provide a curved surface for eyesight correction when use as a lens of glasses is envisaged and it is difficult to impart a shape for fixing to a housing.

Moreover, although PTL 4 describes the production of a light-guiding plate equipped with a diffraction grating by injection molding and also describes preferable flatness and parallelism, PTL 4 does not provide any evaluation results for these properties in the examples and merely indicates the public scope that is considered ideal. Therefore, polishing is fundamentally taken as a presumption for realizing high surface accuracy, and techniques that can be implemented even in the case of a curved light-guiding plate or the like, for example, have not been adequately investigated.

The present disclosure was made in light of the circumstances described above and is directed at the provision of an injection molded light-guiding member and a head-mounted display including this light-guiding member that can provide an image without distortion caused by facial collapse while also inhibiting faults such as non-uniformity of brightness, non-uniformity of color, and rainbow effect even in the case of a light-guiding member where a partial reflecting mirror having polarization selective reflectance characteristics is formed on at least one surface among an input coupler, a wave-guiding section, and an output coupler.

The present disclosure was achieved as a result of diligent investigation by the inventors in view of the problems described above.

The inventors discovered that with a light-guiding member that is formed from a thermoplastic resin composition having sufficiently high heat resistance, having a small photoelastic coefficient, and having a cyclic structure in a main chain or a side chain and that has little anisotropy of residual stress during molding and excellent surface accuracy, it is possible to restrict birefringence after molding to a low level and to provide a clear image with little change of surface accuracy or dimensions caused by a change of environment. The inventors also discovered that by using a partial reflecting mirror that transmits a portion and reflects a remaining portion of light, it is possible to obtain a light-guiding member that solves the problem of critical angle described above while also being capable of imparting a new function.

Specifically, the present disclosure is as set forth below.

[1] An injection molded light-guiding member used in an image display device having an ocular optical system that guides light toward an eyeball of an observer from an image display element, the injection molded light-guiding member comprising:
a substrate section;
an input coupler for causing light from the image display element to enter into a light-guiding body;
two surfaces of a wave-guiding section that are opposite to each other and that guide incident light through repeated reflection; and
an output coupler for extracting light toward an eye of the observer from the light-guiding member through any function among refraction, diffraction, and reflection of guided light, wherein
an absolute value of a photoelastic coefficient is 10×10⁻¹² Pa⁻¹ or less,
a partial reflecting mirror that transmits a portion and reflects a remaining portion of light is formed at at least one surface among a total of three surfaces consisting of the two surfaces of the wave-guiding section and a surface of the output coupler,
the partial reflecting mirror has a difference of reflectance of not less than 10% and less than 40% between first polarized light that is S-polarized light upon reflection by the partial reflecting mirror and P-polarized light that is second polarized light orthogonal to the first polarized light at an incident angle of 30°,
the wave-guiding section has an in-plane retardation of 20 nm or less in an effective area thereof, and
the substrate section is formed from a thermoplastic resin composition having a cyclic structure in a main chain or a side chain and has a glass-transition temperature (Tg) of 115° C. to 150° C.

[2] The injection molded light-guiding member according to [1], wherein
a minimum distance between the two surfaces of the wave-guiding section is not less than 0.6 mm and not more than 25 mm,
a projection length of the light-guiding member in a wave-guiding direction is not less than 10 mm and not more than 50 mm, and
the two surfaces of the wave-guiding section each have a PV value of 10.0 μm or less in an effective area where light is guided.

[3] The injection molded light-guiding member according to [1] or [2], wherein one of the two surfaces of the wave-guiding section is an outer side wave-guiding section, and the partial reflecting mirror that transmits a portion and reflects a remaining portion of light is formed at the outer side wave-guiding section.

[4] The injection molded light-guiding member according to any one of [1] to [3], wherein, in a situation in which first polarized light having a wavelength of 500 nm to 600 nm that is S-polarized light in reflection by the wave-guiding section enters through a light entry section, is guided by the wave-guiding section, and is subsequently extracted from a light extraction section via the output coupler, a value determined when a ratio Tp/Tc of an amount of light Tp that is extracted via a polarizing plate arranged with a transmission axis matching an axis of the first polarized light and an amount of light Tc that is extracted via a polarizing plate arranged with a transmission axis orthogonal to the axis of the first polarized light is divided by a ratio Rs/Rp of reflectance of S-polarized light and reflectance of P-polarized light by the partial reflecting mirror at a surface where the ratio Rs/Rp is largest is 5 or more.

[5] The injection molded light-guiding member according to [4], wherein the value determined when the ratio Tp/Tc is divided by the ratio Rs/Rp at the surface where the ratio Rs/Rp is largest is 10 or more.

[6] The injection molded light-guiding member according to any one of [1] to [5], wherein the partial reflecting mirror that transmits a portion and reflects a remaining portion of light is formed at the output coupler.

[7] The injection molded light-guiding member according to any one of [1] to [6], wherein the thermoplastic resin composition contains 0.5 mass % to 2.8 mass % of a higher fatty acid ester.

[8] The injection molded light-guiding member according to any one of [1] to [7], wherein the thermoplastic resin composition is a methacrylic resin composition.

[9] A head-mounted display comprising the injection molded light-guiding member according to any one of [1] to [8].

[10] The head-mounted display according to [9], wherein at either or both of a light output section and an eye side wave-guiding section, reflectance of S-polarized light is larger than reflectance of P-polarized light at an incident angle of 5°, and a difference between the reflectance of S-polarized light and the reflectance of P-polarized light is 5% or more.

[11] The head-mounted display according to [9] or [10], wherein the partial reflecting mirror that transmits a portion and reflects a remaining portion of light is formed at part or all of both of the two surfaces of the wave-guiding section, and light is guided at an incident angle that is smaller than a critical angle of the substrate section.

[12] The head-mounted display according to any one of [9] to [11], wherein a linear polarizing plate is included on a straight line that joins the eyeball of the observer and the output coupler of the light-guiding member and that extends to the outside world.

[13] The head-mounted display according to any one of [9] to [12], wherein a linear polarizing plate and a half-wave plate or a retardation layer that imparts half-wave retardation are included in order from an outside world side on a straight line that joins the eyeball of the observer and the output coupler of the light-guiding member and that extends to the outside world.

[14] The head-mounted display according to [9], wherein:
at either or both of a light output section and an eye side wave-guiding section, reflectance of S-polarized light is larger than reflectance of P-polarized light at an incident angle of 5°, and a difference between the reflectance of S-polarized light and the reflectance of P-polarized light is 5% or more;
the partial reflecting mirror that transmits a portion and reflects a remaining portion of light is formed at part or all of both of the two surfaces of the wave-guiding section, and light is guided at an incident angle that is smaller than a critical angle of the substrate section;
a linear polarizing plate is included on a straight line that joins the eyeball of the observer and the output coupler of the light-guiding member and that extends to the outside world; or
a linear polarizing plate and a half-wave plate or a retardation layer that imparts half-wave retardation are included in order from an outside world side on a straight line that joins the eyeball of the observer and the output coupler of the light-guiding member and that extends to the outside world.

According to the present disclosure, it is possible to provide an injection molded light-guiding member and a head-mounted display including this injection molded light-guiding member that can provide an image while also inhibiting faults such as non-uniformity of brightness, non-uniformity of color, and rainbow effect even in a situation in which a partial reflecting mirror having polarization selective reflectance characteristics is formed at an input coupler, a wave-guiding section, and/or an output coupler.

### BRIEF DESCRIPTION OF THE DRAWINGS

In the accompanying drawings:

FIG. 1 is a conceptual diagram of an optical system for describing a basic configuration of an AR head-mounted display;

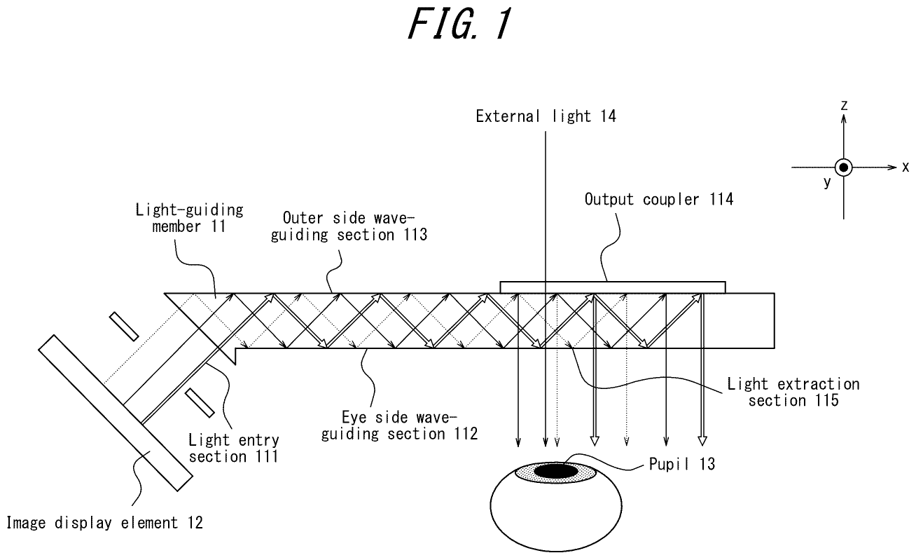

FIG. 2A is a conceptual diagram of an optical system modeled on an AR head-mounted display that includes a light-guiding member according to one embodiment of the present disclosure;

FIG. 2B is a conceptual diagram of an optical system modeled on an AR head-mounted display that includes a light-guiding member according to one embodiment of the present disclosure;

FIG. 2C is a conceptual diagram of an optical system modeled on an AR head-mounted display that includes a light-guiding member according to one embodiment of the present disclosure;

FIG. 3 is a conceptual diagram for describing measurement of polarization retention characteristics in the case of an optical system having multiple eyepoints;

FIG. 4 is a diagram for describing the vibration axes of S-polarized light and P-polarized light upon reflection inside of a light-guiding member;

FIG. 5 is a diagram for describing the vibration axes of S-polarized light and P-polarized light upon reflection at the ground, water surface, or the like;

FIG. 6 is a conceptual diagram for describing a configuration in which a linear polarizing plate is included in order to block polarized light that is intense reflected light of external light;

FIG. 7 is a conceptual diagram for describing a configuration in which a linear polarizing plate and a retardation plate are included in order to block polarized light that is intense reflected light of external light while also increasing utilization efficiently of light that is guided inside of a light-guiding member;

FIG. 8 is a conceptual diagram illustrating measurement of a PV value at the surface of a substrate of a light entry section, a wave-guiding section, an input coupler, and an output coupler;

FIG. 9 illustrates an example of polarized light reflectance characteristics of a partial reflecting mirror in a present embodiment;

FIG. 10A is a conceptual diagram illustrating an outline of a test device in evaluation of polarization retention characteristics in a case in which light enters at an incident angle of 45° relative to a wave-guiding section;

FIG. 10B is a conceptual diagram illustrating an outline of a test device in evaluation of polarization retention characteristics in a case in which light enters at an incident angle of 40° relative to a wave-guiding section;

FIG. 11 is a conceptual diagram of image evaluation in which a light-guiding member of a present embodiment is used in combination as an AR headset;

FIG. 12 is a conceptual diagram of molded article holding that was implemented in Example 2 as one example pertaining to a method of holding a molded article in air after molding; and

FIG. 13 is a conceptual diagram of configuration of an AR headset indicated in Example 16 that is one present embodiment.

### DETAILED DESCRIPTION

The following provides a detailed description of an embodiment of the present disclosure (hereinafter, referred to as the “present embodiment”). However, the present disclosure is not limited by the following description and can be implemented with various alterations within the essential scope thereof.

In description of the polarization state and retardation of light, states expressed by concepts such as linear polarization, circular polarization, elliptical polarization, ¼λ (quarter-wave) retardation, ½λ (half-wave) retardation, and so forth generally refer to broad states having a certain range. Accordingly, the essential effects according to the present disclosure are not impaired by deviation of these states. Moreover, retardation arising at an optical element is retardation with respect to light of wavelength k, and any wavelength in the visible region can generally be selected as the wavelength k. For example, the wavelength λ may be 587.6 nm but is not limited thereto.

### DESCRIPTION OF TERMINOLOGY

The term “hydrocarbon group” as used in the present specification refers to a monovalent group and encompasses linear, branched, and cyclic saturated hydrocarbon groups, unsaturated hydrocarbon groups, and aromatic groups. For example, a “hydrocarbon group” is one type of group selected from the group consisting of alkyl groups (for example, following alkyl groups), alkenyl groups (for example, following alkenyl groups), aryl groups (for example, following aryl groups), aryloxy groups (for example, following aryloxy groups), aralkyl groups (for example, following aralkyl groups), and alkoxy groups (for example, following alkoxy groups).

The term “aliphatic hydrocarbon group” as used in the present specification refers to a group resulting from the removal of at least one hydrogen atom bonded to an aliphatic carbon of an aliphatic compound. In more detail, a monovalent aliphatic hydrocarbon group is a group resulting from the removal of one hydrogen atom bonded to an aliphatic carbon of an aliphatic compound, whereas a divalent aliphatic hydrocarbon group is a group resulting from the removal of two hydrogen atoms that are each bonded to an aliphatic carbon of an aliphatic compound. Note that the term “aliphatic hydrocarbon group” as used in the present specification refers to a group where a main chain is an aliphatic hydrocarbon and that the group may include an aromatic ring or the like as part thereof. A divalent aliphatic hydrocarbon group may, for example, be an optionally substituted alkylene group, an optionally substituted cycloalkylene group, an optionally substituted alkenylene group, an optionally substituted cycloalkenylene group, or an optionally substituted alkpolyenylene group (group in which the number of double bonds is preferably 2 to 10, more preferably 2 to 6, even more preferably 2 to 4, and further preferably 2).

The term “aromatic hydrocarbon group” as used in the present specification refers to a group resulting from the removal of one hydrogen atom from an aromatic ring of an aromatic hydrocarbon compound. Specific examples of aromatic hydrocarbon groups include a phenyl group, a biphenyl group, a tolyl group, an indenyl group, a naphthyl group, an anthryl group, a fluorenyl group, a pyrenyl group, a phenanthryl group, and a mesityl group.

An arylalkyl group referred to in the present specification may be a benzyl group, a phenylethyl group, a phenylpropyl group, a naphthylmethyl group, a naphthylethyl group, a naphthylpropyl group, or the like, for example.

An aryl group referred to in the present specification may be a phenyl group, a tolyl group, a xylyl group, a naphthyl group, a biphenyl group, an anthracenyl group, a phenanthryl group, or the like, for example.

An alkyl group referred to in the present specification may be linear or branched and may be a methyl group, an ethyl group, an n-propyl group, an isopropyl group, an n-butyl group, a sec-butyl group, an isobutyl group, a tert-butyl group, a 2-methylbutyl group, an n-pentyl group, a 2-pentyl group, a 3-pentyl group, a 2,2-dimethylpropyl group, an n-hexyl group, a heptyl group, an n-octyl group, a 1,1,3,3-tetramethylbutyl group, a 2-ethylhexyl group, a nonyl group, a decyl group, an undecyl group, a dodecyl group, or the like, for example.

A halogen atom referred to in the present specification may be a fluorine atom, a chlorine atom, a bromine atom, an iodine atom, or the like, for example.

An alkoxy group referred to in the present specification may be a methoxy group, an ethoxy group, an n-butoxy group, a methoxyethoxy group, or the like, for example.

A cycloalkyl group referred to in the present specification may be a cyclopropyl group, a cyclopropylmethyl group, a cyclobutyl group, a cyclopentyl group, a cyclohexyl group, a cyclohexylmethyl group, a trimethylcyclohexyl group, a thujyl group, a norbornyl group, a bornyl group, a norcaryl group, a caryl group, a menthyl group, a norpinyl group, a pinyl group, a 1-adamantyl group, a 2-adamantyl group, or the like, for example.

### [Injection Molded Light-Guiding Member]

An injection molded light-guiding member of the present embodiment is an injection molded light-guiding member (hereinafter, also referred to simply as a “light-guiding member”) used in an image display device having an ocular optical system that guides light toward an eyeball of an observer from an image display element and includes:
a substrate section;
an input coupler for causing light from the image display element to enter into a light-guiding body;
two surfaces of a wave-guiding section that are opposite to each other and that guide incident light through repeated reflection; and
an output coupler for extracting light toward an eye of the observer from the light-guiding body through any function among refraction, diffraction, and reflection of guided light, wherein
an absolute value of a photoelastic coefficient is 10×10⁻¹² Pa⁻¹ or less,
a partial reflecting mirror that transmits a portion and reflects a remaining portion of light is formed at at least one surface among a total of three surfaces consisting of the two surfaces of the wave-guiding section and a surface of the output coupler,
the partial reflecting mirror has a difference of reflectance of not less than 10% and less than 40% between first polarized light that is S-polarized light upon reflection by the partial reflecting mirror and P-polarized light that is second polarized light orthogonal to the first polarized light at an incident angle of 30°,
the wave-guiding section has an in-plane retardation of 20 nm or less in an effective area thereof, and
the substrate section is formed from a thermoplastic resin composition having a cyclic structure in a main chain or a side chain and has a glass-transition temperature (Tg) of 115° C. to 150° C.

Through the injection molded light-guiding member set forth above, it is possible to provide an image while also inhibiting faults such as non-uniformity of brightness, non-uniformity of color, and rainbow effect even in a situation in which a partial reflecting mirror having polarization selective reflectance characteristics is formed at the input coupler, the wave-guiding section, or the output coupler.

The inventors discovered that in the case of a light-guiding member that is formed from a thermoplastic resin composition having sufficiently high heat resistance, having a small photoelastic coefficient, and having a cyclic structure in a main chain or a side chain and that has little anisotropy of residual stress, it is possible to obtain a light-guiding member in which birefringence after molding is restricted to a low level, that experiences little change of surface accuracy or dimensions caused by a change of environment, and that can provide a clear image. The inventors also discovered that by using a partial reflecting mirror that transmits a portion and reflects a remaining portion of light, it is possible to obtain a light-guiding member that solves the problem of critical angle described above while also being capable of imparting a new function.

Specifically, by using a partial reflecting mirror that transmits a portion and reflects a remaining portion of light (for example, a partial reflecting mirror designed to have a reflectance of 30% and a transmittance of 70%), it is possible to guide light through forced reflection inside a substrate of a light-guiding member regardless of the critical angle. The inventors also discovered that by adopting a design allowing a sufficiently large incident angle, the light-guiding member can also guide image light through total internal reflection without loss.

Although partial reflecting mirrors have not been proactively adopted in wave-guiding sections in conventional techniques, the inventors realized that another feature of a partial reflecting mirror is the expression of polarization dependency of reflectance according to the configuration of the mirror and that this property varies according to the incident angle. Moreover, in a situation in which a mirror having a reflectance difference of 10% or more between first polarized light and second polarized light orthogonal to the first polarized light at an incident angle of 30°, for example, is adopted as a partial reflecting mirror, by using a partial reflecting mirror for which S-polarized light reflectance is 50% and P-polarized light reflectance is 10%, for example, despite the designed reflectance for unpolarized light being 30% and by causing input image light to enter as S-polarized light, it is possible to improve the utilization efficiency of image light by an amount in accordance with the number of reflections by a wave-guiding section.

However, the inventors determined that in a situation in which such a wave-guiding section and an output coupler have polarization selective reflectance (or transmittance) characteristics, the polarization state of polarized light of image light that is being guided is disrupted by birefringence of a resin substrate, and this acts as a cause of non-uniformity of brightness, rainbow effect, and non-uniformity of color in an image, but by adopting a light-guiding member that is formed from a low-birefringence resin composition according to the present disclosure, it is possible to provide a light-guiding member with which non-uniformity of brightness, rainbow effect, non-uniformity of color, and so forth do not arise in an image.

The injection molded light-guiding member (hereinafter, also referred to simply as a “light-guiding member”) of the present embodiment may be a light-guiding member that includes another member (for example, a polarizing plate, a waveplate or retardation coating, a metal mirror coating, an anti-reflection coating, a hard coating, or another such functional coating layer) so long as the effects according to the present disclosure are not impaired. The other member mentioned above may be one member or a plurality of members.

—Configuration—Although no specific limitations are placed on the shape of the light-guiding member, an input coupler for causing light to enter a light-guiding body, a wave-guiding section that guides light through repeated reflection, and an output coupler for extracting light are essential elements of configuration. In addition, the light-guiding member includes a light entry section where light enters and a light extraction section where light that has been guided is extracted to the outside world. Note that that an exit section may be the same configuration as the output coupler.

No specific limitations are placed on the input coupler and the output coupler, and besides a diffraction grating composed of a grating, a volume hologram, and a diffraction grating formed from a liquid-crystal, it is also possible to use a mirror composed of a metal thin film or a partial reflecting mirror composed of a dielectric multilayer film.

In a case in which the input coupler is configured as a reflecting surface, it is preferable to use a mirror having high reflectance without loss of light. Moreover, in a case in which the input coupler is configured as a diffractive surface, it is preferable to use a diffractive element having high diffraction efficiency without loss of light.

In a case in which the input coupler is configured as a transmissive surface, it is preferable to provide an anti-reflection coating having suppressed reflectance.

Furthermore, it is not necessary for the input coupler and the output coupler to be parallel to the two surfaces constituting the wave-guiding section, and these couplers may be formed as a tilted surface forming a prism section for bending image light by reflection.

The wave-guiding section preferably has a configuration that enables total internal reflection and is preferably provided with a partial reflecting mirror in a case in which the critical angle is limiting with regards to widening the viewing angle of an image or eye box design. However, since the provision of a partial reflecting mirror results in attenuation of the amount of light through repeated reflection, it is preferable to adjust reflectance of the partial reflecting mirror and exploit polarized light reflectance characteristics of the partial reflecting mirror in order to set a high reflectance of image light in consideration of the brightness of image light that is visible to an observer. Note that even in a case in which a partial reflecting mirror is adopted, light can be guided without loss so long as total internal reflection conditions are satisfied, making this more preferable.

The wave-guiding section has two surfaces in the light-guiding member. One surface of the wave-guiding section is referred to as an outer side wave-guiding section, whereas the other surface of the wave-guiding section is referred to as an eye side wave-guiding section. Note that the eye side wave-guiding section is a wave-guiding section that is close to an eyeball of an observer, whereas the other wave-guiding section constitutes the outer side wave-guiding section.

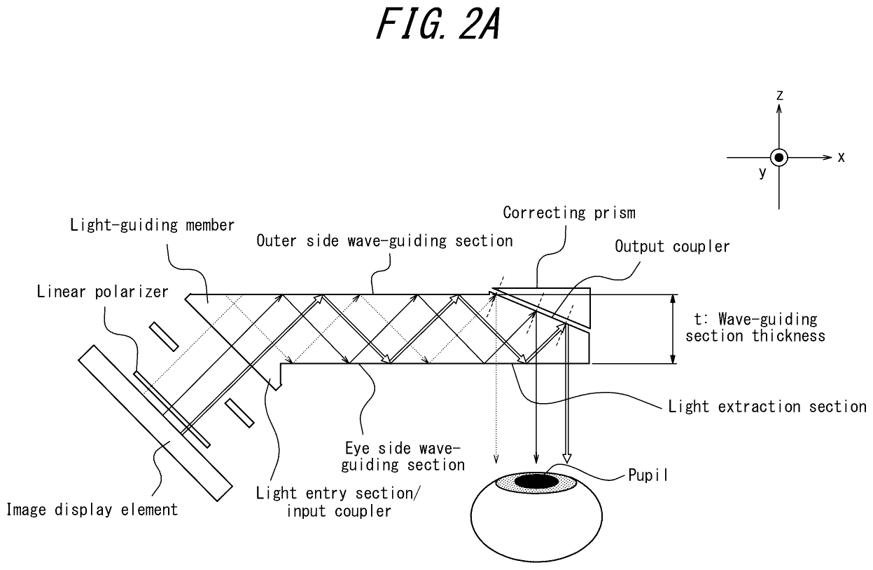

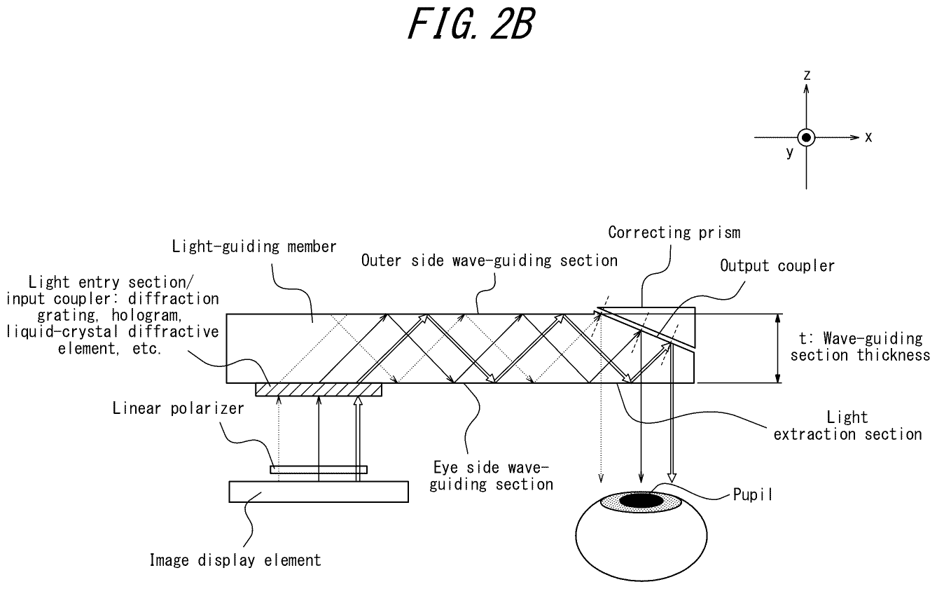

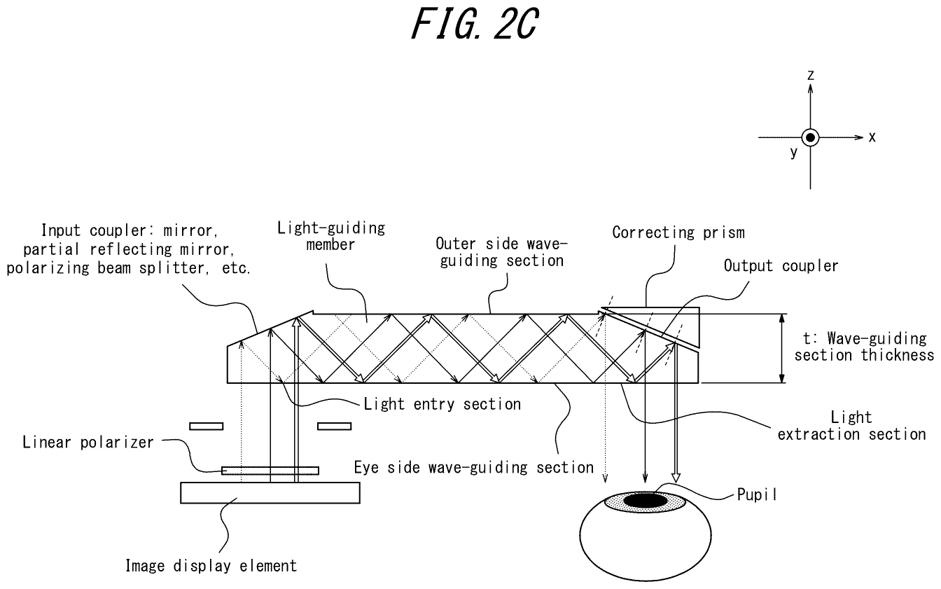

One example of configuration of the light-guiding member of the present embodiment is described with reference to FIGS. 2A to 2C. Light from an image display element is caused to enter the light-guiding member using, as the input coupler installed at the light entry section of the light-guiding member, a prism in FIG. 2A, a diffraction grating, a holographic element (hologram), and a liquid-crystal diffractive element in FIG. 2B, and a mirror, a partial reflecting mirror, and a polarizing beam splitter (reflective polarizer) in FIG. 2C. The image light is guided by the wave-guiding section (outer side wave-guiding section and eye side wave-guiding section) inside of the light-guiding member by total internal reflection, is subsequently output in the direction of a pupil of a user by a mirror, diffraction grating, or holographic element serving as the output coupler, which is arranged such as to disrupt total internal reflection, and is extracted from the light extraction section such that light that has passed through the light-guiding member is observed by the pupil of the observer. Note that in FIGS. 2A to 2C, a linear polarizer is disposed between the image display element and the light-guiding member. A collimating optical system (not illustrated) may also be separately disposed between the image display element and the light-guiding member. Moreover, a correcting prism is adhered to the output coupler.

The surface of the light-guiding member according to the present embodiment can be further subjected to surface functionalization treatment such as hard coating treatment, anti-reflection treatment, metal mirror treatment, retardation layer provision, transparent electroconductive treatment, electromagnetic shielding treatment, or gas barrier treatment, for example, to the extent that the effects according to the present disclosure are not impaired. The thickness of such functional layers is not specifically limited but is normally within a range of 0.01 μm to 10 μm. In a situation in which reflection at an interface between a substrate and a functional layer due to refractive index difference is undesirable, it is preferable to restrict the difference with the refractive index of the substrate to within ±0.05. It is also possible to reduce the appearance of a double image due to reflection at an interface between the substrate and the functional layer and reflection at an interface between the functional layer and air by adopting a thin thickness.

A hard coating layer can be formed on the surface of the light-guiding member by adopting a conventional application method that is commonly known to apply a coating liquid having a silicone curable resin, an organic polymer-composited inorganic fine particle-containing curable resin, or an acrylate such as urethane acrylate, epoxy acrylate, or a polyfunctional acrylate and a light or thermal polymerization initiator dissolved or dispersed in an organic solvent, for example, onto a light-guiding member obtained using a resin composition of the present embodiment, and then drying the coating liquid and causing curing by light or heat.

In order to improve adhesiveness, it is possible to adopt a method in which an easy-adhesion layer containing inorganic fine particles in the composition thereof, a primer layer, an anchor layer, or the like is provided in advance, prior to application of the hard coating layer, and in which the hard coating layer is subsequently formed.

An anti-glare layer can be formed on the surface of the light-guiding member by forming an ink using fine particles of silica, melamine resin, acrylic resin, or the like, applying the ink onto another functional layer by a conventional application method that is commonly known, and causing curing by heat or light.

An anti-reflection layer provided at the surface of the light-guiding member (optionally including a functional layer such as a hard coating layer) may be a layer composed of a thin film of an inorganic material such as a metal oxide, fluoride, silicide, boride, nitride, or sulfide or a single layer or stack of multiple layers of resins having different refractive indices such as an acrylic resin and a fluororesin, for example. Alternatively, a stack of thin layers containing composite fine particles of an inorganic compound and an organic compound can also be used.

A mirror, half-mirror, or partial reflecting mirror (optionally a partial reflecting mirror having a ratio of reflectance and transmittance that is not 50:50, such as a partial reflecting mirror having a transmittance of 15% and a reflectance of 85%, for example; a mirror is defined as having a higher reflectance than the surface reflectance of the base material of the surface of the substrate) can be provided on the surface of the light-guiding member (optionally including a functional layer such as a hard coating layer). Although any suitable configuration can be adopted, the mirror can be constructed through coating of a thin layer of a metal (for example, silver or aluminum) on the light-guiding member. Since coating with a thin metal layer causes absorption of light by the metal, it is preferable to form the mirror by depositing a thin-film dielectric coating on the surface of the light-guiding member. Moreover, a method of coating with a metal and a method of coating with a dielectric may be combined. A SiO₂ film, a SiO film, or a MgF film may be additionally formed as a protective film on the surface of the mirror so long as the function of the mirror is not impaired.

The reflectance and transmittance of light can be controlled through the thickness and number of coated layers. Also, in a method that involves depositing a dielectric, it is also possible to design the coating such that only light of an arbitrary wavelength is reflected.

### —Dimensions—

Although no specific limitations are placed on the size of the injection molded light-guiding member of the present embodiment, a size roughly the same as that of vision-correcting glasses is preferable. With reference to the diagrams of the light-guiding members illustrated as examples in FIGS. 2A to 2C, the x-axis direction length of the injection molded light-guiding member, for example, is preferably not less than 10 mm and not more than 80 mm, more preferably not less than 20 mm and not more than 60 mm, and even more preferably not less than 35 mm and not more than 55 mm. A short length in the x-direction may lead to contact between the face and an image display element of eyewear. Moreover, when the light-guiding member according to the present disclosure is used with the distance described above, light can be guided while maintaining the polarization state, the effect of the partial reflecting mirror according to the present disclosure, which has a reflectance difference of 10% or more between P-polarized light and S-polarized light, can be suppressed, and a clear image can be presented to an observer.

Furthermore, the y-axis direction length of the injection molded light-guiding member is preferably not less than 10 mm and not more than 80 mm, more preferably not less than 10 mm and not more than 50 mm, and even more preferably not less than 25 mm and not more than 45 mm.

In a situation in which the light-guiding member of the present embodiment is used in an AR headset, a correcting prism may be provided at an opposing surface such that the outside world can be viewed in a see-through manner without distortion when the outside world is viewed through the output coupler. In this situation, it is desirable that the difference between the refractive index of the light-guiding member and the refractive index of an adhesive used for adhering the correcting prism to the light-guiding member is limited to within ±0.05. This makes it possible to sufficiently suppress distortion caused by a refractive index difference of the bond relative to the light-guiding member or the correcting prism. Furthermore, optical elements such as a linear polarizing plate, a linear polarizing plate and a half-wave plate, and/or a retardation layer imparting half-wave retardation may be further provided at an outside world side of the correcting prism.

### (Wave-Guiding Section)

The injection molded light-guiding member of the present embodiment includes two surfaces of a wave-guiding section that are opposite to each other and that guide light from an image display element through repeated reflection. The two surfaces of the wave-guiding section can be an eye side wave-guiding section that is at a side corresponding to an eye of an observer and an outer side wave-guiding section that is opposite to the eye side wave-guiding section at a side corresponding to the outside world.

The minimum distance between the outer side wave-guiding section and the eye side wave-guiding section, which in other words is the minimum distance between the two surfaces of the wave-guiding section, is preferably not less than 0.6 mm and not more than 25 mm, more preferably not less than 1 mm and not more than 20 mm, and even more preferably not less than 1.2 mm and not more than 20 mm. In another preferred embodiment, the minimum distance between the two surfaces of the wave-guiding section is preferably not less than 1 mm and not more than 8 mm. A thickness of 8 mm or less is preferable from a viewpoint of weight reduction, whereas a thickness of less than 0.6 mm makes it difficult to maintain the strength of the light-guiding member. Moreover, a thinner thickness means that an effect of warping may arise under the influence of molding strain, thermal deformation, or the like in the case of a light-guiding member that is made of resin and makes it difficult to reproduce the surface shape as a flat surface or an accurate curved surface. Therefore, the minimum distance between the two surfaces of the wave-guiding section is more preferably not less than 1.2 mm and not more than 15 mm, even more preferably not less than 1.5 mm and not more than 7 mm, and particularly preferably not less than 2 mm and not more than 6 mm.

In the injection molded light-guiding member of the present embodiment, the wave-guiding section can be a flat surface or a curved surface. In a case in which the wave-guiding section is a curved surface, when the distance between the two surfaces of the wave-guiding section of the light-guiding member is taken to be a thickness t, it is preferable to adopt a design in which the radius of curvature R mm at the eye side is widened by an amount corresponding to the thickness t such that the radius of curvature is R+t mm in order to avoid a change of incident angle during guiding.

The projection length of the wave-guiding section in a wave-guiding direction is preferably 10 mm or more. Note that the wave-guiding direction is the direction in which light is guided. The projection length in the wave-guiding direction is preferably not less than 10 mm and not more than 50 mm, more preferably not less than 12 mm and not more than 45 mm, and even more preferably not less than 15 mm and not more than 40 mm. By using the light-guiding member according to the present disclosure, light can be guided while maintaining the polarization state, the effect of the partial reflecting mirror according to the present disclosure, which has a reflectance difference of 10% or more between P-polarized light and S-polarized light, can be suppressed, and a clear image can be presented to an observer.

A partial reflecting mirror that transmits a portion and reflects a remaining portion of light may be formed at the two surfaces of the wave-guiding section. The partial reflecting mirror may be formed at just one of the two surfaces of the wave-guiding section or may be formed at both thereof. In other words, a partial reflecting mirror that transmits a portion and reflects a remaining portion of light may be formed at part or all of both of the two surfaces of the wave-guiding section. In a case in which a partial reflecting mirror is only formed at one of the two surfaces of the wave-guiding section, it is preferable that a partial reflecting mirror that transmits a portion and reflects a remaining portion of light is formed at the outer side wave-guiding section.

### (Input Coupler)

No specific limitations are placed on the input coupler according to the present embodiment to the extent that the effects according to the present disclosure are not impaired so long as it is an element that can guide light into the light-guiding member. The input coupler may, for example, be a surface relief-type diffraction grating, a volume hologram, a liquid-crystal diffraction grating, a prism-shaped element provided with an anti-reflection coating on part of the surface thereof, or a prism-shaped element provided with a partial reflecting mirror, mirror, polarizing beam splitter (inclusive of a reflective polarizer), or the like on part of the surface thereof. In reflection by the wave-guiding section, light can be guided by total internal reflection and loss of light can be reduced through the incident angle being not less than the critical angle of the substrate section of the light-guiding member or of an outermost layer of the light-guiding member. Even in a case in which light is incident on the wave-guiding section at an incident angle that is smaller than the critical angle, light can be guided independent of the critical angle through use of an optical element, partial reflecting mirror, or mirror such as previously described. It is preferable that an optical element having polarization selectivity that can maintain the polarization state is used at the input coupler, particularly with the aim of improving light utilization efficiency, blocking a portion of light, etc.

The term “polarization selectivity” means that diffraction efficiency, transmittance, or reflectance with respect to either an S-wave or P-wave polarization state of light (of a used wavelength region) that is incident on the above-described optical element has a difference of 5% or more relative to the other polarization.

### (Output Coupler)

No specific limitations are placed on the output coupler according to the present embodiment to the extent that the effects according to the present disclosure are not impaired so long as it is an element that can guide light inside of the light-guiding member. The output coupler may, for example, be a surface relief-type diffraction grating, a volume hologram, a liquid-crystal diffraction grating, a prism-shaped element provided with an anti-reflection coating on part of the surface thereof, or a prism-shaped element provided with a partial reflecting mirror, mirror, polarizing beam splitter (inclusive of a reflective polarizer), or the like on part of the surface thereof. Moreover, the output coupler is configured such that a portion of or all light that has been guided by the wave-guiding section is delivered to an eyeball (eyepoint) of an observer through refraction, diffraction, or reflection. The shape of the output coupler is not limited to a flat surface, and the output coupler may be a curved surface, may have the function of a convex lens or a concave lens, and may further have a free-form surface. By adopting such a free-form surface, it is possible to configure a direct retinal imaging-type optical system. Note that it is preferable that an optical element having polarization selectivity that can maintain the polarization state of light is used at the output coupler, particularly with the aim of improving light utilization efficiency, imparting a function of blocking a portion of light, etc.

Moreover, it is preferable that a partial reflecting mirror that transmits a portion and reflects a remaining portion of light is formed at the output coupler.

### [Properties of Injection Molded Light-Guiding Member]

### —Polarization Retention Characteristics—

Polarization retention characteristics of the injection molded light-guiding member in the present embodiment can be evaluated by the following method.

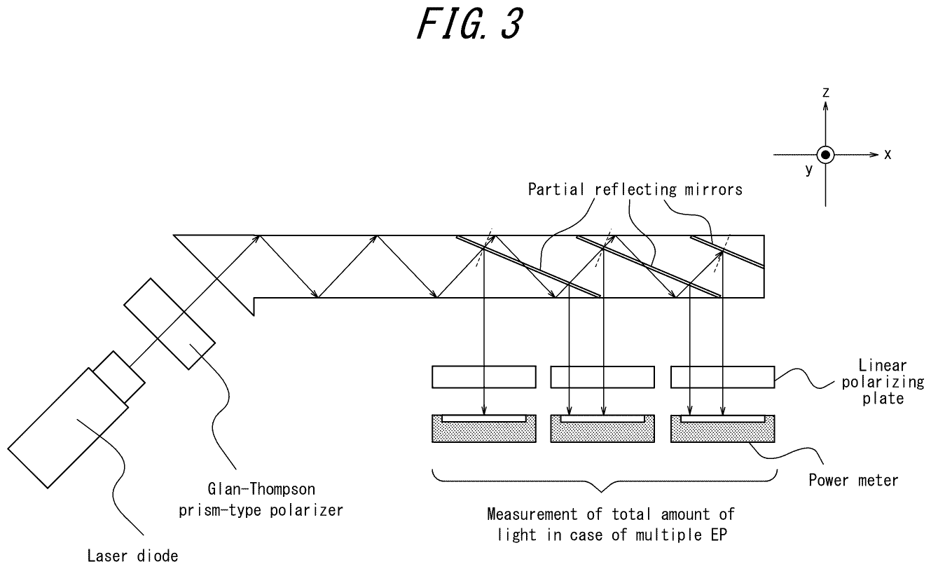

A specific index takes, as a basis, a ratio Tp/Tc of an amount of light (Tp) that, upon entry of first polarized light that is light parallel to an optical axis of the light-guiding member, is obtained at a power meter via a polarizing plate that is arranged in front of the light extraction section such as to transmit the first polarized light and an amount of light (Tc) that is obtained at the power meter under conditions where the polarizing plate disposed in front of the light exit section is rotated by 900 so as to block the first polarized light. In a case in which there are multiple eyepoints, power meters are arranged at multiple locations as illustrated in FIG. 3, and the sum of the overall amount of light is adopted.

The following describes the preferred ratio Tp/Tc for each wavelength. Since the ratio Tp/Tc varies depending on the magnitude of Rs/Rp, which is a ratio of the reflectance Rs of S-polarized light and the reflectance Rp of P-polarized light by the partial reflecting mirror, the ratio Tp/Tc is standardized through division by the ratio Rs/Rp, with the resulting value then being taken as an index. Note that in a case in which a plurality of partial reflecting mirror reflectances are designed, a value determined by dividing Tp/Tc by the ratio Rs/Rp of a surface where the ratio Rs/Rp of polarized light reflectance is largest is adopted.

When a blue laser that emits light with a principal wavelength of 450 nm is used, (Tp/Tc)/(Rs/Rp) (450 nm) is preferably 6 or more. (Tp/Tc)/(Rs/Rp) (450 nm) is more preferably 12 or more, even more preferably 18 or more, and particularly preferably 30 or more.

Moreover, when S-polarized light vibrating along an axis orthogonal to a plane of incidence that includes incident light and reflected light enters the light-guiding member as incident polarized light of the blue laser, (Tp/Tc)/(Rs/Rp) (450 nm) is preferably 7 or more, more preferably 10 or more, even more preferably 25 or more, and particularly preferably 40 or more.

When P-polarized light vibrating within the plane of incidence that includes incident light and reflected light enters the light-guiding member as incident polarized light of the blue laser, (Tp/Tc)/(Rs/Rp) (450 nm) is preferably 5 or more, more preferably 7 or more, even more preferably 10 or more, and particularly preferably 15 or more.

When a green laser that emits light with a principal wavelength of 530 nm is used, (Tp/Tc)/(Rs/Rp) (530 nm) is preferably 10 or more. (Tp/Tc)/(Rs/Rp) (530 nm) is more preferably 15 or more, even more preferably 20 or more, further preferably 30 or more, and particularly preferably 40 or more.

Moreover, when S-polarized light vibrating along an axis orthogonal to a plane of incidence that includes incident light and reflected light enters the light-guiding member as incident polarized light of the green laser, (Tp/Tc)/(Rs/Rp) (530 nm) is preferably 10 or more, more preferably 50 or more, even more preferably 100 or more, and particularly preferably 300 or more.

When P-polarized light vibrating within the plane of incidence that includes incident light and reflected light enters the light-guiding member as incident polarized light of the green laser, (Tp/Tc)/(Rs/Rp) (530 nm) is preferably 5 or more, more preferably 10 or more, even more preferably 20 or more, and particularly preferably 40 or more.

When a red laser that emits light with a principal wavelength of 630 nm is used, (Tp/Tc)/(Rs/Rp) (630 nm) is preferably 10 or more. (Tp/Tc)/(Rs/Rp) (630 nm) is more preferably 15 or more, even more preferably 20 or more, and particularly preferably 25 or more.

Moreover, when S-polarized light vibrating along an axis orthogonal to a plane of incidence that includes incident light and reflected light enters the light-guiding member as incident polarized light of the red laser, (Tp/Tc)/(Rs/Rp) (630 nm) is preferably 10 or more, more preferably 50 or more, even more preferably 100 or more, and particularly preferably 150 or more.

When P-polarized light vibrating within the plane of incidence that includes incident light and reflected light enters the light-guiding member as incident polarized light of the red laser, (Tp/Tc)/(Rs/Rp) (630 nm) is preferably 5 or more, more preferably 7 or more, even more preferably 10 or more, and particularly preferably 20 or more.

By producing a light-guiding member having a high Tp/Tc in this manner, it is possible to display a clear image without non-uniformity of brightness, non-uniformity of color, and rainbow effect. A light-guiding member having a high Tp/Tc can be obtained by producing the light-guiding member through injection molding described in the present disclosure using a resin composition having an excellent property of low birefringence that is described further below.

### —Reflectance Difference Between P-Polarized Light and S-Polarized Light of Partial Reflecting Mirror—

In one embodiment of the present disclosure, the use of a light-guiding member having high polarization retention performance (for example, a case in which a partial reflecting mirror having high reflectance of S-polarized light is used at the wave-guiding section and/or output coupler) makes it possible to increase light utilization efficiency by using a polarized light source element for an entering image and causing image light that is S-polarized light relative to a reflecting surface of the light-guiding member to enter the light-guiding member.

In this case, a ratio Rs/Rp of the reflectance Rs of first polarized light that is S-polarized light and the reflectance Rp of P-polarized light that is second polarized light orthogonal to the first polarized light at an incident angle of 30° at the partial reflecting mirror formed at the wave-guiding section and/or output coupler is preferably 1.2 or more, more preferably 1.4 or more, more preferably 1.8 or more, and particularly preferably 3.0 or more. On the other hand, it is undesirable for the ratio Rs/Rp to be 9.0 or more because this results in poorer close adherence of the mirror. Therefore, the ratio Rs/Rp is preferably less than 9.0.

Moreover, the difference of reflectance between first polarized light that is S-polarized light upon reflection by the partial reflecting mirror and P-polarized light that is second polarized light orthogonal to the first polarized light at an incident angle of 30° at the partial reflecting mirror is preferably 10% or more, and more preferably 15% or more. This difference is even more preferably 20% or more, and further preferably 30% or more. However, this reflectance difference is preferably less than 40% because a difference of 40% or more results in poorer close adherence of the mirror and is undesirable.

In one preferable embodiment of the present disclosure, one of the two surfaces of the wave-guiding section is an outer side wave-guiding section, a partial reflecting mirror that transmits a portion and reflects a remaining portion of light is formed at the outer side wave-guiding section, and the partial reflecting mirror has a reflectance difference of 10% or more between first polarized light that is S-polarized light upon reflection by the partial reflecting mirror and P-polarized light that is second polarized light orthogonal to the first polarized light at an incident angle of 30°.

In another preferable embodiment, a partial reflecting mirror that transmits a portion and reflects a remaining portion of light is formed at the output coupler, and the partial reflecting mirror has a reflectance difference of 10% or more between first polarized light that is S-polarized light upon reflection by the partial reflecting mirror and P-polarized light that is second polarized light orthogonal to the first polarized light at an incident angle of 30°.

Note that in a case in which the output coupler is provided as one stage (i.e., a case in which only one eyepoint line is formed in the X-axis direction, though multiple eyepoints may be present in the Y-axis direction), the use of a mirror having high S-polarized light reflectance at the light extraction section prevents the extraction of light toward an eye, thus making it preferable that a mirror having low reflectance characteristics of S-polarized light and P-polarized light is used at just the light extraction section or at both the eye side wave-guiding section and the light extraction section. Moreover, since it is often the case that light is incident perpendicular to the light extraction section when light is extracted toward the eye, it is also preferable to use a partial reflecting mirror that has a suitable reflectance at the angle of incidence during guiding by the wave-guiding section but has low reflectance at an incident angle of 0° when light is extracted.

Furthermore, in a configuration in which the output coupler is provided as a plurality of stages and in which multiple eyepoints are provided, this limitation does not apply, and a mirror having a higher reflectance of S-polarized light than of P-polarized light such as previously described may be used at the eye side wave-guiding section and the light extraction section. In this configuration, it is preferable to adjust the reflectance of the output coupler, the reflectance of the light extraction section, and so forth as appropriate in order that there is an equal amount of light at each eyepoint.

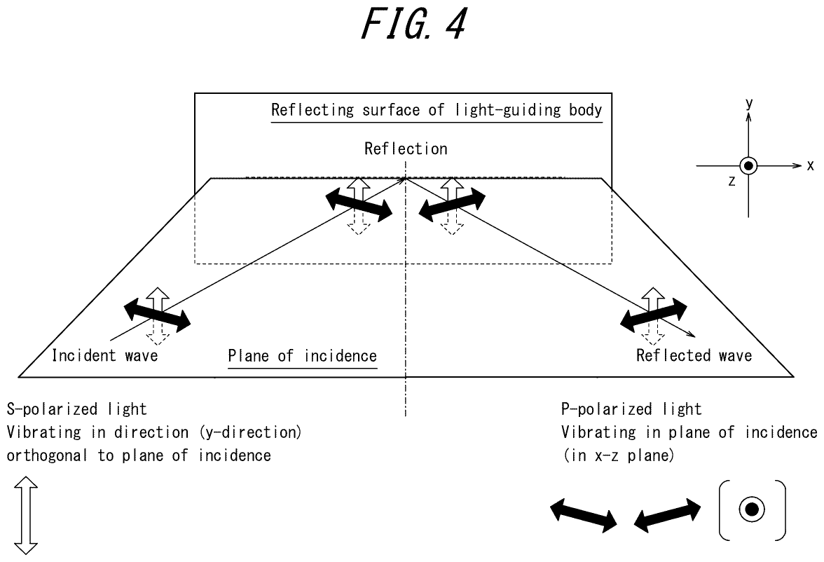

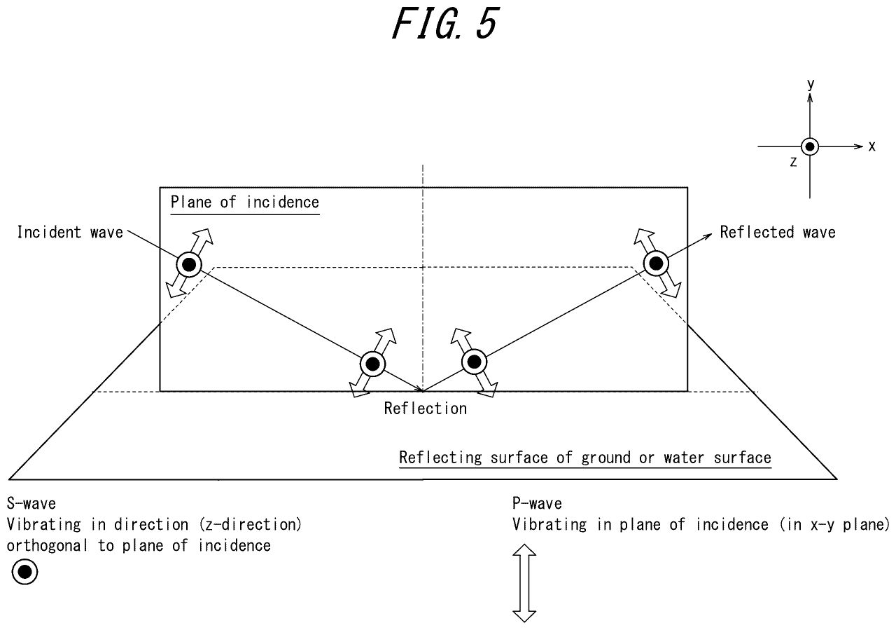

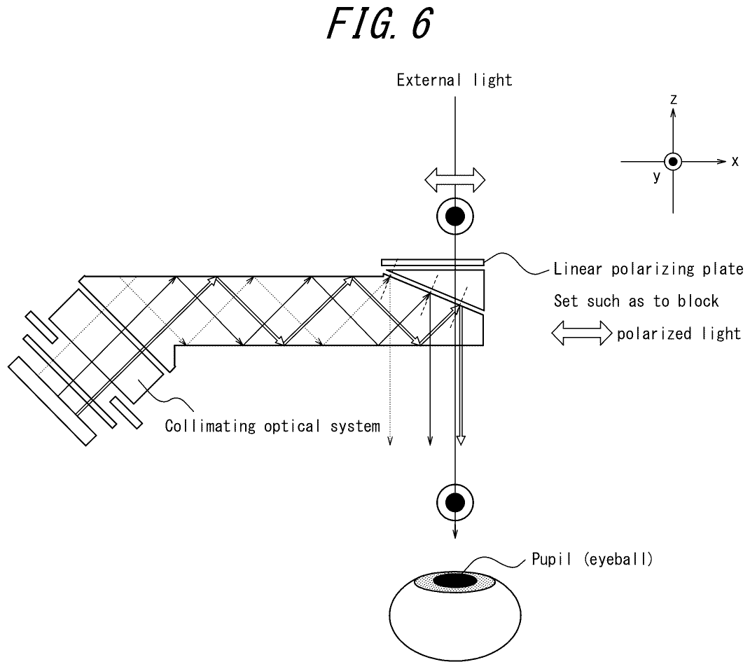

In a situation in which a plane including a plane of incidence and a plane of reflection in the wave-guiding section is horizontal relative to the ground, S-polarized light that is orthogonal to the plane of incidence/reflection of the wave-guiding section (polarized light vibrating in a Y-axis direction in FIG. 4) is P-polarized light in reflection of light at the ground (polarized light vibrating in an X-Y plane in FIG. 5). Accordingly, with the aim of blocking S-polarized light vibrating in a horizontal direction relative to the ground (P-polarized light relative to the plane of incidence/reflection of the wave-guiding section) in order to reduce reflected light from an object or the surface of water, a polarizing plate that blocks S-polarized light relative to the ground can be provided in order from the outside world on a straight line joining the eyepoint (i.e., an eyeball of an observer), the output coupler, and the outside world and can thereby impart a function as polarizing sunglasses (refer to FIG. 6).

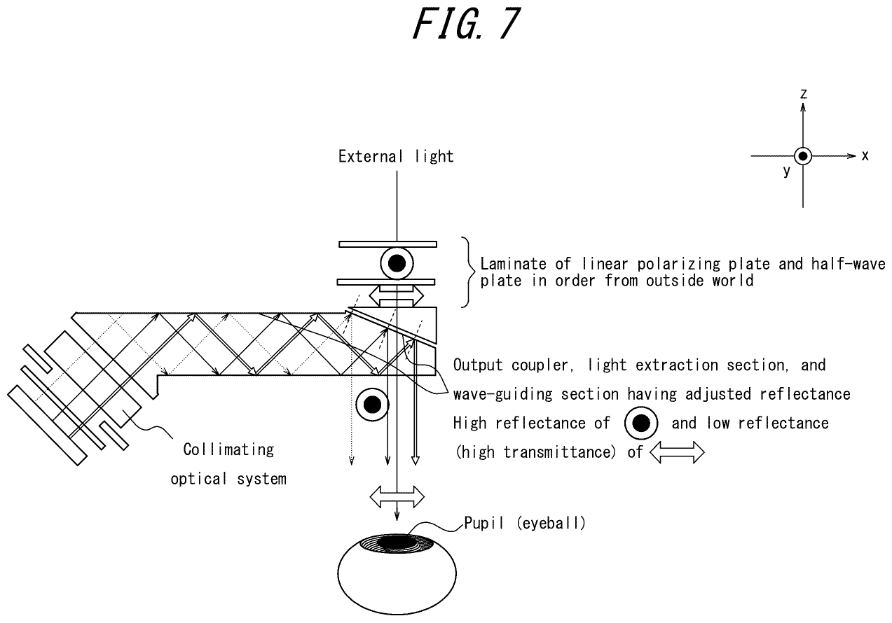

In addition to a linear polarizing plate, a half-wave element or a retardation layer that imparts half-wave retardation may be used. In this case, by adjusting the reflectance characteristics of the partial reflecting mirror, by using a partial reflecting mirror having high polarized light reflectance of S-polarized light relative to the wave-guiding section at the output coupler or the outer side wave-guiding section, and by using an image display element that emits light that is S-polarized light (relative to the wave-guiding section), it is possible to design a configuration in which high transmittance is displayed with respect to light entering from the outside world via the linear polarizing plate and the half-wave element (P-polarized light relative to the plane of incidence/reflection of the wave-guiding section), whereas high reflectance is displayed with respect to image light guided inside of the light-guiding member (refer to FIG. 7).

A thin film obtained through orientation of a liquid-crystal at a specific angle and subsequent curing, for example, can be used as a retardation layer that imparts half-wave retardation.

For the injection molded light-guiding member of the present embodiment, it is preferable that in a situation in which first polarized light of a wavelength of 500 nm to 600 nm that is S-polarized light in reflection by the wave-guiding section enters from the light entry section, is guided by the wave-guiding section, and is then extracted from the light exit section via the output coupler, a value determined when a ratio Tp/Tc of transmittance Tp for extraction via a polarizing plate arranged with a transmission axis matching an axis of the first polarized light and transmittance Tc for extraction via a polarizing plate arranged with a transmission axis orthogonal to the axis of the first polarized light is divided by the ratio Rs/Rp, which is a ratio of the reflectance Rs of S-polarized light and the reflectance Rp of P-polarized light by the partial reflecting mirror, is 5 or more. Moreover, the ratio Tp/Tc is preferably 10 or more, more preferably 15 or more, and even more preferably 20 or more. Note that in a case in which a plurality of partial reflecting mirror reflectances are designed, a value determined when the ratio Tp/Tc is divided by the ratio Rs/Rp of a surface for which the ratio Rs/Rp of polarized light reflectance is largest is adopted.

### —Evaluation by Image Observation—

The light-guiding member according to the present embodiment can be evaluated through image observation by a method subsequently described in the EXAMPLES section.

In evaluation by image observation, the observation of an image free of non-uniformity of brightness, non-uniformity of color, rainbow effect, and double imaging is desirable. By using a preferable light-guiding member according to the present disclosure described further below, it is possible to display an image free of non-uniformity of brightness, non-uniformity of color, rainbow effect, and double imaging.

### —Retardation in Effective Area—

For the light-guiding member in the present embodiment, the average of an absolute value of retardation in an effective area when light passes in a direction perpendicular to the two surfaces of the wave-guiding section such as to pass through the two surfaces (i.e., the in-plane retardation in an effective area of the wave-guiding section where light is guided) is 20 nm or less, preferably 10 nm or less, more preferably 5 nm or less, and even further preferably 3 nm or less. By using a light-guiding member for which the average of the absolute value of retardation in the effective area is within any of these ranges, it is possible to inhibit non-uniformity of brightness, non-uniformity of color, rainbow effect, and ghosts (double imaging) in the case of a long optical path and enable the viewing of a clear image with high resolution.

The effective area of the light-guiding member represents a region where there is transmission (inclusive of guiding) of image light that is visible when the light-guiding member is incorporated into a housing of a head-mounted display and in which an observer that has put on the head-mounted display places their eye in a designed eye box. The effective area can be set as appropriate by an optical designer.

Therefore, in the case of a light-guiding member having a protrusion, coupling mechanism, or the like for incorporation into a housing, a portion where the protrusion, coupling mechanism, or the like is present is excluded from the effective area. In a case in which there is not a clear effective area, the effective area may be regarded as region including 80% or more of projected area at the subject surface, excluding a region where a protrusion, coupling mechanism, or the like is present. In case in which the wave-guiding section is the subject surface, the projected area refers to the area of a shape of all or a partial region of the wave-guiding section that is projected onto a horizontal plane when, with the test subject surface of the light-guiding member arranged as an upper surface, a parallel light beam parallel to the direction of gravity is irradiated from a point infinitely distant in a vertically upward direction (i.e., the projected area refers to the parallel projected area). The retardation in the effective area of the light-guiding member can, more specifically, be measured by a method subsequently described in the EXAMPLES section.

With regards to the method by which a light-guiding member having an effective area such as described above is obtained, a light-guiding member having an in-plane retardation that is within any of the ranges set forth above can be obtained through the adoption of a preferable resin composition and preferable molding conditions that are described further below. Other examples include a method in which a gate and a region around the gate having high birefringence are removed from a light-guiding member and then the light-guiding member is used and a method in which a molded product obtained by pouring a monomer into a mold and then performing a light curing reaction or heat curing reaction to cause hardening is used in production. However, a method in which a gate and a region around the gate are removed is undesirable due to large loss of material and reduction of adjustment range during optical system assembly. Moreover, the method involving producing a light-guiding member by a curing reaction has an issue of requiring a long cycle time for obtaining a single light-guiding member and also makes it difficult to obtain a cured product without residual strain. Therefore, it is preferable that the light-guiding member is obtained by injection molding.

### —Surface Accuracy—

The light-guiding member in the present embodiment is required to accurately reproduce a surface shape that is stipulated in optical design. Deviation of surface shape from the design may result in the occurrence of aberrations such as spherical aberrations and astigmatism aberrations and the appearance of faults such as image distortion, overall image blurring, and localized image blurring in a displayed image.

Preferable surface accuracy can be expressed by a PV value that is the difference between a maximum value and a minimum value expressing the degree of deviation from the designed shape. The two surfaces of the wave-guiding section preferably each have a PV value of less than 15.0 μm in the effective area where light is guided. Moreover, the PV value is more preferably less than 10.0 μm, even more preferably less than 5.0 μm, and particularly preferably less than 3.0 μm.

The surface shape is not restricted to a flat surface and may be a concave curved surface, a convex curved surface, a spherical surface, or a free-form surface without limitation on the shape. Regardless of the type of curved surface, it is possible to obtain a light-guiding member having good surface accuracy by adopting a suitable material and molding method described in the present disclosure.

In one preferable embodiment of the present disclosure, the minimum distance between the two surfaces of the wave-guiding section is not less than 0.6 mm and not more than 25 mm, the projection length of the light-guiding member in the wave-guiding direction is not less than 10 mm and not more than 50 mm, and the two surfaces of the wave-guiding section each have a PV of 10.0 μm or less in the effective area where light is guided.

### —Glass-Transition Temperature—

The light-guiding member in the present embodiment preferably has a glass-transition temperature (Tg) of 115° C. to 150° C.

It is preferable for the glass-transition temperature of the light-guiding member to be 115° C. or higher from a perspective of ensuring heat resistance against heat generated by electronic devices of a head-mounted display. Not only does a low heat-resistance temperature result in significant dimensional change in high-temperature environments, but may also lead to delamination as a result of differences in dimensional change in a situation in which an optical film such as a polarizing film is bonded to the light-guiding member. In contrast, a high heat-resistance temperature is preferable from a perspective of also having an effect of suppressing photoelastic birefringence arising due to tension at a bonding interface with an optical film, for example. The glass-transition temperature (Tg) is more preferably 120° C. or higher, even more preferably 125° C. or higher, and most preferably 130° C. or higher.

During molding in a subsequently described injection molding step, it is necessary to maintain a high mold temperature in a temperature region in proximity to the glass-transition temperature in order to reduce birefringence of a resin lens. Moreover, during removal of a light-guiding member made of resin, it is necessary to adopt a long cooling time in order to inhibit deformation such as sink marks. Consequently, not only does the cycle time increase, but also rapid cooling due to the temperature difference with room temperature tends to result in strain remaining in a light-guiding member made of resin. For this reason, it is undesirable for the glass-transition temperature of the light-guiding member in the present embodiment to exceed 150° C. from a viewpoint of sufficiently reducing birefringence of the light-guiding member.

On the other hand, a glass-transition temperature (Tg) of 150° C. or lower makes it possible to avoid melt processing at an excessively high temperature, inhibit thermal decomposition of resin or the like, and obtain a good product. From a viewpoint of obtaining the above-described effects to an even greater extent, the glass-transition temperature (Tg) is preferably 145° C. or lower, and more preferably 140° C. or lower.

Note that the glass-transition temperature (Tg) can be determined through measurement in accordance with JIS-K7121. Specifically, the glass-transition temperature (Tg) can be determined by a method subsequently described in the EXAMPLES section.

The glass-transition temperature of the light-guiding member can be adjusted to within any of the ranges set forth above by producing the substrate section from a preferable resin composition in the present disclosure that is described further below, for example. Moreover, a high glass-transition temperature can be achieved by providing a cyclic structure in a main chain in the resin composition.

### —Photoelastic Coefficient CR—

The absolute value |CR| of the photoelastic coefficient CR of the light-guiding member of the present embodiment is 10.0×10⁻¹² Pa⁻¹ or less, preferably 5.0×10⁻¹² Pa⁻¹ or less, more preferably 3.0×10⁻¹² Pa⁻¹ or less, and even more preferably 1.0×10⁻¹² Pa⁻¹ or less.

The photoelastic coefficient is described in various documents (for example, refer to Review of Chemistry, No. 39, 1998 (published by Publishing Center of the Chemical Society of Japan)) and is defined by the following formulae (i-a) and (i-b). The closer the absolute value of the photoelastic coefficient CR is to zero, the smaller the change in birefringence caused by external force.

$$\vert CR \vert = \vert Δ n \vert / σ R \qquad ( i - a )$$

$$\vert Δ n \vert = \vert nx - ny \vert \qquad ( i - b )$$

(In the formulae, CR indicates the photoelastic coefficient, σR indicates the tensile stress, |Δn| indicates the absolute value of birefringence, nx indicates the refractive index in the tensile direction, and ny indicates the refractive index in an in-plane direction orthogonal to the tensile direction.) When the absolute value |CR| of the photoelastic coefficient CR of the light-guiding member of the present embodiment is 10.0×10⁻¹² Pa⁻¹ or less, birefringence caused by internal strain arising during molding of the light-guiding member is reduced, stress birefringence arising in accompaniment to stress arising when the light-guiding member is fixed or adhered to a lens barrel or jig is sufficiently small, and a resin lens that suppresses the occurrence of ghosts or deterioration of contrast and provides a clear image in an optical device using polarized light is obtained. On the other hand, a large absolute value |CR| of the photoelastic coefficient CR is undesirable because this causes birefringence and results in non-uniformity of brightness, non-uniformity of color, and rainbow effect as previously described.

Note that measurement of the photoelastic coefficient CR can be performed by finely cutting up the light-guiding member and then forming a pressed film using a vacuum compression molding machine. Specifically, the photoelastic coefficient CR can be determined by a method subsequently described in the EXAMPLES section.

The absolute value of the photoelastic coefficient of the light-guiding member can be adjusted to within any of the ranges set forth above by, for example, producing the substrate section of the light-guiding member from a preferable resin composition in the present embodiment that is described further below. Moreover, it is preferable for a copolymerization composition ratio of a monomer having a positive photoelastic coefficient as a homopolymer and a monomer having a negative photoelastic coefficient as a homopolymer to be adjusted to within a suitable range. In the case of a cycloolefin copolymer, it is possible to obtain a cycloolefin copolymer resin composition for which the absolute value of the photoelastic coefficient is small by adjusting a copolymerization composition ratio of constitutional units derived from an α-olefin and constitutional units derived from a cycloolefin to within a suitable range. Moreover, although it is also possible to relieve stress and strain through annealing, this is undesirable because sufficient stress relief requires heat treatment at a temperature from 35° C. lower than the glass-transition temperature of the resin to around the glass-transition temperature, and change of surface shape, focus deviation, or the like may arise in this step. Therefore, it is desirable to mold the light-guiding member from a resin composition having a small photoelastic coefficient.

### —Light Transmittance—

The light transmittance of the light-guiding member of the present embodiment can be measured by passing light such that the light is transmitted through the two surfaces of the wave-guiding section from a direction perpendicular to the two surfaces and using a spectrophotometer to perform measurement with a D65 light source and a 2° viewing field. With regards to light transmittance, a ratio T450/T680 of the transmittance (T450) at a wavelength of 450 nm relative to the transmittance (T680) at a wavelength of 680 nm is preferably 0.95 to 1.03, more preferably 0.97 to 1.01, and even more preferably 0.98 to 1.00. When the ratio T450/T680 is within any of the ranges set forth above, an image having good color tone can be obtained.

Note that the light transmittance can, more specifically, be measured by a method subsequently described in the EXAMPLES section.

### <Resin Composition>

In the light-guiding member of the present embodiment, the substrate section is formed from a resin composition. More specifically, the substrate section is formed from a thermoplastic resin composition having a cyclic structure in a main chain or a side chain. Although no specific limitations are placed on the resin composition so long as it contains a thermoplastic resin having both heat resistance and a property of low birefringence in order that a rainbow effect does not arise due to the difference of polarized light reflectance of a partial reflecting mirror, it is preferable that the resin composition contains a methacrylic resin as a resin that enables the realization of a property of low birefringence to a high level. In other words, it is preferable for the thermoplastic resin composition having a cyclic structure in a main chain or a side chain to be a methacrylic resin composition (i.e., a methacrylic resin composition having a cyclic structure in a main chain or a side chain). Moreover, it is also preferable for the thermoplastic resin composition having a cyclic structure in a main chain or a side chain to be a cycloolefin copolymer resin composition that contains a cycloolefin copolymer. To summarize the above, the thermoplastic resin composition having a cyclic structure in a main chain or a side chain preferably contains a methacrylic resin having a cyclic structure in a main chain or a side chain or a cycloolefin copolymer (i.e., is preferably a methacrylic resin composition that contains a methacrylic resin having a cyclic structure in a main chain or a side chain or a cycloolefin copolymer resin composition).

### (Methacrylic Resin)

In order to ensure sufficient heat resistance, it is preferable that a methacrylic resin including a structural unit (X) having a cyclic structure in a main chain and a structural unit derived from a methacrylic acid ester monomer, in particular, is contained as a methacrylic resin. Through the inclusion of a methacrylic resin, and particularly through the inclusion of a methacrylic resin that includes a structural unit (X) having a cyclic structure in a main chain and a methacrylic acid ester monomer unit, it is possible to obtain a light-guiding member having high heat resistance, a sufficiently small in-plane retardation in an effective area, and a sufficiently small photoelastic coefficient.

### [Methacrylic Resin Having Cyclic Structure in Main Chain]

The following describes each structural unit of the methacrylic resin including a structural unit (X) having a cyclic structure in a main chain and a structural unit derived from a methacrylic acid ester monomer.

—Structural Unit Derived from Methacrylic Acid Ester Monomer—

The structural unit derived from a methacrylic acid ester monomer may be a structural unit that is derived from a monomer selected from the following methacrylic acid esters, for example. Examples of methacrylic acid esters include methyl methacrylate, ethyl methacrylate, n-propyl methacrylate, isopropyl methacrylate, n-butyl methacrylate, isobutyl methacrylate, t-butyl methacrylate, 2-ethylhexyl methacrylate, cyclopentyl methacrylate, cyclohexyl methacrylate, cyclooctyl methacrylate, tricyclodecyl methacrylate, dicyclooctyl methacrylate, tricyclododecyl methacrylate, isobornyl methacrylate, phenyl methacrylate, benzyl methacrylate, 1-phenylethyl methacrylate, 2-phenoxyethyl methacrylate, 3-phenylpropyl methacrylate, and 2,4,6-tribromophenyl methacrylate.

One of these monomers may be used individually, or two or more of these monomers may be used together.

Structural units derived from methyl methacrylate and benzyl methacrylate are preferable as the aforementioned structural unit derived from a methacrylic acid ester monomer in terms of the resultant methacrylic resin having excellent transparency and weatherability.

Just one type of structural unit derived from a methacrylic acid ester monomer may be included, or two or more types of structural units derived from methacrylic acid ester monomers may be included.

Through appropriate adjustment of a ratio of the structural unit (X) having a cyclic structure in a main chain and the structural unit derived from a methacrylic acid ester monomer in the methacrylic resin contained in the resin composition, it is possible to reduce birefringence arising due to orientation and residual stress during molding and to obtain a light-guiding member having an absolute value of in-plane retardation of 20 nm or less in an effective area. Moreover, appropriate adjustment of the ratio described above also makes it possible to impart sufficient heat resistance to the methacrylic resin. From these viewpoints, the content of methacrylic acid ester monomer-derived structural units is preferably 50 mass % to 97 mass %, more preferably 55 mass % to 97 mass %, even more preferably 55 mass % to 95 mass %, further preferably 60 mass % to 93 mass %, and particularly preferably 60 mass % to 90 mass % when the methacrylic resin is taken to be 100 mass %.

Note that the content of methacrylic acid ester monomer-derived structural units can be determined by ¹H-NMR and ¹³C-NMR measurements. For example, ¹H-NMR and ¹³C-NMR measurements can be made at a measurement temperature of 40° C. using CDCl₃ or DMSO-d6.

### —Structural Unit (X) Having Cyclic Structure in Main Chain—

The following describes the structural unit (X) having a cyclic structure in a main chain.

It is preferable that at least one type of structural unit selected from the group consisting of a structural unit derived from an N-substituted maleimide monomer, a glutarimide-based structural unit, and a lactone ring structural unit is included as the structural unit (X) having a cyclic structure in a main chain, and more preferable that only at least one type of structural unit selected from the group consisting of a structural unit derived from an N-substituted maleimide monomer, a glutarimide-based structural unit, and a lactone ring structural unit constitutes the structural unit (X) having a cyclic structure in a main chain. One type of structural unit (X) having a cyclic structure in a main chain may be included, or a plurality of types of structural units (X) having a cyclic structure in a main chain may be included in combination.

Moreover, in another preferred embodiment, the methacrylic resin preferably includes at least one type of structural unit selected from the group consisting of a structural unit derived from an N-substituted maleimide monomer, a glutarimide-based structural unit, a lactone ring structural unit, and a hydrogenated aromatic ring structural unit. In the case of a methacrylic resin that has undergone a cyclization step in order to introduce a cyclic structure into a main chain, carboxylic acid side chains may remain and act as a cause of extremely high water absorption, which adversely affects close adherence of an anti-reflection coating or mirror coating or bonding with a reflective polarizer. Therefore, a methacrylic resin that includes a structural unit derived from an N-substituted maleimide monomer or a hydrogenated aromatic ring structural unit is more preferable. In particular, the inclusion of a structural unit derived from an N-substituted maleimide monomer is particularly preferable from a viewpoint of ease of high-level control of optical properties such as photoelastic coefficient without blending with another thermoplastic resin.

The inclusion of an N-substituted maleimide monomer unit structure is also particularly preferable in terms of obtaining a cyclic structure that can increase heat resistance and control lowering of birefringence without undergoing a cyclization step in which an acid or base that can impair bonding adhesiveness with a reflective polarizer, for example, is added.

—Structural Unit Derived from N-Substituted Maleimide Monomer—

Next, the structural unit derived from an N-substituted maleimide monomer is described.

The structural unit derived from an N-substituted maleimide monomer may be at least one structural unit selected from the group consisting of a structural unit represented by the following general formula (1) and a structural unit represented by the following general formula (2), with the inclusion of both a structural unit represented by the following general formula (1) and a structural unit represented by the following general formula (2) being preferable.

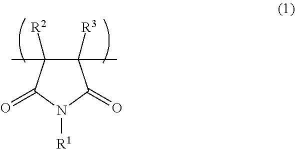

In general formula (1), R¹ represents an arylalkyl group having 7 to 14 carbon atoms or an aryl group having 6 to 14 carbon atoms, and R² and R³ each represent, independently of each other, a hydrogen atom, an oxygen atom, a sulfur atom, an alkyl group having 1 to 12 carbon atoms, or an aryl group having 6 to 14 carbon atoms.

Note that in a case in which R² or R³ in general formula (1) is an aryl group, R² or R³ may include a halogen atom as a substituent.

Moreover, R¹ in general formula (1) may be substituted with a substituent such as a halogen atom, an alkyl group having 1 to 6 carbon atoms, an alkoxy group having 1 to 6 carbon atoms, a nitro group, or a benzyl group.

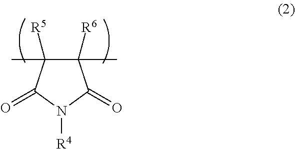

In general formula (2), R⁴ represents a hydrogen atom, a cycloalkyl group having 3 to 12 carbon atoms, or an alkyl group having 1 to 12 carbon atoms, and R⁵ and R⁶ each represent, independently of each other, a hydrogen atom, an oxygen atom, a sulfur atom, an alkyl group having 1 to 12 carbon atoms, or an aryl group having 6 to 14 carbon atoms.

The following gives specific examples of monomers that form structural units represented by general formula (1) and general formula (2).

Examples of monomers (N-arylmaleimides, N-aromatic-substituted maleimides, etc.) that form a structural unit represented by general formula (1) include N-phenylmaleimide, N-benzylmaleimide, N-(2-chlorophenyl)maleimide, N-(4-chlorophenyl)maleimide, N-(4-bromophenyl)maleimide, N-(2-methylphenyl)maleimide, N-(2,6-dimethylphenyl)maleimide, N-(2-ethylphenyl)maleimide, N-(2-methoxyphenyl)maleimide, N-(2-nitrophenyl)maleimide, N-(2,4,6-trimethylphenyl)maleimide, N-(4-benzylphenyl)maleimide, N-(2,4,6-tribromophenyl)maleimide, N-naphthylmaleimide, N-anthracenylmaleimide, 3-methyl-1-phenyl-1H-pyrrole-2,5-dione, 3,4-dimethyl-1-phenyl-1H-pyrrole-2,5-dione, 1,3-diphenyl-1H-pyrrole-2,5-dione, and 1,3,4-triphenyl-1H-pyrrole-2,5-dione.

Of these monomers, N-phenylmaleimide and N-benzylmaleimide are preferable in terms of providing the resultant methacrylic resin with excellent heat resistance and optical properties such as birefringence.

One of these monomers may be used individually, or two or more of these monomers may be used together.

Examples of monomers that form a structural unit represented by general formula (2) include N-methylmaleimide, N-ethylmaleimide, N-n-propylmaleimide, N-isopropylmaleimide, N-n-butylmaleimide, N-isobutylmaleimide, N-s-butylmaleimide, N-t-butylmaleimide, N-n-pentylmaleimide, N-n-hexylmaleimide, N-n-heptylmaleimide, N-n-octylmaleimide, N-laurylmaleimide, N-cyclopentylmaleimide, N-cyclohexylmaleimide, 1-cyclohexyl-3-methyl-1H-pyrrole-2,5-dione, 1-cyclohexyl-3,4-dimethyl-1H-pyrrole-2,5-dione, 1-cyclohexyl-3-phenyl-1H-pyrrole-2,5-dione, and 1-cyclohexyl-3,4-diphenyl-1H-pyrrole-2,5-dione.

Of these monomers, N-methylmaleimide, N-ethylmaleimide, N-isopropylmaleimide, and N-cyclohexylmaleimide are preferable in terms of providing the methacrylic resin with excellent weatherability, and N-cyclohexylmaleimide that has an alicyclic group in a side chain is particularly preferable in terms of providing the excellent low moisture absorbency demanded of optical materials in recent years.

One of these monomers may be used individually, or two or more of these monomers may be used together.

It is particularly preferable that a structural unit represented by general formula (1) and a structural unit represented by general formula (2) are used together in the methacrylic resin of the present embodiment in order that the expression of birefringence can be controlled to a high degree.

A molar ratio X1/X2 of the content (X1) of a structural unit represented by formula (1) relative to the content (X2) of a structural unit represented by general formula (2) is preferably more than 0 and not more than 15, and more preferably more than 0 and not more than 10.

When the molar ratio X1/X2 is within any of these ranges, the light-guiding member of the present embodiment maintains transparency without yellowing and exhibits good heat resistance and good photoelastic characteristics without loss of environmental resistance.

The content of N-substituted maleimide monomer-derived structural units is preferably within a range of 5 mass % to 40 mass %, and more preferably within a range of 5 mass % to 35 mass % when the methacrylic resin is taken to be 100 mass %.

When the content is within any of these ranges, the methacrylic resin exhibits a more sufficient improvement in heat resistance and also provides more favorable improvements in weatherability, low water absorption, and optical properties Note that restricting the content of N-substituted maleimide monomer-derived structural units to 40 mass % or less is effective for preventing reduction of physical properties of the methacrylic resin arising when a large amount of monomer remains unreacted due to reduced reactivity of monomer components in the polymerization reaction.

Also, by appropriately adjusting the content of N-substituted maleimide monomer-derived structural units within any of these ranges, it is possible to reduce birefringence caused by orientation and residual stress during molding and obtain a light-guiding member having an absolute value of in-plane retardation of 20 nm or less in an effective area. The optimal content of N-substituted maleimide monomer-derived structural units varies depending on the type of N-substituted maleimide. For example, in a case in which methyl methacrylate is used as a methacrylic acid ester monomer and N-phenylmaleimide and N-cyclohexylmaleimide are used as N-substituted maleimide monomers, the contents of structural units derived from methyl methacrylate, structural units derived from N-phenylmaleimide, and structural units derived from N-cyclohexylmaleimide are preferably adjusted within ranges of 79 mass % to 83 mass %, 6 mass % to 8 mass %, and 11 mass % to 13 mass %, respectively.

Although an N-substituted maleimide results in a residual acid component such as maleic acid or fumaric acid as a by-product in a production step, the amount of the acid component can be sufficiently reduced in a purification step. Moreover, although storage in a high temperature and high humidity environment similarly results in ring opening by hydrolysis and formation of an acid component such as maleic acid or fumaric acid as a by-product, the formation of such acid components can be suppressed through storage in the dark at a low temperature in a state in which the humidity is managed. A methacrylic resin that has an N-substituted maleimide in a main chain is also advantageous in terms that the methacrylic resin does not undergo a cyclization step using an acid or a base and that the residual amounts of acid components and alkali components can easily be controlled. Consequently, it is possible to obtain a resin in which the content of acid components is restricted to a low level.

In the resin composition, the methacrylic resin that includes a structural unit derived from an N-substituted maleimide monomer may include structural units derived from other monomers that are copolymerizable with a structural unit derived from a methacrylic acid ester monomer and a structural unit derived from an N-substituted maleimide monomer to the extent that the objects of the present disclosure are not impaired.

Examples of other copolymerizable monomers that can be used include aromatic vinyls; unsaturated nitriles; acrylic acid esters including a cyclohexyl group, a benzyl group, or an alkyl group having 1 to 18 carbon atoms; glycidyl compounds; and unsaturated carboxylic acids.

Examples of aromatic vinyls include styrene, a-methylstyrene, and divinylbenzene.

Examples of unsaturated nitriles include acrylonitrile, methacrylonitrile, and ethacrylonitrile.

Examples of acrylic acid esters include methyl acrylate, ethyl acrylate, propyl acrylate, isopropyl acrylate, and butyl acrylate.

Examples of glycidyl compounds include glycidyl (meth)acrylate.

Examples of unsaturated carboxylic acids include acrylic acid, methacrylic acid, itaconic acid, maleic acid, fumaric acid, and semi-esterified products and acid anhydrides thereof.

The methacrylic resin may include just one type of structural unit derived from another copolymerizable monomer or may include two or more types of structural units derived from other copolymerizable monomers.

The content of structural units derived from such other copolymerizable monomers is preferably 0 mass % to 10 mass %, more preferably 0 mass % to 9 mass %, and even more preferably 0 mass % to 8 mass % when the methacrylic resin is taken to be 100 mass %.

It is preferable for the content of structural units derived from other monomers to be within any of the ranges set forth above in terms that moldability and mechanical properties of the resin can be enhanced without losing the intended effects of introducing a cyclic structure into a main chain.

Note that the content of N-substituted maleimide monomer-derived structural units and the content of structural units derived from other copolymerizable monomers can be determined by ¹H-NMR and ¹³C-NMR measurements. For example, ¹H-NMR and ¹³C-NMR measurements can be made at a measurement temperature of 40° C. using CDCl₃ or DMSO-d6 as a measurement solvent.

### —Glutarimide-Based Structural Unit—

The methacrylic resin including a glutarimide-based structural unit in a main chain may be a methacrylic resin including a glutarimide-based structural unit that is described in JP 2006-249202 A, JP 2007-009182 A, JP 2007-009191 A, JP 2011-186482 A, WO 2012/114718 A1, or the like, for example, and can be formed by a method described in any of these publications.

A glutarimide-based structural unit that is a constituent of the methacrylic resin of the present embodiment may be formed after resin polymerization.

Specifically, the glutarimide-based structural unit may be a structural unit that is represented by the following general formula (3).

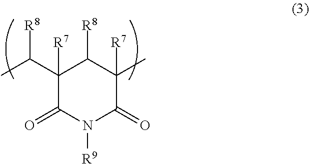

In the preceding general formula (3), it is preferable that R⁷ and R⁸ are each, independently of each other, a hydrogen atom or a methyl group, and R⁹ is a hydrogen atom, a methyl group, a butyl group, or a cyclohexyl group, and more preferable that R⁷ is a methyl group, R⁸ is a hydrogen atom, and R⁹ is a methyl group.

The methacrylic resin may include just one type of glutarimide-based structural unit or may include a plurality of types of glutarimide-based structural units.

In the methacrylic resin including a glutarimide-based structural unit, the content of glutarimide-based structural units is preferably within a range of 3 mass % to 70 mass %, and more preferably within a range of 3 mass % to 60 mass % when the methacrylic resin is taken to be 100 mass %.

It is preferable for the content of glutarimide-based structural units to be within any of the ranges set forth above in terms that a resin having good moldability, heat resistance, and optical properties can be obtained.

Also, by appropriately adjusting the content of glutarimide-based structural units within any of these ranges, it is possible to reduce birefringence caused by orientation and residual stress during molding and obtain a light-guiding member having an absolute value of in-plane retardation of 20 nm or less in an effective area. The optimal content of glutarimide-based structural units varies depending on the type of substituents R⁷ to R⁹ in general formula (3). For example, in a case in which R⁷ and R⁸ are hydrogen atoms and R⁹ is a methyl group, a glutarimide-based structural unit content that is within a range of 3 mass % to 10 mass % makes it possible to reduce birefringence caused by orientation and residual stress during molding and obtain a light-guiding member having an absolute value of in-plane retardation of 20 nm or less in an effective area.

Note that the content of glutarimide-based structural units in the methacrylic resin can be determined by a method described in the previously mentioned patent literature.

The methacrylic resin including a glutarimide-based structural unit may further include an aromatic vinyl monomer unit as necessary.

The aromatic vinyl monomer may be styrene or a-methylstyrene, but is not specifically limited thereto, and is preferably styrene.

Although no specific limitations are placed on the content of aromatic vinyl units in the methacrylic resin including a glutarimide-based structural unit, the content of aromatic vinyl units is preferably 0 mass % to 20 mass % when the methacrylic resin including a glutarimide-based structural unit is taken to be 100 mass %.

It is preferable for the content of aromatic vinyl units to be within the range set forth above in terms that both heat resistance and excellent photoelastic characteristics can be obtained.

For example, in the case of a resin that is obtained through glutarimidization of a methyl methacrylate-styrene copolymer resulting from copolymerization of methyl methacrylate as a methacrylic acid ester monomer and styrene as an aromatic vinyl monomer, adjusting structural units derived from methyl methacrylate within a range of 25 mass % to 90 mass %, structural units derived from styrene within a range of 5 mass % to 15 mass %, and glutarimide-based structural units within a range of 5 mass % to 70 mass % makes it possible to reduce birefringence caused by orientation and residual stress during molding and obtain a light-guiding member having an absolute value of in-plane retardation of 20 nm or less in an effective area.

Another effect is that the copolymerization of a low water absorption monomer such as styrene can reduce water absorption of the resultant methacrylic resin and of the resin composition of this resin, thereby enabling prevention of delamination of a reflective polarizer and inhibition of deterioration of lens surface accuracy after reliability testing in a high humidity environment.

### —Lactone Ring Structural Unit—

The methacrylic resin including a lactone ring structural unit in a main chain can be formed, for example, by a method described in JP 2001-151814 A, JP 2004-168882 A, JP 2005-146084 A, JP 2006-96960 A, JP 2006-171464 A, JP 2007-63541 A, JP 2007-297620 A, JP 2010-180305 A, or the like.

A lactone ring structural unit that is a constituent of the methacrylic resin of the present embodiment may be formed after resin polymerization.

A six-membered ring is preferable as a lactone ring structural unit in the present embodiment since this provides excellent cyclic structure stability.

For example, a structure represented by the following general formula (4) is particularly preferable as a lactone ring structural unit that is a six-membered ring.

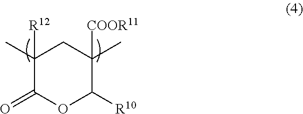

In the preceding general formula (4), R¹⁰, R¹¹, and R¹² are each, independently of one another, a hydrogen atom or an organic residue having 1 to 20 carbon atoms.

Examples of the organic residue include saturated aliphatic hydrocarbon groups (alkyl groups, etc.) having 1 to 20 carbon atoms such as a methyl group, an ethyl group, and a propyl group; unsaturated aliphatic hydrocarbon groups (alkenyl groups, etc.) having 2 to 20 carbon atoms such as an ethenyl group and a propenyl group; aromatic hydrocarbon groups (aryl groups, etc.) having 6 to 20 carbon atoms such as a phenyl group and a naphthyl group; and groups in which at least one hydrogen atom of any of these saturated aliphatic hydrocarbon groups, unsaturated aliphatic hydrocarbon groups, and aromatic hydrocarbon groups has be replaced by at least one group selected from the group consisting of a hydroxy group, a carboxyl group, an ether group, and an ester group.

The lactone ring structural unit may be formed, for example, by copolymerizing an acrylic acid-based monomer having a hydroxy group and a methacrylic acid ester monomer such as methyl methacrylate to introduce a hydroxy group and an ester group or carboxyl group into the molecular chain, and then causing dealcoholization (esterification) or dehydration condensation (hereinafter, also referred to as a “cyclocondensation reaction”) between the hydroxy group and the ester group or carboxyl group.

Examples of acrylic acid-based monomers having a hydroxy group that can be used in polymerization include 2-(hydroxymethyl)acrylic acid, 2-(hydroxyethyl)acrylic acid, alkyl 2-(hydroxymethyl)acrylates (for example, methyl 2-(hydroxymethyl)acrylate, ethyl 2-(hydroxymethyl)acrylate, isopropyl 2-(hydroxymethyl)acrylate, n-butyl 2-(hydroxymethyl)acrylate, and t-butyl 2-(hydroxymethyl)acrylate), and alkyl 2-(hydroxyethyl)acrylates.

Moreover, 2-(hydroxymethyl)acrylic acid and alkyl 2-(hydroxymethyl)acrylates that are monomers having a hydroxyalkyl moiety are preferable, and methyl 2-(hydroxymethyl)acrylate and ethyl 2-(hydroxymethyl)acrylate are particularly preferable.

In the methacrylic resin including a lactone ring structural unit in a main chain, the content of lactone ring structural units is preferably 5 mass % to 40 mass %, and more preferably 5 mass % to 35 mass % relative to 100 mass % of the methacrylic resin.

When the content of lactone ring structural units is within any of the ranges set forth above, effects resulting from the introduction of a cyclic structure, such as improved solvent resistance and improved surface hardness, can be exhibited while maintaining moldability. Also, by appropriately adjusting the content of lactone ring structural units within any of these ranges, it is possible to reduce birefringence caused by orientation and residual stress during molding and obtain a light-guiding member having an absolute value of in-plane retardation of 20 nm or less in an effective area.

Note that the content of lactone ring structures in the methacrylic resin can be determined by a method described in the previously mentioned patent literature.

The methacrylic resin including a lactone ring structural unit in a main chain may include structural units derived from other monomers that are copolymerizable with the above-described structural unit derived from a methacrylic acid ester monomer and structural unit derived from an acrylic acid-based monomer having a hydroxy group.

Examples of such other copolymerizable monomers include monomers having a polymerizable double bond such as styrene, vinyltoluene, α-methylstyrene, α-hydroxymethylstyrene, α-hydroxyethylstyrene, acrylonitrile, methacrylonitrile, methallyl alcohol, ethylene, propylene, 4-methyl-1-pentene, vinyl acetate, 2-hydroxymethyl-1-butene, methyl vinyl ketone, N-vinylpyrrolidone, and N-vinylcarbazole.

Just one of these other monomers (constitutional units) may be included, or two or more of these other monomers (constitutional units) may be included.

In particular, copolymerization of a monomer having low water absorption such as styrene enables reduction of water absorption of the resultant methacrylic resin and the resin composition of that resin.

The content of structural units derived from such other copolymerizable monomers is preferably 0 mass % to 20 mass % relative to 100 mass % of the methacrylic resin, and is more preferably less than 10 mass %, and even more preferably less than 7 mass % from the viewpoint of weatherability.

The methacrylic resin in the present embodiment may include just one type of structural unit or two or more types of structural units derived from the other copolymerizable monomers described above.

### —Methacrylic Resin Including Hydrogenated Aromatic Ring Structural Unit—

A methacrylic resin that includes a hydrogenated aromatic ring structural unit is also preferable as the methacrylic resin.

The method by which the methacrylic resin including a hydrogenated aromatic ring structural unit is produced may be a method in which a copolymer of an aromatic vinyl compound and a (meth)acrylate is hydrogenated in the presence of a hydrogenation catalyst and a reaction solvent to produce a nuclear hydrogenated polymer.

The following provides a specific description of one example of a production method for a methacrylic resin including a hydrogenated aromatic ring structural unit that is obtained through hydrogenation of a copolymer of an aromatic vinyl compound and a (meth)acrylate.

The aromatic vinyl compound used in polymerization may, more specifically, be styrene, α-methylstyrene, vinyltoluene, α-hydroxymethylstyrene, α-hydroxyethylstyrene, p-hydroxystyrene, alkoxystyrene, chlorostyrene, or the like, but is preferably styrene. It is also possible to copolymerize two or more aromatic vinyl compounds. In particular, using styrene having a substituent at the α-position is preferable because it can enhance heat resistance of the resin.

In the case of a copolymer of an aromatic vinyl compound and a (meth)acrylate, the composition of constitutional units of the copolymer does not necessarily match the composition of charged monomers and is determined by the amounts of monomers that are actually incorporated into the copolymer in the polymerization reaction. Although the ratio of constitutional units of the copolymer will match the composition ratio of charged monomers in a situation in which the polymerization rate is 100%, the polymerization rate is often 50% to 80% in actual production, and a monomer having high reactivity is more readily incorporated into the copolymer. Therefore, it is necessary to adjust the composition ratio of charged monomers as appropriate since there is disparity between the composition of charged monomers and the composition of constitutional units of the copolymer.

Among constitutional units of the copolymer of an aromatic vinyl compound and a (meth)acrylate that is used in the hydrogenation reaction in the present disclosure, a molar ratio A/B of constitutional units derived from a (meth)acrylate monomer (A mol) relative to constitutional units derived from an aromatic vinyl compound monomer (B mol) is preferably not less than 0.25 and not more than 4.0. When the molar ratio A/B is less than 0.25, mechanical strength is poor, and practical utility may be compromised. When the molar ratio A/B exceeds 4.0, the number of aromatic rings that are hydrogenated is small, and performance enhancement effects such as improvement of glass-transition temperature by the hydrogenation reaction may be insufficient.

Moreover, the methacrylic resin including a hydrogenated aromatic ring structural unit may include structural units derived from other monomers that are copolymerizable with the hydrogenated aromatic ring structural unit to the extent that the objects of the present disclosure are not impaired.

The content of such structural units derived from other copolymerizable monomers is preferably 0 mass % to 20 mass % relative to 100 mass % of the methacrylic resin, and is more preferably less than 10 mass %, and even more preferably less than 7 mass % from a viewpoint of weatherability.

The methacrylic resin in the present embodiment may include just one type of structural unit or two or more types of structural units derived from the other copolymerizable monomers described above.

### —Production Method of Methacrylic Resin—

The following describes the production method of the methacrylic resin of the present embodiment.

—Production Method of Methacrylic Resin Including Structural Unit Derived from N-Substituted Maleimide Monomer—

The production method of the methacrylic resin that includes a structural unit derived from an N-substituted maleimide monomer in a main chain (hereinafter, also referred to as the “maleimide copolymer”) may be any polymerization method among bulk polymerization, solution polymerization, suspension polymerization, precipitation polymerization, and emulsion polymerization, but is preferably suspension polymerization, bulk polymerization, or solution polymerization, and more preferably solution polymerization from a viewpoint that the amount of residual monomer and the amount of impurities contained in the light-guiding member can be reduced.

The addition method of a polymerization initiator may be a continuous method or an intermittent method without any specific limitations so long as the addition can be varied according to the concentration of monomer remaining in the polymerization solution rather than adopting a constant addition rate. In a case in which the polymerization initiator is added intermittently, the additive amount per unit time is not considered for time where the polymerization initiator is not being added.

The polymerization process in the production method in the present embodiment can be a batch process, a semi-batch process, or a continuous process. A batch process referred to here is a process in which all raw materials are charged into a reactor, a reaction is subsequently initiated and caused to proceed, and the product is recovered at the end of the reaction. Moreover, a semi-batch process is a process in which either raw material charging or product recovery is performed concurrently while the reaction is ongoing. Furthermore, a continuous process is a process in which both raw material charging and product recovery are performed concurrently while the reaction is ongoing. In the present embodiment, it is preferable to adopt a method in which a portion of monomer is charged into a reactor before polymerization begins, a polymerization initiator is added to initiate polymerization, and the remaining portion of monomer is subsequently supplied (i.e., a semi-batch polymerization method) from a viewpoint that the copolymer composition can be precisely controlled, the amount of N-substituted maleimide remaining at the end of polymerization can be reduced, and by-products having color tone or fluorescence can be reduced.

A continuous process is less preferable as the production method in the present embodiment for the reason described below. Although a continuous process is advantageous in that the difference in monomer composition between fractions with different molecular weights in the methacrylic resin can be reduced when a polymerization reaction is carried out in a single complete mixing reactor, a large amount of unreacted monomer remains after polymerization, which tends to adversely affect the color tone. On the other hand, although the amount of unreacted monomer can be reduced by using a plug flow reactor, this tends to increase the difference in monomer composition between fractions with different molecular weights in the methacrylic resin. It is also possible to reduce the amount of unreacted monomer in a situation in which a plurality of complete mixing reactors or a complete mixing reactor and a plug flow reactor are combined in series, but the aforementioned difference in monomer composition between fractions tends to increase.

In order to maintain good color tone and transmittance of the light-guiding member obtained using the methacrylic resin and the composition of that resin and in order to reduce the content of fluorescent substances, the total mass of unreacted N-substituted maleimide remaining at the end of polymerization is preferably 1,000 mass ppm or less, and more preferably not less than 10 mass ppm and not more than 500 mass ppm relative to 100 mass % of the polymerization solution at the end of polymerization.

In a situation in which an N-arylmaleimide such as N-phenylmaleimide is used as an N-substituted maleimide, the total mass of unreacted N-arylmaleimide remaining at the end of polymerization is preferably 500 mass ppm or less, more preferably not less than 10 mass ppm and not more than 500 mass ppm, and even more preferably not less than 10 mass ppm and not more than 50 mass ppm relative to 100 mass % of the polymerization solution at the end of polymerization.

An amount that is within any of these ranges is preferable because the content of fluorescent substances in the methacrylic resin and the resultant light-guiding member can be suppressed. Moreover, restricting the amount of unreacted N-substituted maleimide to less than 10 mass ppm is undesirable because it necessitates a higher polymerization temperature or an increased amount of polymerization initiator, which increases maleimide thermally modified products and active radicals and acts as a cause of poorer color tone of the methacrylic resin. The means by which the amount of unreacted N-substituted maleimide at the end of polymerization is controlled to within any of the ranges set forth above may be a semi-batch polymerization method. In a polymerization step of the semi-batch polymerization method, it is preferable to supplementarily add 5 mass % to 35 mass % of the methacrylic acid ester monomer, relative to 100 mass % of the total mass of all monomers subjected to polymerization (for example, a methacrylic acid ester, an N-substituted maleimide, and other optional monomers), at 30 minutes or later from the start of addition of the polymerization initiator. In other words, it is preferable that 65 mass % to 95 mass % among 100 mass % of the total mass of all monomers subjected to polymerization is charged into the reactor prior to addition of the polymerization initiator and that the remaining portion of 5 mass % to 35 mass % of the methacrylic acid ester monomer is supplementarily added at 30 minutes or later from the start of addition of the polymerization initiator. The amount of the methacrylic acid ester monomer that is supplementarily added is more preferably 10 mass % to 30 mass % relative to 100 mass % of the total mass of all monomers subjected to polymerization. Setting the amount of the methacrylic acid ester monomer that is supplementarily added within any of the ranges set forth above is preferable because unreacted N-substituted maleimide and supplementarily added methacrylic acid ester monomer react, making it possible to control the amount of unreacted N-substituted maleimide at the end of polymerization to within any of the previously described ranges.

The point at which supplementary addition of monomer is initiated, the speed of supplementary addition, and so forth may be set as appropriate according to the polymerization conversion rate. Moreover, a monomer mixture containing an N-substituted maleimide monomer or another monomer in addition to the methacrylic acid ester monomer may be supplementarily added to an extent that does not impair the effects according to the present disclosure and reduction of the amount of unreacted N-substituted maleimide.

The adoption of a semi-batch polymerization method such as described above is preferable because it is possible to reduce the amount of unreacted N-substituted maleimide monomer at a late stage of polymerization and minimize production of fluorescent substances in a subsequently described devolatilization step, and it is also possible to obtain a methacrylic resin and composition of the resin having good color tone even in a light-guiding member having a long optical path length.

The following provides a specific description of a case in which a solution polymerization method is adopted in production by semi-batch radical polymerization as one example of a production method of a methacrylic resin that includes a structural unit derived from an N-substituted maleimide monomer.

In the semi-batch polymerization method, it is preferable that 5 mass % to 35 mass % of a methacrylic acid ester monomer relative to 100 mass % of total mass of all monomers subjected to polymerization (methacrylic acid ester, N-substituted maleimide, and other optional monomers) is supplementarily added at 30 minutes or later from the start of addition of the polymerization initiator. In other words, it is preferable that 65 mass % to 95 mass % among 100 mass % of the total mass of all monomers subjected to polymerization is charged into a reactor prior to initiation of polymerization and that the remaining portion of 5 mass % to 35 mass % of the methacrylic acid ester monomer is supplementarily added at 30 minutes or later from the start of addition of the polymerization initiator.

The amount of the methacrylic acid ester monomer that is supplementarily added is more preferably 10 mass % to 30 mass % relative to 100 mass % of the total mass of all monomers subjected to polymerization.

The point at which supplementary addition of monomer is initiated, the speed of supplementary addition, and so forth may be set as appropriate according to the polymerization conversion rate.

Moreover, a monomer mixture containing an N-substituted maleimide monomer or another monomer in addition to the methacrylic acid ester monomer may be supplementarily added to an extent that does not impair the effects according to the present disclosure and increasing the conversion rate of the N-substituted maleimide monomer.

The adoption of a semi-batch polymerization method such as described above is preferable because it is possible to increase the conversion rate of the N-substituted maleimide monomer in a late stage of polymerization, reduce the content of fluorescent substances, provide excellent light transmittance in a light-guiding member having a long optical path length, easily control the molecular weight distribution of the resultant polymerized product, and obtain a resin and composition of the resin having fluidity suitable for injection molding, in particular.

### (Polymerization Solvent)

No specific limitations are placed on the polymerization solvent that is used so long as the solubility of the maleimide copolymer obtained through polymerization is high and an appropriate reaction solution viscosity can be maintained in order to prevent gelation or the like.

Specific examples of polymerization solvents that can be used include aromatic hydrocarbons such as toluene, xylene, ethylbenzene, and isopropylbenzene; esters such as methyl isobutyrate; ketones such as methyl isobutyl ketone, butyl cellosolve, methyl ethyl ketone, and cyclohexanone; and polar solvents such as dimethylformamide and 2-methylpyrrolidone.

One of these polymerization solvents can be used individually, or two or more of these polymerization solvents can be used together.

Moreover, an alcohol such as methanol, ethanol, or isopropanol may also be used together as the polymerization solvent to the extent that dissolution of polymerization product during polymerization is not impaired.

No specific limitations are placed on the amount of the solvent during polymerization so long as polymerization proceeds, precipitation of copolymer or used monomers does not occur during production, and it is an amount that can easily be removed. For example, when the total amount of compounded monomers is taken to be 100 mass %, the amount of the solvent is preferably 10 mass % to 200 mass %, more preferably 25 mass % to 200 mass %, even more preferably 50 mass % to 200 mass %, and further preferably 50 mass % to 150 mass %.

In the present embodiment, a method in which polymerization is performed while appropriately altering the solvent concentration during polymerization such that the amount of the solvent during polymerization is within a range of 100 mass % or less relative to 100 mass % of the total amount of compounded monomers can also preferably be adopted.

More specifically, one example of a method that may be adopted involves compounding 40 mass % to 60 mass % of the solvent during an initial stage of polymerization and compounding the remaining 60 mass % to 40 mass % of the solvent partway through polymerization such that the final amount of the solvent is within a range of 100 mass % or less relative to 100 mass % of the total amount of compounded monomers.

The adoption of this method is preferable because it is possible to increase the polymerization conversion rate, further control the molecular weight distribution, and obtain a resin and resin composition having excellent injection moldability.

In solution polymerization, it is important to lower the dissolved oxygen concentration in the polymerization solution as much as possible, with a dissolved oxygen concentration of 10 ppm or less, for example, being preferable. The dissolved oxygen concentration can be measured using a dissolved oxygen DO meter B-505 (produced by Iijima Electronics Corporation), for example. The method by which the dissolved oxygen concentration is lowered can be selected as appropriate from methods such as a method in which bubbling of an inert gas in the polymerization solution is performed, a method in which an operation of pressurizing a vessel containing the polymerization solution to approximately 0.2 MPa with an inert gas and then depressurizing the vessel is repeated prior to polymerization, and a method in which an inert gas is passed through a vessel containing the polymerization solution.

Although no specific limitations are placed on the polymerization temperature so long as it is a temperature at which polymerization proceeds, the polymerization temperature is preferably 70° C. to 180° C., more preferably 80° C. to 160° C., even more preferably 90° C. to 150° C., and further preferably 100° C. to 150° C. A polymerization temperature of 70° C. or higher is preferable from a viewpoint of productivity, whereas a polymerization temperature of 180° C. or lower is preferable in order to inhibit side reactions during polymerization and obtain a polymer of desired molecular weight and quality.

The polymerization time is also not specifically limited so long as it is a time in which the required degree of polymerization can be achieved at the required conversion rate. However, from viewpoints of productivity and the like, the polymerization time is preferably 2 hours to 15 hours, more preferably 3 hours to 12 hours, and even more preferably 4 hours to 10 hours.

### (Polymerization Initiator)

The polymerization initiator may be any initiator commonly used in radical polymerization and examples thereof include organic peroxides such as cumene hydroperoxide, diisopropylbenzene hydroperoxide, di-t-butyl peroxide, lauroyl peroxide, benzoyl peroxide, t-butylperoxy isopropyl carbonate, t-amyl peroxy-2-ethylhexanoate, t-amyl peroxyisononanoate, and 1,1-di(t-butylperoxy)cyclohexane; and azo compounds such as 2,2′-azobis(isobutyronitrile), 1,1′-azobis(cyclohexanecarbonitrile), 2,2′-azobis(2,4-dimethylvaleronitrile), and dimethyl-2,2′-azobisisobutyrate.

One of these polymerization initiators may be used individually, or two or more of these polymerization initiators may be used together.

These polymerization initiators may be added at any stage so long as the polymerization reaction is in progress.

The additive amount of the polymerization initiator when the total amount of monomers used in polymerization is taken to be 100 mass % may be 0.01 mass % to 1 mass %, and is preferably 0.05 mass % to 0.5 mass %.

The addition method of the polymerization initiator may be a continuous method or an intermittent method without any specific limitations so long as the addition can be varied according to the concentration of monomer remaining in the polymerization solution rather than adopting a constant addition rate. In a case in which the polymerization initiator is added intermittently, the additive amount per unit time is not considered for time where the polymerization initiator is not being added.

In the present embodiment, it is preferable to select the type and additive amount of the polymerization initiator, the polymerization temperature, and so forth as appropriate in order that the ratio of the total amount of radicals generated by the polymerization initiator relative to the total amount of unreacted monomer remaining in the reaction system constantly remains at not greater than a specific value.

By adopting these methods, it is possible to suppress the amount of oligomer and low-molecular weight product produced in a late stage of polymerization, inhibit overheating during polymerization, and stabilize polymerization.

### (Chain Transfer Agent)

In the polymerization reaction, polymerization may be performed with addition of a chain transfer agent as necessary.

The chain transfer agent may be a chain transfer agent that is commonly used in radical polymerization and examples thereof include mercaptan compounds such as n-butyl mercaptan, n-octyl mercaptan, n-decyl mercaptan, n-dodecyl mercaptan, and 2-ethylhexyl thioglycolate; halogen compounds such as carbon tetrachloride, methylene chloride, and bromoform; and unsaturated hydrocarbon compounds such as α-methylstyrene dimer, a-terpinene, dipentene, and terpinolene.

One of these chain transfer agents may be used individually, or two or more of these chain transfer agents may be used together.

These chain transfer agents may be added at any stage, without any specific limitations, so long as the polymerization reaction is in progress.

The additive amount of the chain transfer agent when the total amount of monomers used in polymerization is taken to be 100 parts by mass may be 0.01 parts by mass to 1 part by mass, and is preferably 0.05 parts by mass to 0.5 parts by mass.

No specific limitations are placed on the method by which a polymerized product is collected from the polymerization solution obtained through solution polymerization. Examples of methods that can be adopted include a method in which the polymerization solution is added into an excess of a poor solvent in which the polymerized product obtained through polymerization does not dissolve, such as a hydrocarbon solvent or an alcohol solvent, treatment (emulsifying dispersion) is subsequently performed using a homogenizer, and unreacted monomer is separated from the polymerization solution by pre-treatment such as liquid-liquid extraction or solid-liquid extraction; and a method in which the polymerization solvent and unreacted monomer are separated by a step referred to as a devolatilization step to collect the polymerized product.

The devolatilization step is a step in which volatile content such as the polymerization solvent, residual monomer, and reaction by-products are removed under heated and reduced pressure conditions.

A devolatilization device comprising a tubular heat exchanger and a devolatilization tank, for example, may be adopted as a device used in the devolatilization step. Other examples include devices having a rotating part such as thin film evaporators, examples of which include a WIPRENE and an EXEVA produced by Kobelco Eco-Solutions Co., Ltd. and also a Kontro and a Diagonal-Blade Kontro produced by Hitachi, Ltd., and vented extruders having sufficient residence time and surface area for exhibiting devolatilization capability.

Moreover, it is possible to adopt a devolatilization step or the like in which a devolatilization device that is a combination of two or more of these devices is used.

In the case of a resin composition forming a light-guiding member that is to be used in an application where high image contrast is important, it is vital to limit reaction by-products that display fluorescence. Examples of methods that can be adopted in order to inhibit production of such by-products and obtain a methacrylic resin having good color tone include a method in which polymerization is performed for as long a polymerization time as possible or is performed while altering the addition rate of the polymerization initiator according to the concentration of unreacted monomer in the polymerization solution in order to raise the conversion rate of monomers; a method in which polymerization is performed while altering the solvent concentration as appropriate during polymerization; a method in which another monomer having high reactivity with residual N-substituted maleimide monomer is supplementarily added in a late stage of polymerization; and a method in which a compound such as a-terpinene that has high reactivity with an N-substituted maleimide is added at the end of polymerization.

From a viewpoint of improving color tone, it is preferable to use a devolatilization device that has a heat exchanger and a decompression vessel as main components thereof and that has a structure without rotating parts.

Specifically, it is possible to employ a devolatilization device that includes a devolatilization tank having a configuration where a decompression unit is attached to a decompression vessel, which is sized to be suitable for devolatilization and is provided with a heat exchanger disposed in the upper part thereof, and that also includes a discharge device such as a gear pump for discharging a polymerized product after devolatilization.

In this devolatilization device, a polymerization solution is preheated by feeding it to the heat exchanger (for example, a multi-tube heat exchanger, a plate-fin heat exchanger, or a flat plate heat exchanger having a flat plate channel and a heater), which is disposed in the upper part of the decompression vessel and has been heated, and then the polymerization solution is fed to the devolatilization tank, which is in a heated and depressurized state, so as to separate and remove the copolymer from the polymerization solvent, a mixture of unreacted raw materials, polymerization by-products, and so forth. The use of a devolatilization device such as described above that does not have a rotating part is preferable since a methacrylic resin having good color tone can be obtained.

In the present embodiment, it is preferable to use a flat plate heat exchanger having a flat plate channel and a heater as the heat exchanger that is disposed in the upper part of the decompression vessel. A flat plate heat exchanger that includes a heater and a flat plate channel having a layered structure including a plurality of slit-like channels having a rectangular cross-section in the same planner shape is more preferable.

The polymerization solution that is supplied into this devolatilization device is fed into the slit-like channels from a central part of the heat exchanger and is heated. The heated polymerization solution is fed from the slit-like channels into the decompression vessel under reduced pressure that is integrated with the heat exchanger and is subjected to flash evaporation.

This devolatilization method is also called “flash devolatilization” and is also referred to as flash devolatilization hereinafter in the present disclosure.

The polymerization solution that is supplied into this devolatilization device is fed into the slit-like channels from a central part of the heat exchanger and is heated. The heated polymerization solution is fed from the slit-like channels into the decompression vessel under reduced pressure that is integrated with the heat exchanger and is subjected to flash evaporation.

This devolatilization method is also called “flash devolatilization” and is also referred to as flash devolatilization hereinafter in the present disclosure.

The treatment temperature of the devolatilization device is a temperature from 100° C. higher than the glass-transition temperature (Tg) of the methacrylic resin to 160° C. higher than the glass-transition temperature (Tg) of the methacrylic resin. The specific treatment temperature is preferably 150° C. to 350° C., more preferably 180° C. to 310° C., and even more preferably 200° C. to 290° C. Residual volatile content can be limited by adopting a temperature that is not lower than any of the lower limits set forth above, whereas coloring and decomposition of the resultant methacrylic resin can be inhibited by adopting a temperature that is not higher than any of the upper limits set forth above.

The degree of vacuum inside of the devolatilization tank may be within a range of 5 Torr to 300 Torr, with a range of 10 Torr to 200 Torr being preferable. When this degree of vacuum is 300 Torr or less, unreacted monomer or a mixture of unreacted monomer and polymerization solvent can be efficiently separated and removed, and thermal stability and quality of the resultant thermoplastic copolymer do not decrease. When the degree of vacuum is 5 Torr or more, industrial implementation is easier.

The average residence time inside of the devolatilization tank is 5 minutes to 60 minutes, and preferably 5 minutes to 45 minutes. An average residence time within any of these ranges is preferable because it enables efficient devolatilization and can also inhibit coloring due to thermal modification and decomposition of the polymerized product.

The polymerized product collected through the devolatilization step is processed into the form of pellets through a step referred to as a pelletization step.

In the pelletization step, molten resin is extruded in the form of strands and processed into the form of pellets by cold cutting pelletizing, hot cutting pelletizing in air, strand cutting pelletizing in water, or underwater pelletizing in at least one type of transferring pelletizer selected from a gear pump, a single-screw extruder, a twin-screw extruder, and so forth having a multi-hole die as an attachment.

In the present embodiment, it is preferable to adopt a pelletization method that enables quick cooling and solidification with as little air contact as possible of a resin composition in a molten state at high temperature in order to obtain a resin composition that is controlled to a high degree.

In this case, it is more preferable to perform pelletization under conditions with the molten resin temperature lowered as much as possible, the residence time from an outlet of the multi-hole die to the surface of cooling water shortened as much as possible, and the temperature of the cooling water also set as high as possible.

For example, the molten resin temperature is preferably 220° C. to 280° C., and more preferably 230° C. to 270° C., the residence time from an outlet of the multi-hole die to the surface of cooling water is preferably 5 seconds or less, and more preferably 3 seconds or less, and the temperature of the cooling water is preferably 30° C. to 80° C., and more preferably 40° C. to 60° C.

Implementation with a molten resin temperature and a cooling water temperature that are within any these ranges is preferable because it results in a methacrylic resin and composition thereof having even less coloration and lower water content.

The content of residual monomer in the methacrylic resin after the devolatilization step is preferably low from viewpoints of thermal stability and product quality. Specifically, the content of the methacrylic acid ester monomer is preferably 3,000 mass ppm or less, and more preferably 2,000 mass ppm or less. The content of the N-substituted maleimide monomer as a total amount is preferably 200 mass ppm or less, and more preferably 100 mass ppm or less.

Moreover, the content of residual polymerization solvent is preferably 500 mass ppm or less, and more preferably 300 mass ppm or less.

### —Production Method of Methacrylic Resin Including Glutarimide-Based Structural Unit—

The method used to produce the methacrylic resin including a glutarimide-based structural unit in a main chain may be any polymerization method from among bulk polymerization, solution polymerization, suspension polymerization, precipitation polymerization, and emulsion polymerization, is preferably suspension polymerization, bulk polymerization, or solution polymerization, and is more preferably solution polymerization.

The polymerization process in the production method in the present embodiment may, for example, be a batch polymerization process, a semi-batch polymerization process, or a continuous polymerization process.

In the production method in the present embodiment, the monomers are preferably polymerized by radical polymerization.

The methacrylic resin including a glutarimide-based structural unit in a main chain may be a methacrylic resin including a glutarimide-based structural unit that is described in any of JP 2006-249202 A, JP 2007-009182 A, JP 2007-009191 A, JP 2011-186482 A, or WO 2012/114718 A1, for example, and can be formed by a method described in any of these publications.

The following provides a specific description of a case in which a solution polymerization method is adopted in production by batch radical polymerization as one example of a production method of a methacrylic resin that includes a glutarimide-based structural unit.

First, a (meth)acrylic acid ester such as methyl methacrylate is polymerized to produce a (meth)acrylic acid ester polymer. In a case in which an aromatic vinyl unit is also to be included in the methacrylic resin including a glutarimide-based structural unit, a (meth)acrylic acid ester and an aromatic vinyl (for example, styrene) are copolymerized to produce a (meth)acrylic acid ester-aromatic vinyl copolymer.

A solvent that is used in the polymerization may be an aromatic hydrocarbon such as toluene, xylene, or ethylbenzene; a ketone such as methyl ethyl ketone or methyl isobutyl ketone; or the like, for example.

One of these solvents may be used individually, or two or more of these solvents may be used together.

No specific limitations are placed on the amount of the solvent during polymerization so long as polymerization proceeds, precipitation of copolymer or used monomers does not occur during production, and it is an amount that can easily be removed. For example, when the total amount of compounded monomers is taken to be 100 mass %, the amount of the solvent is preferably 10 mass % to 200 mass %. The amount of the solvent during polymerization is more preferably 25 mass % to 200 mass %, even more preferably 50 mass % to 200 mass %, and further preferably 50 mass % to 150 mass %.

Although no specific limitations are placed on the polymerization temperature other than being a temperature at which polymerization proceeds, the polymerization temperature is preferably 50° C. to 200° C., and more preferably 80° C. to 200° C. The polymerization temperature is even more preferably 90° C. to 150° C., further preferably 100° C. to 140° C., and even further preferably 100° C. to 130° C. A polymerization temperature of 50° C. or higher is preferable from a viewpoint of productivity, whereas a polymerization temperature of 200° C. or lower is preferable in order to inhibit side reactions during polymerization and obtain a polymer of desired molecular weight and quality.

Although no specific limitations are placed on the polymerization time so long as the target conversion rate can be achieved, the polymerization time is preferably 0.5 hours to 15 hours, more preferably 2 hours to 12 hours, and even more preferably 4 hours to 10 hours from viewpoints of productivity and the like.

In the polymerization reaction, polymerization may be performed with addition of a polymerization initiator and/or a chain transfer agent as necessary.

The polymerization initiator may be, but is not specifically limited to, any of the polymerization initiators disclosed in relation to the production method of the methacrylic resin including a structural unit derived from an N-substituted maleimide monomer described above, for example.

One of these polymerization initiators may be used individually, or two or more of these polymerization initiators may be used together.

These polymerization initiators may be added at any stage so long as the polymerization reaction is in progress.

Although the additive amount of the polymerization initiator is not specifically limited and should be set as appropriate according to the combination of monomers, the reaction conditions, and so forth, the additive amount of the polymerization initiator when the total amount of monomers used in polymerization is taken to be 100 mass % may be 0.01 mass % to 1 mass %, and is preferably 0.05 mass % to 0.5 mass %.

The chain transfer agent may be any chain transfer agent that is commonly used in radical polymerization and examples thereof include the chain transfer agents disclosed in relation to the production method of the methacrylic resin including a structural unit derived from an N-substituted maleimide monomer described above, for example.

One of these chain transfer agents may be used individually, or two or more of these chain transfer agents may be used together.

These chain transfer agents may be added at any stage, without any specific limitations, so long as the polymerization reaction is in progress.

Although no specific limitations are placed on the additive amount of the chain transfer agent so long as the desired degree of polymerization is obtained under the adopted polymerization conditions, when the total amount of monomers used in polymerization is taken to be 100 mass %, the additive amount of the chain transfer agent may be 0.01 mass % to 1 mass %, and is preferably 0.05 mass % to 0.5 mass %.

Suitable addition methods of the polymerization initiator and the chain transfer agent in the polymerization step may be methods that were described in relation to the production method of the methacrylic resin including a structural unit derived from an N-substituted maleimide monomer described above, for example.

The dissolved oxygen concentration in the polymerization solution may be a value that was disclosed in relation to the production method of the methacrylic resin including a structural unit derived from an N-substituted maleimide monomer described above.

Next, an imidization agent is caused to react with the above-described (meth)acrylic acid ester polymer or methacrylic acid ester-aromatic vinyl copolymer so as to perform an imidization reaction (imidization step). In this manner, a methacrylic resin that includes a glutarimide-based structural unit can be produced.

The imidization agent is not specifically limited and may be an agent that can form a glutarimide-based structural unit represented by the preceding general formula (3).

Specifically, ammonia or a primary amine can be used as the imidization agent. The primary amine may be an aliphatic hydrocarbon group-containing primary amine such as methylamine, ethylamine, n-propylamine, i-propylamine, n-butylamine, i-butylamine, tert-butylamine, or n-hexylamine; an alicyclic hydrocarbon group-containing primary amine such as cyclohexylamine; or the like, for example.

Of these imidization agents, it is preferable to use ammonia, methylamine, or cyclohexylamine from perspectives of cost and physical properties, and the use of methylamine is particularly preferable.

By adjusting the ratio in which the imidization agent is added in the imidization step, it is possible to adjust the glutarimide-based structural unit content in the resultant methacrylic resin including a glutarimide-based structural unit.

The imidization reaction can be implemented by a conventional method that is commonly known without any specific limitations. For example, the imidization reaction can be caused to proceed using an extruder or a batch-type reaction tank.

The extruder is not specifically limited and may be a single-screw extruder, a twin-screw extruder, a multiscrew extruder, or the like, for example. Of these extruders, the use of a twin-screw extruder is preferable. The use of a twin-screw extruder can promote mixing of the raw material polymer and imidization agent.

The twin-screw extruder may be a non-inter-meshing co-rotating type, an inter-meshing co-rotating type, a non-intermeshing counter-rotating type, an inter-meshing counter-rotating type, or the like, for example.

The extruders given as examples above may be used individually, or a plurality of the extruders may be linked in series and used.

It is particularly preferable that the used extruder is provided with a vent port that enables depressurization to atmospheric pressure or lower in order to remove imidization agent, by-products such as methanol, and/or monomers of the reaction.

In addition to the imidization step described above, production of the methacrylic resin including a glutarimide-based structural unit can also include an esterification step of treating carboxyl groups of the resin with an esterification agent such as dimethyl carbonate. A catalyst such as trimethylamine, triethylamine, or tributylamine can also be used in this treatment.

The esterification step can be caused to proceed using an extruder or a batch-type reaction tank, for example, in the same manner as the imidization step.

The used device is preferably provided with a vent port that enables depressurization to atmospheric pressure or lower in order to remove excess esterification agent, by-products such as methanol, and/or monomers. In a situation in which carboxyl groups are not esterified at this time, the residual carboxyl groups increase water absorption of the resin and lead to deterioration of surface accuracy of the light-guiding member in reliability testing in a high-humidity environment. Moreover, insufficient devolatilization of an esterification agent such as dimethyl carbonate or an amine is undesirable because an acidic substance or alkaline substance remains.

The methacrylic resin obtained through the imidization step and, as necessary, the esterification step is melted and extruded in the form of strands from an extruder equipped with a multi-hole die and is processed into the form of pellets by cold cutting pelletizing, hot cutting pelletizing in air, strand cutting pelletizing in water, underwater pelletizing, or the like.

Moreover, the adoption of a method in which the methacrylic resin is dissolved in an organic solvent such as toluene, methyl ethyl ketone, or methylene chloride, the resultant methacrylic resin solution is filtered, and the organic solvent is subsequently volatilized is also preferable for reducing foreign substances in the resin.

From a viewpoint of reducing the strength of fluorescence (content of fluorescent substances), it is preferable that imidization of the polymerization solution present after polymerization is performed in a batch-type reaction tank and that a twin-screw extruder where shear force is imparted is not used.

The imidization reaction is preferably performed at 130° C. to 250° C., more preferably performed at 150° C. to 230° C., and even more preferably performed at 170° C. to 190° C. Moreover, the reaction time is preferably 10 minutes to 5 hours, and more preferably 30 minutes to 2 hours.

After the imidization step, and after the esterification step as necessary, it is preferable from a viewpoint of reducing the strength of fluorescence that devolatilization is performed by a devolatilization method described in relation to the production method of the methacrylic resin including a structural unit derived from an N-substituted maleimide monomer described above and that pelletization is performed after this devolatilization.

### —Production Method of Methacrylic Resin Including Lactone Ring Structural Unit—

The method used to produce the methacrylic resin including a lactone ring structural unit in a main chain is a method in which a lactone ring structure is formed by a cyclization reaction after polymerization. In order to promote this cyclization reaction, it is preferable that monomers are polymerized by radical polymerization through a solution polymerization method using a solvent.

The polymerization process in the production method in the present embodiment may, for example, be a batch polymerization process, a semi-batch polymerization process, or a continuous polymerization process.

The methacrylic resin including a lactone ring structural unit in a main chain can be formed by a method described in JP 2001-151814 A, JP 2004-168882 A, JP 2005-146084 A, JP 2006-96960 A, JP 2006-171464 A, JP 2007-63541 A, JP 2007-297620 A, or JP 2010-180305 A, for example.

The following provides a specific description of a case in which production is carried out by a batch process through radical polymerization using solution polymerization as one example of a method of producing the methacrylic resin including a lactone ring structural unit.

The method used to produce the methacrylic resin including a lactone ring structural unit is a method in which a lactone ring structure is formed by a cyclization reaction after polymerization, and solution polymerization using a solvent is preferable in order to promote this cyclization reaction.

A solvent that is used in the polymerization may be an aromatic hydrocarbon such as toluene, xylene, or ethylbenzene; a ketone such as methyl ethyl ketone or methyl isobutyl ketone; or the like, for example.

One of these solvents may be used individually, or two or more of these solvents may be used together.

The amount of the solvent in polymerization is not specifically limited so long it is a condition under which polymerization proceeds and gelation can be inhibited, but when the total amount of compounded monomers is taken to be 100 mass %, for example, the amount of the solvent is preferably 50 mass % to 200 mass %, and more preferably 100 mass % to 200 mass %.

In order to sufficiently inhibit gelation of the polymerization solution and promote the cyclization reaction after polymerization, polymerization is preferably performed such that the concentration of produced polymer in the reaction mixture obtained after polymerization is 50 mass % or less. This concentration is preferably controlled to 50 mass % or less by adding the polymerization solvent to the reaction mixture as appropriate.

The method by which the polymerization solvent is added to the reaction mixture as appropriate is not specifically limited and may be by adding the polymerization solvent continuously or by adding the polymerization solvent intermittently, for example.

The polymerization solvent that is added may be a single type of solvent or a mixed solvent of two or more types of solvents.

Although no specific limitations are placed on the polymerization temperature other than being a temperature at which polymerization proceeds, the polymerization temperature is preferably 50° C. to 200° C., and more preferably 80° C. to 180° C. from a viewpoint of productivity.

Although no specific limitations are placed on the polymerization time so long as the target conversion rate can be achieved, the polymerization time is preferably 0.5 hours to 10 hours, and more preferably 1 hour to 8 hours from viewpoints of productivity and the like.

In the polymerization reaction, polymerization may be performed with addition of a polymerization initiator and/or a chain transfer agent as necessary.

The polymerization initiator may be, but is not specifically limited to, any of the polymerization initiators disclosed in relation to the production method of the methacrylic resin including a structural unit derived from an N-substituted maleimide monomer described above, for example.

One of these polymerization initiators may be used individually, or two or more of these polymerization initiators may be used together.

These polymerization initiators may be added at any stage so long as the polymerization reaction is in progress.

Although the additive amount of the polymerization initiator is not specifically limited and should be set as appropriate according to the combination of monomers, the reaction conditions, and so forth, the additive amount of the polymerization initiator when the total amount of monomers used in polymerization is taken to be 100 mass % may be 0.05 mass % to 1 mass %.

The chain transfer agent may be any chain transfer agent that is commonly used in radical polymerization and examples thereof include the chain transfer agents disclosed in relation to the production method of the methacrylic resin including a structural unit derived from an N-substituted maleimide monomer described above, for example.

One of these chain transfer agents may be used individually, or two or more of these chain transfer agents may be used together.

These chain transfer agents may be added at any stage, without any specific limitations, so long as the polymerization reaction is in progress.

Although no specific limitations are placed on the additive amount of the chain transfer agent so long as the desired degree of polymerization is obtained under the adopted polymerization conditions, the additive amount of the chain transfer agent when the total amount of monomers used in polymerization is taken to be 100 mass % may preferably be 0.05 mass % to 1 mass %.

Suitable addition methods of the polymerization initiator and the chain transfer agent in the polymerization step may be methods that were described in relation to the production method of the methacrylic resin including a structural unit derived from an N-substituted maleimide monomer described above, for example.

The dissolved oxygen concentration in the polymerization solution may be a value that was disclosed in relation to the production method of the methacrylic resin including a structural unit derived from an N-substituted maleimide monomer described above, for example.

The methacrylic resin including a lactone ring structural unit in the present embodiment can be obtained by performing a cyclization reaction once the polymerization reaction described above has ended. Therefore, it is preferable that the polymerization solvent is not removed from the polymerization reaction solution and that the polymerization reaction solution is subjected to the lactone cyclization reaction in a state containing the solvent.

The copolymer obtained by polymerization is heat treated to thereby instigate a cyclocondensation reaction between a hydroxyl group and an ester group present in a molecular chain of the copolymer and form a lactone ring structure.

The heat treatment for lactone ring structure formation can be performed using a reaction device that includes a vacuum device or devolatilization device, an extruder that includes a devolatilization device, or the like in order to remove alcohol that can be produced as a by-product of the cyclocondensation.

In formation of the lactone ring structure, the heat treatment may be performed in the presence of a cyclocondensation catalyst to promote the cyclocondensation reaction.

Specific examples of cyclocondensation catalysts include phosphorous acid monoalkyl esters, dialkyl esters, and trialkyl esters such as methyl phosphite, ethyl phosphite, phenyl phosphite, dimethyl phosphite, diethyl phosphite, diphenyl phosphite, trimethyl phosphite, and triethyl phosphite; phosphoric acid monoalkyl esters, dialkyl esters and trialkyl esters such as methyl phosphate, ethyl phosphate, 2-ethylhexyl phosphate, octyl phosphate, isodecyl phosphate, lauryl phosphate, stearyl phosphate, isostearyl phosphate, dimethyl phosphate, diethyl phosphate, di-2-ethylhexyl phosphate, diisodecyl phosphate, dilauryl phosphate, distearyl phosphate, diisostearyl phosphate, trimethyl phosphate, triethyl phosphate, triisodecyl phosphate, trilauryl phosphate, tristearyl phosphate, and triisostearyl phosphate; and organozinc compounds such as zinc acetate, zinc propionate, and octyl zinc.

One of these cyclocondensation catalysts may be used individually, or two or more of these cyclocondensation catalysts may be used together.

Although no specific limitations are placed on the used amount of the cyclocondensation catalyst, the amount of the cyclocondensation catalyst is preferably 0.01 mass % to 3 mass %, and more preferably 0.05 mass % to 1 mass % relative to 100 mass % of the methacrylic resin, for example.

The use of 0.01 mass % or more of the catalyst is effective for improving the rate of the cyclocondensation reaction, whereas the use of 3 mass % or less of the catalyst is effective for preventing coloring of the resultant polymer and polymer crosslinking that then makes melt molding difficult.

The timing of addition of the cyclocondensation catalyst is not specifically limited and may be addition in an initial stage of the cyclocondensation reaction, addition partway through the reaction, or addition at both of these timings, for example.

In a situation in which the cyclocondensation reaction is carried out in the presence of a solvent, devolatilization can be carried out concurrently with the reaction.

Although no specific limitations are placed on the device used in a situation in which the cyclocondensation reaction and a devolatilization step are carried out concurrently, it is preferable to use a devolatilization device comprising a heat exchanger and a devolatilization tank, a vented extruder, or an apparatus in which a devolatilization device and an extruder are arranged in series, and more preferable to use a vented twin-screw extruder.

The vented twin-screw extruder that is used is preferably a vented extruder having a plurality of vent ports.

The reaction treatment temperature in a case in which a vented extruder is used it preferably 150° C. to 350° C., and more preferably 200° C. to 300° C. A reaction treatment temperature of lower than 150° C. may result in an inadequate cyclocondensation reaction and the presence of a large amount of residual volatile content. Conversely, a reaction treatment temperature of higher than 350° C. may cause coloring and decomposition of the resultant polymer.

The degree of vacuum in a case in which a vented extruder is used is preferably 10 Torr to 500 Torr, and more preferably 10 Torr to 300 Torr. A degree of vacuum of higher than 500 Torr makes it likely that volatile content will remain. Conversely, a degree of vacuum of lower than 10 Torr may make industrial implementation difficult.

In a situation in which the cyclocondensation reaction described above is performed, an alkaline earth metal and/or amphoteric metal salt of an organic acid is preferably added in pelletization with the aim of deactivating residual cyclocondensation catalyst.

The alkaline earth metal and/or amphoteric metal salt of an organic acid may be calcium acetyl acetate, calcium stearate, zinc acetate, zinc octanoate, zinc 2-ethylhexanoate, or the like, for example.

After the cyclocondensation reaction step is completed, the methacrylic resin is melted and extruded as strands from an extruder equipped with a multi-hole die and is then processed into the form of pellets by cold cutting pelletizing, hot cutting pelletizing in air, strand cutting pelletizing in water, or underwater pelletizing.

Note that the lactonization for forming the lactone ring structural unit described above may be performed after resin production and before resin composition production (described further below) or may be performed together with melt-kneading of the resin with components other than the resin during resin composition production.

From a viewpoint of reducing the strength of fluorescence (content of fluorescent substances), it is preferable that lactone ring formation of the polymerization solution present after the end of polymerization is performed in a batch-type reaction tank and that a twin-screw extruder where shear force is imparted is not used. After the lactone ring formation step, it is preferable from a viewpoint of reducing the strength of fluorescence that devolatilization is performed by a devolatilization method described in relation to the production method of the methacrylic resin including a structural unit derived from an N-substituted maleimide monomer described above and that pelletization is performed after this devolatilization.

### —Production Method of Methacrylic Resin Including Hydrogenated Aromatic Ring Structural Unit—

The production method of the methacrylic resin including a hydrogenated aromatic ring structural unit may be a method in which a copolymer of an aromatic vinyl compound and a (meth)acrylate is hydrogenated in the presence of a hydrogenation catalyst and a reaction solvent to produce a nuclear hydrogenated polymer.

Polymerization of monomers including an aromatic vinyl compound and a (meth)acrylate can be performed using any commonly known method, but a method by radical polymerization is convenient in an industrial context. A commonly known method such as bulk polymerization, solution polymerization, emulsion polymerization, or suspension polymerization can be selected as appropriate as the radical polymerization, but production by bulk polymerization or solution polymerization is preferable in order to avoid the inclusion of water at the time of the hydrogenation reaction. The polymerization process in the production method in the present embodiment may, for example, be a batch polymerization process, a semi-batch polymerization process, or a continuous polymerization process.

The methacrylic resin including a hydrogenated aromatic ring structural unit can be formed by a method described in JP 2006-291184 A, JP 2014-77043 A, or JP 2014-77044A, for example.

The following provides a specific description of one example of a production method of a methacrylic resin including a hydrogenated aromatic ring structural unit that is obtained through hydrogenation of a copolymer of an aromatic vinyl compound and a (meth)acrylate.

The solvent that is used in polymerization is required to not only itself be stable under the reaction conditions, but also to provide good solubility of a copolymer before and after the hydrogenation reaction (i.e., the copolymer of an aromatic vinyl compound and a (meth)acrylate and the nuclear hydrogenated polymer obtained through aromatic ring hydrogenation) and solubility of hydrogen and enable the reaction to be performed quickly. Moreover, in a situation which devolatilization of a solvent component after reaction is anticipated, it is also important for the solvent to have a high ignition point. Examples of solvents satisfying these requirements include hydrocarbon compounds such as n-pentane, n-hexane, n-octane, and cyclohexane; ether compounds such as 1,4-dioxane, tetrahydrofuran, ethylene glycol dimethyl ether, and diethylene glycol dimethyl ether; amide compounds such as dimethylformamide and dimethylacetamide; and ester compounds, with ether compounds and ester compounds, in particular, being suitable.

Tetrahydrofuran is particularly suitable as an ether compound. One of these solvents may be used individually, or two or more of these solvents may be used together.

A carboxylic acid ester compound is suitable as an ester compound. The carboxylic acid ester compound may be an aliphatic ester compound and is suitably a compound represented by the following general formula (5).

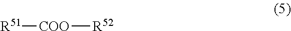

In general formula (5), R⁵¹ is an alkyl group having 1 to 6 carbon atoms, and R⁵² is an alkyl group having 1 to 6 carbon atoms. Examples of R⁵¹ and R⁵² include a methyl group, an ethyl group, a propyl group, an isopropyl group, a butyl group, an isobutyl group, a pentyl group, a hexyl group, and a cyclohexyl group. The ester compound may be methyl acetate, ethyl acetate, n-butyl acetate, pentyl acetate, methyl propionate, ethyl propionate, n-propyl propionate, n-butyl propionate, methyl n-butyrate, methyl isobutyrate, n-butyl n-butyrate, methyl n-valerate, methyl n-hexanoate, or the like, with methyl acetate, ethyl acetate, methyl propionate, methyl isobutyrate, and methyl n-butyrate, in particular, being even more suitable.

The concentration of the copolymer (the copolymer of an aromatic vinyl compound and a (meth)acrylate and the nuclear hydrogenated polymer obtained through aromatic ring hydrogenation) in the solution during the hydrogenation reaction is normally 1 wt % to 50 wt %, preferably 3 wt % to 30 wt %, and even more preferably 5 wt % to 25 wt %. An excessively high copolymer concentration is undesirable from perspectives such as reduction of the rate of reaction and inconvenience of handling due to increased solution viscosity, whereas a low concentration is undesirable from perspectives of productivity and economy.

The water concentration in the polymer solution before the hydrogenation reaction is 0.5 wt % or less, preferably 0.2 wt % or less, and even more preferably 0.05 wt % or less. A water content of more than 0.5 wt % may result in coloring of the produced nuclear hydrogenated polymer (pellets, powder), making it undesirable as an optical material.

Although a polymerization initiator and a chain transfer agent can be added as necessary in the polymerization reaction, it is desirable that the inclusion of sulfur is avoided as much as possible because sulfur content impairs the hydrogenation reaction.

The polymerization initiator is not specifically limited so long as it does not have a sulfur functional group and can, for example, be any of the polymerization initiators disclosed in relation to the production method of the methacrylic resin including a structural unit derived from an N-substituted maleimide monomer described above.

One of these polymerization initiators may be used individually, or two or more of these polymerization initiators may be used together.

These polymerization initiators may be added at any stage so long as the polymerization reaction is in progress.

Although the additive amount of the polymerization initiator is not specifically limited and should be set as appropriate according to the combination of monomers, the reaction conditions, and so forth, the additive amount of the polymerization initiator when the total amount of monomers used in polymerization is taken to be 100 mass % may be 0.05 mass % to 1 mass %.

Suitable addition methods of the polymerization initiator and the chain transfer agent in the polymerization step may be methods that were described in relation to the production method of the methacrylic resin including a structural unit derived from an N-substituted maleimide monomer described above, for example.

The dissolved oxygen concentration in the polymerization solution may be a value that was disclosed in relation to the production method of the methacrylic resin including a structural unit derived from an N-substituted maleimide monomer described above, for example.

A chain transfer agent is not necessarily required. Moreover, in a case in which a chain transfer agent is used, it is preferable to use a carbon tetrahalide such as carbon tetrachloride, carbon tetrabromide, or carbon tetraiodide or a dimer of a styrene such as 2,4-diphenyl-4-methyl-1-pentene.

Chain transfer agents based on mercaptan compounds, which are commonly used, are undesirable because they introduce a sulfur functional group at a polymer terminal and impair the hydrogenation reaction of an aromatic ring.

One of these chain transfer agents may be used individually, or two or more of these chain transfer agents may be used together.

These chain transfer agents may be added at any stage, without any specific limitations, so long as the polymerization reaction is in progress.

Although no specific limitations are placed on the additive amount of the chain transfer agent so long as the desired degree of polymerization is obtained under the adopted polymerization conditions, the additive amount of the chain transfer agent when the total amount of monomers used in polymerization is taken to be 100 mass % may preferably be 0.05 mass % to 1 mass %.

Note that although thermal decomposition properties of a raw material polymer are generally poorer in a situation in which a mercaptan compound-based chain transfer agent is not used, in the case of a methacrylic resin including a hydrogenated aromatic ring structural unit, physical properties such as decomposition temperature are only dependent on the hydrogenation rate, and the use of a sulfuric chain transfer agent does not influence the decomposition temperature so long as the hydrogenation rate is the same.

No specific limitations are placed on the catalyst used in the hydrogenation reaction (hydrogenation catalyst) so long as it has hydrogenation activity. Specifically, nickel, ruthenium, rhodium, palladium, platinum, or the like may be used. Of these catalysts, palladium supported on a carrier is particularly preferable because it provides a high reaction rate and ensures that the solvent is retained between before and after the reaction without undergoing side reactions. In general, activated carbon, alumina (Al₂O₃), silica (SiO₂), silica-alumina (SiO₂—Al₂O₃), diatomaceous earth, zirconium oxide, or the like is used as a catalyst carrier. Although no limitations are placed on the carrier of the catalyst in the present disclosure, activated carbon, alumina, or zirconium oxide is preferable.

The supported amount of palladium metal on the carrier is typically within a range of 0.01 wt % to 50 wt %, preferably 0.05 wt % to 20 wt %, and more preferably 0.1 wt % to 10 wt %. From an economic standpoint, it is preferable to minimize the used amount of palladium, which is an expensive metal, but when activated carbon or zirconium oxide is used as the carrier, palladium can be supported with high dispersion, and since the reaction rate per unit of palladium is extremely high, a sufficient reaction rate can be maintained even when the supported amount of palladium is within the range of 0.1 wt % to 1.0 wt %. The dispersion of palladium is measured using a known method such as the carbon monoxide pulse adsorption method.

A commonly known salt or complex such as palladium chloride, palladium nitrate, or palladium acetate can be used as a precursor of palladium. The precursor is made into a solution when it is to be impregnated and mounted on the carrier. Examples of precursor solution combinations (precursor/solvent) that may be adopted include palladium chloride/hydrochloric acid aqueous solution, palladium chloride/sodium chloride aqueous solution, palladium nitrate/water, palladium nitrate/hydrochloric acid aqueous solution, palladium acetate/hydrochloric acid aqueous solution, and palladium acetate/organic solvent.

Preferred conditions for the hydrogenation reaction are a temperature of 60° C. to 250° C., a hydrogen pressure of 3 MPa to 30 MPa, and a reaction time of 3 hours to 20 hours. An excessively low reaction temperature is undesirable because the reaction rate slows, whereas an excessively high reaction temperature is undesirable because side reactions such as decomposition of the polymer and hydrogenolysis of the solvent may occur. Moreover, a low hydrogen pressure results in a slower reaction rate, whereas conversely attempting to further raise the hydrogen pressure requires a reactor having high pressure resistance, making it economically undesirable.

Separation of the hydrogenation catalyst and volatile components (solvent, etc.) from the polymer solution after the hydrogenation reaction makes it possible to obtain a nuclear hydrogenated polymer.

The catalyst can be separated by a commonly known technique such as filtration or centrifugal separation. In consideration of coloring, impact on mechanical properties, etc., it is necessary to minimize the concentration of residual catalyst metal in the polymer, with a concentration of 10 ppm or less being preferable, and a concentration of 1 ppm or less more preferable.

After catalyst separation, it is preferable that devolatilization is performed by the devolatilization method described in relation to the production method of the methacrylic resin including a structural unit derived from an N-substituted maleimide monomer described above as a method of separating volatile components such as the solvent from the resultant nuclear hydrogenated polymer solution and thereby purifying the polymer, and that pelletization is performed after this devolatilization.

### <<Additives>>

The resin composition forming the light-guiding member of the present embodiment may contain various additives to the extent that the effects according to the present disclosure are not significantly impaired.

Examples of such additives include, but are not specifically limited to, antioxidants; light stabilizers such as hindered amine light stabilizers; ultraviolet absorbers; mold release agents; thermoplastic resins other than methacrylic resins; softeners and plasticizers such as paraffinic process oils, naphthenic process oils, aromatic process oils, paraffin, organic polysiloxanes, and mineral oils; flame retardants; antistatic agents; reinforcers such as organic fibers, inorganic fillers such as pigments (iron oxide, etc.), glass fibers, carbon fibers, and metal whiskers; colorants; organophosphorus compounds such as phosphorus acid esters, phosphonites, and phosphoric acid esters; other additives; and mixtures of any of the preceding examples.

### —Antioxidant—

The resin composition forming the substrate section according to the present embodiment preferably contains an antioxidant that suppresses degradation and coloring in molding or during use.

The antioxidant may be a hindered phenol antioxidant, a phosphoric antioxidant, a sulfuric antioxidant, or the like, for example, but is not limited thereto. One of these antioxidants may be used, or two or more of these antioxidants may be used together.

From a viewpoint of improving thermal stability and inhibiting molding faults, it is preferable that a plurality of heat stabilizers are used together. For example, it is preferable to use a hindered phenol antioxidant together with at least one selected from a phosphoric antioxidant and a sulfuric antioxidant.

Examples of the hindered phenol antioxidant include, but are not limited to, pentaerythritol tetrakis[3-(3,5-di-tert-butyl-4-hydroxyphenyl)propionate], thiodiethylene bis[3-(3,5-di-tert-butyl-4-hydroxyphenyl)propionate], octadecyl-3-(3,5-di-tert-butyl-4-hydroxyphenyl)propionate, 3,3′,3″,5,5′,5″-hexa-tert-butyl-a,a′,a″-(mesitylene-2,4,6-triyl)tri-p-cresol, 4,6-bis(octylthiomethyl)-o-cresol, 4,6-bis(dodecylthiomethyl)-o-cresol, ethylene bis(oxyethylene) bis[3-(5-tert-butyl-4-hydroxy-m-tolyl)propionate], hexamethylene bis[3-(3,5-di-tert-butyl-4-hydroxyphenyl)propionate], 1,3,5-tris(3,5-di-tert-butyl-4-hydroxybenzyl)-1,3,5-triazine-2,4,6(1H,3H,5H)-trione, 1,3,5-tris[(4-tert-butyl-3-hydroxy-2,6-xylene)methyl]-1,3,5-triazine-2,4,6(1H,3H,5H)-trione, 2,6-di-tert-butyl-4-(4,6-bis(octylthio)-1,3,5-triazin-2-ylamine)phenol, 2-[1-(2-hydroxy-3,5-di-tert-pentylphenyl)ethyl]-4,6-di-tert-pentylphenyl acrylate, and 2-tert-butyl-4-methyl-6-(2-hydroxy-3-tert-butyl-5-methylbenzyl)phenyl acrylate.

In particular, pentaerythritol tetrakis[3-(3,5-di-tert-butyl-4-hydroxyphenyl)propionate], octadecyl-3-(3,5-di-t-butyl-4-hydroxyphenyl)propionate, and 2-[1-(2-hydroxy-3,5-di-tert-pentylphenyl)ethyl]-4,6-di-tert-pentylphenyl acrylate are preferable.

Also, a commercially available phenolic antioxidant may be used as the hindered phenol antioxidant. Examples of such commercially available phenolic antioxidants include, but are not limited to, Irganox 1010 (pentaerythritol tetrakis[3-(3,5-di-t-butyl-4-hydroxyphenyl)propionate]; produced by BASF Corporation), Irganox 1076 (octadecyl-3-(3,5-di-t-butyl-4-hydroxyphenyl)propionate; produced by BASF Corporation), Irganox 1330 (3,3′,3″,5,5′,5″-hexa-t-butyl-a,a′,a″-(mesitylene-2,4,6-triyl)tri-p-cresol; produced by BASF Corporation), Irganox 3114 (1,3,5-tris(3,5-di-t-butyl-4-hydroxybenzyl)-1,3,5-triazine-2,4,6(1H,3H,5H)-trione; produced by BASF Corporation), Irganox 3125 (produced by BASF Corporation), ADK STAB AO-60 (pentaerythritol tetrakis[3-(3,5-di-t-butyl-4-hydroxyphenyl)propionate]; produced by Adeka Corporation), ADK STAB AO-80 (3,9-bis{2-[3-(3-t-butyl-4-hydroxy-5-methylphenyl)propionyloxy]-1,1-dimethylethyl}-2,4,8,10-tetraoxaspiro[5.5]undecane; produced by Adeka Corporation), Sumilizer BHT (produced by Sumitomo Chemical Co., Ltd.), Cyanox 1790 (produced by Cytec Solvay Group), Sumilizer GA-80 (produced by Sumitomo Chemical Co., Ltd.), Sumilizer GS (2-[1-(2-hydroxy-3,5-di-tert-pentylphenyl)ethyl]-4,6-di-tert-pentylphenyl) acrylate; produced by Sumitomo Chemical Co., Ltd.), Sumilizer GM (2-tert-butyl-4-methyl-6-(2-hydroxy-3-tert-butyl-5-methylbenzyl)phenyl acrylate; produced by Sumitomo Chemical Co., Ltd.), and vitamin E (produced by Eisai Co., Ltd.).

Of these commercially available phenolic antioxidants, Irganox 1010, ADK STAB AO-60, ADK STAB AO-80, Irganox 1076, Sumilizer GS, and the like are preferable from a viewpoint of an effect of imparting thermal stability to the resin.

Just one of these phenolic antioxidants may be used individually, or two or more of these phenolic antioxidants may be used together.

Examples of phosphoric antioxidants that may be used as the antioxidant include, but are not limited to, tris(2,4-di-t-butylphenyl) phosphite, phosphorous acid bis(2,4-bis(1,1-dimethylethyl)-6-methylphenyl)ethyl ester, tetrakis(2,4-di-t-butylphenyl)(1,1-biphenyl)-4,4′-diyl bisphosphonite, bis(2,4-di-t-butylphenyl)pentaerythritol diphosphite, bis(2,6-di-t-butyl-4-methylphenyl)pentaerythritol diphosphite, bis(2,4-dicumylphenyl)pentaerythritol diphosphite, tetrakis(2,4-t-butylphenyl)(1,1-biphenyl)-4,4′-diyl bisphosphonite, di-t-butyl-m-cresyl-phosphonite, and 4-[3-[(2,4,8,10-tetra-tert-butyldibenzo[d,f][1,3,2]dioxaphosphepin)-6-yloxy]propyl]-2-methyl-6-tert-butylphenol.

A commercially available phosphoric antioxidant may be used as the phosphoric antioxidant. Examples of such commercially available phosphoric antioxidants include, but are not limited to, Irgafos 168 (tris(2,4-di-t-butylphenyl) phosphite; produced by BASF Corporation), Irgafos 12 (tris[2-[[2,4,8,10-tetra-t-butyldibenzo[d,f][1,3,2]dioxaphosphepin-6-yl]oxy]ethyl]amine; produced by BASF Corporation), Irgafos 38 (phosphorous acid bis(2,4-bis(1,1-dimethylethyl)-6-methylphenyl)ethyl ester; produced by BASF Corporation), ADK STAB 329K (produced by Adeka Corporation), ADK STAB PEP-36 (produced by Adeka Corporation), ADK STAB PEP-36A (produced by Adeka Corporation), ADK STAB PEP-8 (produced by Adeka Corporation), ADK STAB HP-10 (produced by Adeka Corporation), ADK STAB 2112 (produced by Adeka Corporation), ADK STAB 1178 (produced by Adeka Corporation), ADK STAB 1500 (produced by Adeka Corporation), Sandstab P-EPQ (produced by Clariant), Weston 618 (produced by GE Corporation), Weston 619G (produced by GE Corporation), Ultranox 626 (produced by GE Corporation), Sumilizer GP (4-[3-[(2,4,8,10-tetra-tert-butyldibenzo[d,f][1,3,2]dioxaphosphepin)-6-yloxy]propyl]-2-methyl-6-tert-butylphenol; produced by Sumitomo Chemical Co., Ltd.), and HCA (9,10-dihydro-9-oxa-10-phosphaphenanthrene-10-oxide; produced by Sanko Co., Ltd.).

Of these commercially available phosphoric antioxidants, Irgafos 168, ADK STAB PEP-36, ADK STAB PEP-36A, ADK STAB HP-10, and ADK STAB 1178 are preferable from a viewpoint of an effect of imparting thermal stability to the resin and an effect of combined use with various antioxidants, and ADK STAB PEP-36A and ADK STAB PEP-36 are particularly preferable.

Just one of these phosphoric antioxidants may be used individually, or two or more of these phosphoric antioxidants may be used together.

Examples of the sulfuric antioxidant include, but are not limited to, 2,4-bis(dodecylthiomethyl)-6-methylphenol (Irganox 1726 produced by BASF Corporation), 2,4-bis(octylthiomethyl)-6-methylphenol (Irganox 1520L produced by BASF Corporation), 2,2-bis[[3-(dodecylthio)-1-oxopropoxy]methyl]propane-1,3-diyl bis[3-(dodecylthio)prop]onate](ADK STAB AO-412S produced by Adeka Corporation), 2,2-bis[[3-(dodecylthio)-1-oxopropoxy]methyl]propane-1,3-diyl bis[3-(dodecylthio)prop]onate](KEMINOX PLS produced by Chemipro Kasei Kaisha, Ltd.), and di(tridecyl)-3,3′-thiodipropionate (AO-503 produced by Adeka Corporation).

Of these commercially available sulfuric antioxidants, ADK STAB AO-412S and KEMINOX PLS are preferable from a viewpoint of an effect of imparting thermal stability to the resin and an effect of combined use with various antioxidants, and also from a viewpoint of handleability.

Just one of these sulfuric antioxidants may be used individually, or two or more of these sulfuric antioxidants may be used together.

Although the content of the antioxidant may be any amount with which an effect of improving thermal stability is obtained, an excessive content may lead to problems such as bleed-out during processing. Accordingly, the content of the antioxidant relative to 100 parts by mass of the methacrylic resin is preferably 5 parts by mass or less, more preferably 3 parts by mass or less, even more preferably 1 part by mass or less, further preferably 0.8 parts by mass or less, even further preferably 0.01 parts by mass to 0.8 parts by mass, and particularly preferably 0.01 parts by mass to 0.5 parts by mass.

Although the content of the antioxidant may be any amount with which an effect of improving thermal stability is obtained, an excessive content may lead to problems such as bleed-out during processing. Accordingly, the content of the antioxidant relative to 100 mass % of the methacrylic resin is preferably 5 mass % or less, more preferably 3 mass % or less, even more preferably 1 mass % or less, further preferably 0.8 mass % or less, even further preferably 0.01 mass % to 0.8 mass %, and particularly preferably 0.01 mass % to 0.5 mass %.

No specific limitations are placed on the timing of addition of the antioxidant. A method in which the antioxidant is added to the pre-polymerization monomer solution and then polymerization is initiated, a method in which the antioxidant is added and mixed into the post-polymerization polymer solution and then the devolatilization step is performed, a method in which the antioxidant is added and mixed into the polymer in a molten state after devolatilization and then pelletization is performed, a method in which the antioxidant is added and mixed into pellets that have undergone devolatilization and pelletization while these pellets are being melted and extruded once again, or the like may be adopted. Of these methods, it is preferable that the antioxidant is added and mixed into the post-polymerization polymer solution prior to the devolatilization step and that the devolatilization step is subsequently performed from a viewpoint of preventing thermal degradation and coloring in the devolatilization step.

### —Hindered Amine Light Stabilizer—

The resin composition forming the substrate section according to the present embodiment can contain a hindered amine light stabilizer.

The hindered amine light stabilizer is not specifically limited but is preferably a compound including three or more cyclic structures. It is preferable that the cyclic structures are at least one selected from the group consisting of aromatic rings, aliphatic rings, aromatic heterocycles, and nonaromatic heterocycles, and in a case in which a single compound includes two or more cyclic structures, these cyclic structures may be the same as or different from one another.

Specific examples of the hindered amine light stabilizer include, but are not limited to, bis(1,2,2,6,6-pentamethyl-4-piperidyl) [[3,5-bis(1,1-dimethylethyl)-4-hydroxyphenyl]methyl]butylmalonate; a mixture of bis(1,2,2,6,6-pentamethyl-4-piperidyl) sebacate and methyl-1,2,2,6,6-pentamethyl-4-piperidyl sebacate; bis(2,2,6,6-tetramethyl-4-piperidyl) sebacate; N,N′-bis(2,2,6,6-tetramethyl-4-piperidyl)-N,N′-diformylhexamethylenediamine; a polycondensate of dibutylamine, 1,3,5-triazine, and N,N′-bis(2,2,6,6-tetramethyl-4-piperidyl)-1,6-hexamethylenediamine with N-(2,2,6,6-tetramethyl-4-piperidyl)butylamine; poly[{6-(1,1,3,3-tetramethylbutyl)amino-1,3,5-triazine-2,4-diyl}{(2,2,6,6-tetramethyl-4-piperidyl)imino}hexamethylene {(2,2,6,6-tetramethyl-4-piperidyl)imino}]; tetrakis(1,2,2,6,6-pentamethyl-4-piperidyl)butane-1,2,3,4-tetracarboxylate; tetrakis(2,2,6,6-tetramethyl-4-piperidyl)butane-1,2,3,4-tetracarboxylate; a reaction product of 1,2,2,6,6-pentamethyl-4-piperidiol and β,β,β′,β′-tetramethyl-2,4,8,10-tetraoxaspiro[5.5]undecane-3,9-diethanol; a reaction product of 2,2,6,6-tetramethyl-4-piperidiol and β,β,β′,β′-tetramethyl-2,4,8,10-tetraoxaspiro[5.5]undecane-3,9-diethanol; bis(1-undecanoxy-2,2,6,6-tetramethylpiperidin-4-yl) carbonate; 1,2,2,6,6-pentamethyl-4-piperidyl methacrylate; and 2,2,6,6-tetramethyl-4-piperidyl methacrylate.

Of these hindered amine light stabilizers, bis(1,2,2,6,6-pentamethyl-4-piperidyl) [[3,5-bis(1,1-dimethylethyl)-4-hydroxyphenyl]methyl]butylmalonate; a polycondensate of dibutylamine, 1,3,5-triazine, and N,N′-bis(2,2,6,6-tetramethyl-4-piperidyl)-1,6-hexamethylenediamine with N-(2,2,6,6-tetramethyl-4-piperidyl)butylamine; poly[{6-(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}]; a reaction product of 1,2,2,6,6-pentamethyl-4-piperidiol and β,β,β′,β′-tetramethyl-2,4,8,10-tetraoxaspiro[5.5]undecane-3,9-diethanol; and a reaction product of 2,2,6,6-tetramethyl-4-piperidiol and β,β,β′,β′-tetramethyl-2,4,8,10-tetraoxaspiro[5.5]undecane-3,9-diethanol are preferable as compounds including three or more cyclic structures.

Although the content of the hindered amine light stabilizer may be any amount with which an effect of improving light stability is obtained, an excessive content may lead to problems such as bleed-out during processing. Accordingly, the content of the hindered amine light stabilizer relative to 100 mass % of the methacrylic resin is preferably 5 mass % or less, more preferably 3 mass % or less, even more preferably 1 mass % or less, further preferably 0.8 mass % or less, even further preferably 0.01 mass % to 0.8 mass %, and particularly preferably 0.01 mass % to 0.5 mass %.

### —Ultraviolet Absorber—

The resin composition can contain an ultraviolet absorber.

Although no specific limitations are placed on ultraviolet absorbers that can be used, an ultraviolet absorber having a maximum absorption wavelength at 280 nm to 380 nm is preferable. Examples of ultraviolet absorbers that can be used include benzotriazole compounds, benzotriazine compounds, benzophenone compounds, oxybenzophenone compounds, benzoate compounds, phenolic compounds, oxazole compounds, cyanoacrylate compounds, and benzoxazinone compounds.

Examples of benzotriazole compounds include 2,2′-methylenebis[4-(1,1,3,3-tetramethylbutyl)-6-(2H-benzotriazol-2-yl)phenol], 2-(3,5-di-tert-butyl-2-hydroxyphenyl)-5-chlorobenzotriazole, 2-(2H-benzotriazol-2-yl)-p-cresol, 2-(2H-benzotriazol-2-yl)-4,6-bis(1-methyl-1-phenylethyl)phenol, 2-benzotriazol-2-yl-4,6-di-tert-butylphenol, 2-[5-chloro(2H)-benzotriazol-2-yl]-4-methyl-6-t-butylphenol, 2-(2H-benzotriazol-2-yl)-4,6-di-t-butylphenol, 2-(2H-benzotriazol-2-yl)-4-(1,1,3,3-tetramethylbutyl)phenol, 2-(2H-benzotriazol-2-yl)-4-methyl-6-(3,4,5,6-tetrahydrophthalimidylmethyl)phenol, a reaction product of methyl 3-(3-(2H-benzotriazol-2-yl)-5-t-butyl-4-hydroxyphenyl)propionate/polyethylene glycol 300, 2-(2H-benzotriazol-2-yl)-6-(linear/branched dodecyl)-4-methylphenol, 2-(5-methyl-2-hydroxyphenyl)benzotriazole, 2-[2-hydroxy-3,5-bis(a,a-dimethylbenzyl)phenyl]-2H-benzotriazole, and 3-(2H-benzotriazol-2-yl)-5-(1,1-dimethylethyl)-4-hydroxy-C7-9 branched/linear alkyl esters.

Of these benzotriazole compounds, a benzotriazole compound having a molecular weight of 400 or more is preferable, examples of which that are commercially available products include Kemisorb® (Kemisorb is a registered trademark in Japan, other countries, or both) 2792 (produced by Chemipro Kasei Kaisha, Ltd.), ADK STAB® (ADK STAB is a registered trademark in Japan, other countries, or both) LA31 (produced by Adeka Corporation), and TINUVIN® (TINUVIN is a registered trademark in Japan, other countries, or both) 234 (produced by BASF Corporation).

Examples of benzotriazine compounds include 2-mono(hydroxyphenyl)-1,3,5-triazine compounds, 2,4-bis(hydroxyphenyl)-1,3,5-triazine compounds, and 2,4,6-tris(hydroxyphenyl)-1,3,5-triazine compounds, specific examples of which include 2,4-diphenyl-6-(2-hydroxy-4-methoxyphenyl)-1,3,5-triazine, 2,4-diphenyl-6-(2-hydroxy-4-ethoxyphenyl)-1,3,5-triazine, 2,4-diphenyl-(2-hydroxy-4-propoxyphenyl)-1,3,5-triazine, 2,4-diphenyl-(2-hydroxy-4-butoxyphenyl)-1,3,5-triazine, 2,4-diphenyl-6-(2-hydroxy-4-butoxyphenyl)-1,3,5-triazine, 2,4-diphenyl-6-(2-hydroxy-4-hexyloxyphenyl)-1,3,5-triazine, 2,4-diphenyl-6-(2-hydroxy-4-octyloxyphenyl)-1,3,5-triazine, 2,4-diphenyl-6-(2-hydroxy-4-dodecyloxyphenyl)-1,3,5-triazine, 2,4-diphenyl-6-(2-hydroxy-4-benzyloxyphenyl)-1,3,5-triazine, 2,4-diphenyl-6-(2-hydroxy-4-butoxyethoxy)-1,3,5-triazine, 2,4-bis(2-hydroxy-4-butoxyphenyl)-6-(2,4-dibutoxyphenyl)-1,3,5-triazine, 2,4,6-tris(2-hydroxy-4-methoxyphenyl)-1,3,5-triazine, 2,4,6-tris(2-hydroxy-4-ethoxyphenyl)-1,3,5-triazine, 2,4,6-tris(2-hydroxy-4-propoxyphenyl)-1,3,5-triazine, 2,4,6-tris(2-hydroxy-4-butoxyphenyl)-1,3,5-triazine, 2,4,6-tris(2-hydroxy-4-butoxyphenyl)-1,3,5-triazine, 2,4,6-tris(2-hydroxy-4-hexyloxyphenyl)-1,3,5-triazine, 2,4,6-tris(2-hydroxy-4-octyloxyphenyl)-1,3,5-triazine, 2,4,6-tris(2-hydroxy-4-dodecyloxyphenyl)-1,3,5-triazine, 2,4,6-tris(2-hydroxy-4-benzyloxyphenyl)-1,3,5-triazine, 2,4,6-tris(2-hydroxy-4-ethoxyethoxyphenyl)-1,3,5-triazine, 2,4,6-tris(2-hydroxy-4-butoxyethoxyphenyl)-1,3,5-triazine, 2,4,6-tris(2-hydroxy-4-propoxyethoxyphenyl)-1,3,5-triazine, 2,4,6-tris(2-hydroxy-4-methoxycarbonylpropyloxyphenyl)-1,3,5-triazine, 2,4,6-tris(2-hydroxy-4-ethoxycarbonylethyloxyphenyl)-1,3,5-triazine, 2,4,6-tris(2-hydroxy-4-(1-(2-ethoxyhexyloxy)-1-oxopropan-2-yloxy)phenyl)-1,3,5-triazine, 2,4,6-tris(2-hydroxy-3-methyl-4-methoxyphenyl)-1,3,5-triazine, 2,4,6-tris(2-hydroxy-3-methyl-4-ethoxyphenyl)-1,3,5-triazine, 2,4,6-tris(2-hydroxy-3-methyl-4-propoxyphenyl)-1,3,5-triazine, 2,4,6-tris(2-hydroxy-3-methyl-4-butoxyphenyl)-1,3,5-triazine, 2,4,6-tris(2-hydroxy-3-methyl-4-butoxyphenyl)-1,3,5-triazine, 2,4,6-tris(2-hydroxy-3-methyl-4-hexyloxyphenyl)-1,3,5-triazine, 2,4,6-tris(2-hydroxy-3-methyl-4-octyloxyphenyl)-1,3,5-triazine, 2,4,6-tris(2-hydroxy-3-methyl-4-dodecyloxyphenyl)-1,3,5-triazine, 2,4,6-tris(2-hydroxy-3-methyl-4-benzyloxyphenyl)-1,3,5-triazine, 2,4,6-tris(2-hydroxy-3-methyl-4-ethoxyethoxyphenyl)-1,3,5-triazine, 2,4,6-tris(2-hydroxy-3-methyl-4-butoxyethoxyphenyl)-1,3,5-triazine, 2,4,6-tris(2-hydroxy-3-methyl-4-propoxyethoxyphenyl)-1,3,5-triazine, 2,4,6-tris(2-hydroxy-3-methyl-4-methoxycarbonylpropyloxyphenyl)-1,3,5-triazine, 2,4,6-tris(2-hydroxy-3-methyl-4-ethoxycarbonylethyloxyphenyl)-1,3,5-triazine, and 2,4,6-tris(2-hydroxy-3-methyl-4-(1-(2-ethoxyhexyloxy)-1-oxopropan-2-yloxy)phenyl)-1,3,5-triazine.

A commercially available product may be used as the benzotriazine compound. For example, Kemisorb 102 (produced by Chemipro Kasei Kaisha, Ltd.), LA-F70 (produced by Adeka Corporation), LA-46 (produced by Adeka Corporation), TINUVIN 405 (produced by BASF Corporation), TINUVIN 460 (produced by BASF Corporation), TINUVIN 479 (produced by BASF Corporation), TINUVIN 1577FF (produced by BASF Corporation), or the like can be used.

In particular, it is even more preferable to use an ultraviolet absorber having a 2,4-bis(2,4-dimethylphenyl)-6-[2-hydroxy-4-(3-alkyloxy-2-hydroxypropyloxy)-5-α-cumylphenyl]-s-triazine skeleton (“alkyloxy” indicates a long chain alkyloxy group such as octyloxy, nonyloxy, or decyloxy) in terms of having high compatibility with an acrylic resin and excellent ultraviolet absorption characteristics.

In particular, the ultraviolet absorber is preferably a benzotriazine compound or benzotriazole compound having a molecular weight of 400 or more from a viewpoint of resin compatibility and volatility during heating, and is particularly preferably a benzotriazine compound from a viewpoint of inhibiting decomposition of the ultraviolet absorber itself under heating during extrusion.

The melting point (Tm) of the ultraviolet absorber is preferably 800 or higher, more preferably 100° C. or higher, even more preferably 130° C. or higher, and further preferably 160° C. or higher.

Weight loss of the ultraviolet absorber upon heating from 23° C. to 260° C. at a rate of 20° C./min is preferably 50% or less, more preferably 30% or less, even more preferably 15% or less, further preferably 10% or less, and even further preferably 5% or less.

One of these ultraviolet absorbers may be used individually, or two or more of these ultraviolet absorbers may be used together. The combined use of two ultraviolet absorbers having different structures enables absorption of ultraviolet light over a wide wavelength region.

Although no specific limitations are placed on the content of the ultraviolet absorber so long as it is an amount that does not impair heat resistance, wet heat resistance, thermal stability, and moldability and with which the effects according to the present disclosure are displayed, the content of the ultraviolet absorber relative to 100 parts by mass of the methacrylic resin is preferably 0.1 parts by mass to 5 parts by mass, preferably 0.2 parts by mass to 4 parts by mass, more preferably 0.25 parts by mass to 3 parts by mass, and even more preferably 0.3 parts by mass to 3 parts by mass. A content that is within any of these ranges provides an excellent balance of ultraviolet light absorption performance, moldability, and so forth.

—Mold Release Agent—The resin composition can contain a mold release agent. Examples of the mold release agent include, but are not limited to, fatty acid esters, fatty acid amides, fatty acid metal salts, hydrocarbon-based lubricants, alcohol-based lubricants, polyalkylene glycols, carboxylic acid esters, and paraffinic mineral oils of hydrocarbons.

Examples of fatty acid esters that can be used as the mold release agent include conventional fatty acid esters that are commonly known without any specific limitations.

Examples of fatty acid esters that can be used include ester compounds of a fatty acid having 12 to 32 carbon atoms such as lauric acid, palmitic acid, heptadecanoic acid, stearic acid, oleic acid, arachidic acid, or behenic acid with a monohydric aliphatic alcohol such as palmityl alcohol, stearyl alcohol, or behenyl alcohol or a polyhydric aliphatic alcohol such as glycerin, pentaerythritol, dipentaerythritol, or sorbitan; and complex ester compounds of a fatty acid, a polybasic organic acid, and a monohydric aliphatic alcohol or polyhydric aliphatic alcohol.

Examples of such fatty acid ester-based lubricants include cetyl palmitate, butyl stearate, stearyl stearate, stearyl citrate, glycerin monocaprylate, glycerin monocaprate, glycerin monolaurate, glycerin monopalmitate, glycerin dipalmitate, glycerin monostearate, glycerin distearate, glycerin tristearate, glycerin monooleate, glycerin dioleate, glycerin trioleate, glycerin monolinoleate, glycerin monobehenate, glycerin mono-12-hydroxystearate, glycerin di-12-hydroxystearate, glycerin tri-12-hydroxystearate, glycerin diacetomonostearate, glycerin citric acid fatty acid ester, pentaerythritol adipic acid stearic acid ester, montanic acid partially saponified ester, pentaerythritol tetrastearate, dipentaerythritol hexastearate, and sorbitan tristearate.

One of these fatty acid ester-based lubricants can be used individually, or two or more of these fatty acid ester-based lubricants can be used in combination.

Examples of commercially available products include the RIKEMAL series, POEM series, RIKESTER series, and RIKEMASTER series produced by Riken Vitamin Co., Ltd., and the EXCEL series, RHEODOL series, EXCEPARL series, and COCONAD series produced by Kao Corporation. More specific examples include RIKEMAL S-100, RIKEMAL H-100, POEM V-100, RIKEMAL B-100, RIKEMAL HC-100, RIKEMAL S-200, POEM B-200, RIKESTER EW-200, RIKESTER EW-400, EXCEL S-95, and RHEODOL MS-50.

Examples of fatty acid amides that can be used include conventional fatty acid amides that are commonly known without any specific limitations.

Examples of fatty acid amides include saturated fatty acid amides such as lauramide, palmitamide, stearamide, behenamide, and hydroxystearamide; unsaturated fatty acid amides such as oleamide, erucamide, and ricinoleamide; substituted amides such as N-stearyl stearamide, N-oleyl oleamide, N-stearyl oleamide, N-oleyl stearamide, N-stearyl erucamide, and N-oleyl palmitamide; methylol amides such as methylol stearamide and methylol behenamide; saturated fatty acid bisamides such as methylene bisstearamide, ethylene biscapramide, ethylene bislauramide, ethylene bisstearamide, ethylene bisisostearamide, ethylene bishydroxystearamide, ethylene bisbehenamide, hexamethylene bisstearamide, hexamethylene bisbehenamide, hexamethylene bishydroxystearamide, N,N′-distearyl adipamide, and N,N′-distearyl sebacamide; unsaturated fatty acid bisamides such as ethylene bisoleamide, hexamethylene bisoleamide, N,N′-dioleyl adipamide, and N,N′-dioleyl sebacamide; and aromatic bisamides such as m-xylylene bisstearamide and N,N′-distearyl isophthalamide.

One of these fatty acid amides can be used individually, or two or more of these fatty acid amides can be used in combination.

Examples of commercially available products include the DIAMID series (produced by Nippon Kasei Chemical Co., Ltd.), the AMIDE series (produced by Nippon Kasei Chemical Co., Ltd.), the NIKKA AMIDE series (produced by Nippon Kasei Chemical Co., Ltd.), the METHYLOL AMIDE series, BISAMIDE series, and SLIPACKS series (produced by Nippon Kasei Chemical Co., Ltd.), the KAO WAX series (produced by Kao Corporation), the FATTY AMIDE series (produced by Kao Corporation), and ethylene bisstearamides (produced by Dainichi Chemical Industry Co., Ltd.).

The fatty acid metal salt is a metal salt of a higher fatty acid and examples thereof include lithium stearate, magnesium stearate, calcium stearate, calcium laurate, calcium ricinoleate, strontium stearate, barium stearate, barium laurate, barium ricinoleate, zinc stearate, zinc laurate, zinc ricinoleate, zinc 2-ethylhexanoate, lead stearate, dibasic lead stearate, lead naphthenate, calcium 12-hydroxystearate, and lithium 12-hydroxystearate, of which, calcium stearate, magnesium stearate, and zinc stearate are particularly preferable due to an obtained transparent resin having excellent processability and extremely good transparency.

Examples of commercially available products include the SZ series, SC series, SM series, and SA series produced by Sakai Chemical Industry Co., Ltd.

In a case in which any of the fatty acid metal salts described above is used, the content thereof is preferably 0.2 mass % or less relative to 100 mass % of the resin composition from a viewpoint of retention of transparency.

One of the mold release agents described above may be used individually, or two or more of the mold release agents described above may be used together.

The mold release agent that is used preferably has an initial decomposition temperature of 200° C. or higher. The initial decomposition temperature can be measured as the 1% mass loss temperature according to TGA.

Although the content of the mold release agent may be any amount with which the effect as a mold release agent is obtained, an excessive content may lead to problems such as bleed-out during processing and poor extrusion caused by screw slipping. Accordingly, the content of the mold release agent relative to 100 mass % of the methacrylic resin is preferably 5 mass % or less, more preferably 3 mass % or less, even more preferably 1 mass % or less, further preferably 0.8 mass % or less, even further preferably 0.01 mass % to 0.8 mass %, and particularly preferably 0.01 mass % to 0.5 mass %. Addition in an amount that is within any of the ranges set forth above is preferable because reduction of transparency caused by addition of the mold release agent is suppressed, and the occurrence of demolding defects in injection molding tends to be inhibited.

Although the content of the mold release agent may be any amount with which the effect as a mold release agent is obtained, an excessive content may lead to problems such as bleed-out during processing and poor extrusion caused by screw slipping. Accordingly, the content of the mold release agent relative to 100 parts by mass of the methacrylic resin is preferably 5 parts by mass or less, more preferably 3 parts by mass or less, even more preferably 1 part by mass or less, further preferably 0.8 parts by mass or less, even further preferably 0.01 parts by mass to 0.8 parts by mass, and particularly preferably 0.01 parts by mass to 0.5 parts by mass. Addition in an amount that is within any of the ranges set forth above is preferable because reduction of transparency caused by addition of the mold release agent is suppressed, and the occurrence of demolding defects in injection molding tends to be inhibited.

In the case of a mold release agent with which problems such as bleed-out during processing and poor extrusion caused by screw slipping are not observed even when the content of the mold release agent is increased, increasing the additive amount of the mold release agent is expected to cause the mold release agent to act as a plasticizer. Specifically, the mold release agent may contribute to improving fluidity during molding and enable the production of a resin composition having excellent moldability of a thin wall molded piece and transferability of a fine shape. Moreover, when performing an annealing step with the aim of reducing residual stress in a molded article after molding, annealing at a temperature of approximately 35° C. to 50° C. lower than Tg of the resin composition in a case in which the melting point Tm of the mold release agent is within a temperature range of 30° C. to 80° C. lower than Tg enables the mold release agent to move in the same temperature region to promote relaxation of stress and thereby reduce residual stress. Furthermore, performing the annealing step in a temperature region that is sufficiently lower than Tg of the resin composition can also inhibit deformation of the shape of a molded product, maintain surface accuracy after molding, and provide a light-guiding member having good surface accuracy.

### (Other Thermoplastic Resins)

The resin composition forming the light-guiding member of the present embodiment can contain a thermoplastic resin other than the methacrylic resin with the aim of adjusting birefringence and improving flexibility without impairing the objects of the present disclosure.

Examples of other thermoplastic resins include polyacrylates such as polybutyl acrylate; styrenic polymers such as polystyrene, styrene-butyl acrylate copolymer, styrene-acrylonitrile copolymer, and acrylonitrile-butadiene-styrene block copolymer; acrylic rubber particles having a three- or four-layer structure such as described in JP S59-202213 A, JP S63-27516 A, JP S51-129449 A, or JP S52-56150 A, for example; rubbery polymers disclosed in JP S60-17406 B2 and JP H8-245854 A; and methacrylic rubber-containing graft copolymer particles obtained by multi-step polymerization described in WO 2014/002491 A1.

Of these other thermoplastic resins, a styrene-acrylonitrile copolymer or rubber-containing graft copolymer particles having a grafted portion in a surface layer thereof with a composition that is compatible with the methacrylic resin including a structural unit (X) having a cyclic structure in a main chain is preferable from a viewpoint of obtaining good optical properties and mechanical properties.

The average particle diameter of acrylic rubber particles, methacrylic rubber-containing graft copolymer particles, or a rubbery polymer such as described above is preferably 0.03 μm to 1 μm, and more preferably 0.05 μm to 0.5 μm from a viewpoint of enhancing impact strength, optical properties, and so forth of a molded article obtained using the composition of the present embodiment.

The content of other thermoplastic resins is preferably 0 parts by mass to 50 parts by mass, and more preferably 0 parts by mass to 25 parts by mass when the methacrylic resin is taken to be 100 parts by mass.

### (Higher Fatty Acid Ester)

The resin composition preferably contains a higher fatty acid ester.

The addition of a specific amount of a higher fatty acid ester to the resin composition enables expression of the target functions according to the present disclosure.

Moreover, the higher fatty acid ester is preferably a higher fatty acid ester having two or fewer hydroxy groups in a molecule. This is because it is possible to obtain an optical component having low haze and good optical properties.

The content of the higher fatty acid ester in the resin composition is preferably not less than 0.5 mass % and not more than 2.8 mass %, more preferably not less than 0.6 mass % and not more than 2.5 mass %, even more preferably not less than 0.7 mass % and not more than 1.7 mass %, and further preferably not less than 0.8 mass % and not more than 1.3 mass %.

Mixing of the higher fatty acid ester within any of the ranges set forth above dramatically improves fluidity of the resin and relieves orientation birefringence while also promoting relaxation of resin side chains and acting to relieve internal strain through only the higher fatty acid moving at a temperature in proximity to the melting point thereof. It also becomes possible to advantageously reduce only internal strain without deterioration of surface shape even in an annealing step.

In addition, by controlling the higher fatty acid ester to a prescribed amount within any of the ranges set forth above, it is possible to inhibit foreign substances and external appearance defects such as pressure marks during molding and also to retain high shape accuracy of a molded article.

Furthermore, it is also possible to inhibit the occurrence of staining of an insert mirror surface of a mold during molding, blocking of a vent section for gas release, and so forth.

Note that matter in the subsequent “Higher fatty acid ester” section is also applicable for description of the higher fatty acid ester.

### <Cycloolefin Copolymer Resin Composition>

It is also preferable for the resin composition forming the light-guiding member of the present embodiment to be a cycloolefin copolymer resin composition.

The cycloolefin copolymer resin composition is a resin composition containing a cycloolefin copolymer (hereinafter, also referred to as a “cycloolefin copolymer resin”) that is a copolymer of ethylene or an α-olefin with a cycloolefin.

### (Cycloolefin Copolymer)

In the present embodiment, the cycloolefin copolymer including a cycloolefin as a cyclic structure in a main chain includes a copolymer having a structural unit derived from a cycloolefin as an essential constitutional unit.

The cycloolefin copolymer is preferably a copolymer of ethylene or an α-olefin with a cycloolefin.

The cycloolefin copolymer that is contained in the cycloolefin copolymer resin composition of the present embodiment preferably includes at least one type of cycloolefin-derived structural unit (b) selected from the group consisting of a structural unit represented by the following general formula (II), a structural unit represented by the following general formula (III), and a structural unit represented by the following general formula (IV), and more preferably includes at least one type of olefin-derived structural unit (a) represented by the following general formula (I) and at least one type of cycloolefin-derived structural unit (b) selected from the group consisting of a structural unit represented by the following general formula (II), a structural unit represented by the following general formula (III), and a structural unit represented by the following general formula (IV) from a viewpoint that a good balance of performance in terms of transparency and refractive index of an obtained molded product can be maintained while also further improving heat resistance and improving moldability.

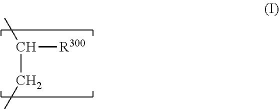

In the preceding general formula (I), R³⁰⁰ indicates a hydrogen atom or a linear or branched hydrocarbon group having 1 to 29 carbon atoms.

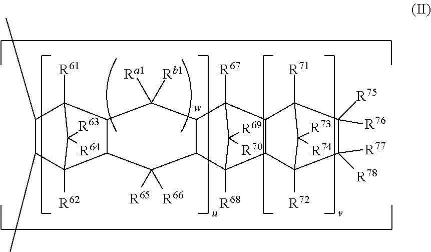

In the preceding general formula (II), u is 0 or 1, v is 0 or a positive integer, preferably an integer of not less than 0 and not more than 2, and more preferably 0 or 1, w is 0 or 1, R⁶¹ to R⁷⁸, R^{a1}, and R^{b1} may be the same as or different from one another and are each a hydrogen atom, a halogen atom, an alkyl group having 1 to 20 carbon atoms, a haloalkyl group having 1 to 20 carbon atoms, a cycloalkyl group having 3 to 15 carbon atoms, or an aromatic hydrocarbon group having 6 to 20 carbon atoms, and R⁷⁵ to R⁷⁸ may be bonded to form a monocycle or a polycycle.

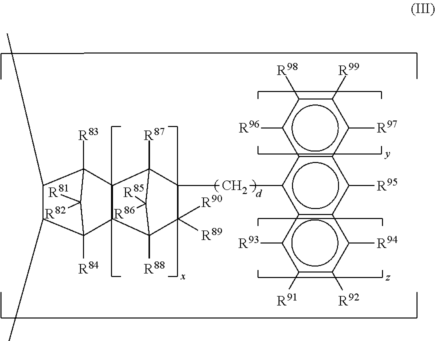

In the preceding general formula (III), x and d are each 0 or an integer of 1 or more, preferably an integer of not less than 0 and not more than 2, and more preferably 0 or 1, y and z are each 0, 1, or 2, R⁸¹ to R⁹⁹ may be the same as or different from one another and are each a hydrogen atom, a halogen atom, an aliphatic hydrocarbon group that is an alkyl group having 1 to 20 carbon atoms or a cycloalkyl group having 3 to 15 carbon atoms, an aromatic hydrocarbon group having 6 to 20 carbon atoms, or an alkoxy group, a carbon atom to which R⁸⁹ and R⁹⁰ are bonded may be bonded, either directly or via an alkylene group having 1 to 3 carbon atoms, to a carbon atom to which R⁹³ is bonded or a carbon atom to which R⁹¹ is bonded, and in a case in which y=z=0, R⁹⁵ and R⁹² or R⁹⁵ and R⁹⁹ may be bonded to form a monocyclic or polycyclic aromatic ring.

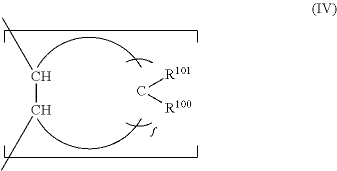

In the preceding general formula (IV), R¹⁰⁰ and R¹⁰¹ may be the same as or different from each other and each indicate a hydrogen atom or a hydrocarbon group having 1 to 5 carbon atoms, and f satisfies 1 f 18.

### ((Olefin Monomer))

An olefin monomer that is one raw material in copolymerization of the cycloolefin copolymer according to the present embodiment is a monomer that undergoes addition copolymerization to form a constitutional unit represented by the preceding general formula (I).

Specifically, an olefin monomer represented by the following general formula (Ia) that corresponds to the preceding general formula (I) is used.

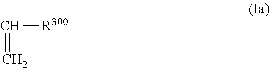

In the preceding general formula (Ia), R³⁰⁰ indicates a hydrogen atom or a linear or branched hydrocarbon group having 1 to 29 carbon atoms.

The olefin monomer represented by the preceding general formula (Ia) may be ethylene or an α-olefin. More specifically, the olefin monomer may be ethylene, propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene, 1-eicosene, or the like. Of these olefin monomers, it is preferable to use ethylene or propylene from a viewpoint of obtaining a molded product having even better heat resistance, mechanical properties, and optical properties, and particularly preferable to use ethylene. Two or more types of olefin monomers represented by the preceding general formula (Ia) may be used.

In the present embodiment, the proportion constituted by olefin-derived structural units when all constitutional units forming the cycloolefin copolymer are taken to be 100 mol % is preferably not less than 5 mol % and not more than 95 mol %, more preferably not less than 40 mol % and not more than 85 mol %, even more preferably not less than 50 mol % and not more than 64 mol %, and particularly preferably not less than 50 mol % and not more than 62 mol %.

Note that the proportion constituted by olefin-derived structural units can be measured by ¹³C-NMR.

### ((Cycloolefin Monomer))

No specific limitations are placed on a cycloolefin monomer that forms the cycloolefin copolymer resin. For example, any of the cycloolefin monomers described in paragraphs [0037] to [0063] of WO 2006/0118261 A1 can be used.

The cycloolefin monomer that is one raw material in copolymerization of the cycloolefin copolymer according to the present embodiment is preferably a monomer that undergoes addition copolymerization to form a cycloolefin-derived structural unit (b) represented by the preceding general formula (II), the preceding general formula (III), or the preceding general formula (IV). Specifically, cycloolefin monomers represented by general formulae (IIa), (IIIa), and (IVa), which correspond to the preceding general formulae (II), (III), and (IV), respectively, may be used.

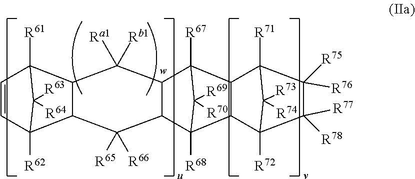

In the preceding general formula (IIa), u is 0 or 1, v is 0 or a positive integer, preferably an integer of not less than 0 and not more than 2, and more preferably 0 or 1, w is 0 or 1, R⁶¹ to R⁷⁸, Rai, and R^{bl} may be the same as or different from one another and are each a hydrogen atom, a halogen atom, an alkyl group having 1 to 20 carbon atoms, a haloalkyl group having 1 to 20 carbon atoms, a cycloalkyl group having 3 to 15 carbon atoms, or an aromatic hydrocarbon group having 6 to 20 carbon atoms, and R⁷⁵ to R⁷⁸ may be bonded to form a monocycle or a polycycle.

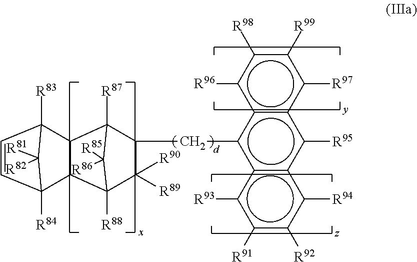

In the preceding general formula (IIIa), x and d are each 0 or an integer of 1 or more, preferably an integer of not less than 0 and not more than 2, and more preferably 0 or 1, y and z are each 0, 1, or 2, R⁸¹ to R⁹⁹ may be the same as or different from one another and are each a hydrogen atom, a halogen atom, an aliphatic hydrocarbon group that is an alkyl group having 1 to 20 carbon atoms or a cycloalkyl group having 3 to 15 carbon atoms, an aromatic hydrocarbon group having 6 to 20 carbon atoms, or an alkoxy group, a carbon atom to which R⁸⁹ and R⁹⁰ are bonded may be bonded, either directly or via an alkylene group having 1 to 3 carbon atoms, to a carbon atom to which R⁹³ is bonded or a carbon atom to which R⁹¹ is bonded, and in a case in which y=z=0, R⁹⁵ and R⁹² or R⁹⁵ and R⁹⁹ may be bonded to form a monocyclic or polycyclic aromatic ring.

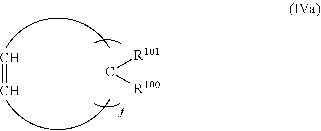

In the preceding general formula (IVa), R¹⁰⁰ and R¹⁰¹ may be the same as or different from each other and each indicate a hydrogen atom or a hydrocarbon group having 1 to 5 carbon atoms, and f satisfies 1 f 18.

By using an olefin monomer represented by general formula (Ia) and a 20 cycloolefin monomer represented by general formula (IIa), (IIIa), or (IVa) described above as copolymerized components, solubility of the cycloolefin copolymer (A) in a solvent further improves, thereby providing better moldability and improving product yield.

Specific examples of cycloolefin monomers represented by general formulae (IIa), (IIIa), and (IVa) include compounds described in paragraphs [0037] to [0063] of WO 2006/0118261 A1.

Specifically, a bicyclo-2-heptene derivative (bicyclohept-2-ene derivative), a tricyclo-3-decene derivative, a tricyclo-3-undecene derivative, a tetracyclo-3-dodecene derivative, a pentacyclo-4-pentadecene derivative, a pentacyclopentadecadiene derivative, a pentacyclo-3-pentadecene derivative, a pentacyclo-4-hexadecene derivative, a pentacyclo-3-hexadecene derivative, a hexacyclo-4-heptadecene derivative, a heptacyclo-5-eicosene derivative, a heptacyclo-4-eicosene derivative, a heptacyclo-5-heneicosene derivative, an octacyclo-5-docosene derivative, a nonacyclo-5-pentacosene derivative, a nonacyclo-6-hexacosene derivative, a cyclopentadiene-acenaphthylene adduct, a 1,4-methano-1,4,4a,9a-tetrahydrofluorene derivative, a 1,4-methano-1,4,4a,5,10,10a-hexahydroanthracene derivative, or a cycloalkylene derivative having 3 to 20 carbon atoms may be used.

Among cycloolefin monomers represented by general formulae (IIa), (IIIa), and (IVa), a cycloolefin monomer represented by general formula (IIa) is preferable.

It is preferable to use bicyclo[2.2.1]-2-heptene (also referred to as “norbornene”) or tetracyclo[4.4.0.1^{2,5}.1^{7,10}]-3-dodecene (also referred to as tetracyclododecene), and more preferable to use tetracyclo[4.4.0.1^{2,5}.1^{7,10}]-3-dodecene as a cycloolefin monomer represented by the preceding general formula (IIa). These cycloolefins are advantageous because their rigid cyclic structure makes it easy to maintain the elastic modulus of the copolymer and a molded product.

The proportion constituted by cycloolefin monomer-derived structural units (cyclic skeleton constitutional units) when all constitutional units forming the main chain of the cycloolefin copolymer are taken to be 100 mol % is preferably not less than 5 mol % and not more than 95 mol %, more preferably not less than 15 mol % and not more than 60 mol %, even more preferably not less than 36 mol % and not more than 50 mol %, and particularly preferably not less than 38 mol % and not more than 50 mol %.

When cycloolefin monomer-derived structural units are within any of the ranges set forth above, it is possible to provide high heat resistance and maintain a high elastic modulus, particularly even in a high temperature region, and thereby inhibit shape deformation caused by an annealing step and restrict surface deformation of the light-guiding member according to the present disclosure to a low level.

Although no specific limitations are placed on the molecular weight of the cycloolefin copolymer according to the present embodiment, a molecular weight displaying a limiting viscosity [η], measured in 135° C. decalin, of 0.03 dL/g to 10 dL/g is preferable, with 0.05 dL/g to 5 dL/g being more preferable, and 0.10 dL/g to 2 dL/g even more preferable.

When the molecular weight of the cycloolefin copolymer is not less than any of the lower limits set forth above, mechanical strength of a molded product can be improved. Moreover, when the molecular weight is not more than any of the upper limits set forth above, moldability can be improved.

### (Higher Fatty Acid Ester)

The cycloolefin copolymer resin composition according to the present embodiment preferably contains a higher fatty acid ester in addition to the cycloolefin copolymer described above.

The addition of a specific amount of a higher fatty acid ester to the cycloolefin copolymer resin composition according to the present embodiment enables expression of the target functions according to the present disclosure.

Moreover, the higher fatty acid ester is preferably a higher fatty acid ester having two or fewer hydroxy groups in a molecule. This is because it is possible to obtain an optical component having low haze and good optical properties.

The content of the higher fatty acid ester in the cycloolefin copolymer resin composition according to the present embodiment is preferably not less than 0.5 mass % and not more than 2.8 mass %, more preferably not less than 0.6 mass % and not more than 2.5 mass %, even more preferably not less than 0.7 mass % and not more than 1.7 mass %, and further preferably not less than 0.8 mass % and not more than 1.3 mass %.

Mixing of the higher fatty acid ester within any of the ranges set forth above dramatically improves fluidity of the resin and relieves orientation birefringence while also promoting relaxation of resin side chains and acting to relieve internal strain through only the higher fatty acid moving at a temperature in proximity to the melting point thereof. It also becomes possible to advantageously reduce only internal strain without deterioration of surface shape even in an annealing step.

In addition, by controlling the higher fatty acid ester to a prescribed amount within any of the ranges set forth above, it is possible to inhibit foreign substances and external appearance defects such as pressure marks during molding and also to retain high shape accuracy of a molded article.

Furthermore, it is also possible to inhibit the occurrence of staining of an insert mirror surface of a mold during molding, blocking of a vent section for gas release, and so forth.

The higher fatty acid ester referred to here is an ester compound of a fatty acid having 6 or more carbon atoms and an alcohol. The higher fatty acid ester according to the present embodiment is formed from a polyhydric alcohol and a fatty acid described below.

The polyhydric alcohol can be glycerin, pentaerythritol, diglycerin, triglycerin, polyglycerin, 1,2-ethanediol, dipentaerythritol, sorbitan, polyethylene glycol, polypropylene glycol, polybutylene glycol, α,α′-[(isopropylidene)di-4,1-phenylene]bis{ω-hydroxy-poly[oxy(methylethylene)]}, polyoxyethylene-laurylamine, polyoxyethylene-stearylamine, polyoxyethylene-oleylamine, polyoxyethylene polyoxypropylene pentaerythritol ether, polyethylene glycol polybutylene glycol pentaerythritol ether, polyoxytetramethylene polyoxyethylene glycol, polyoxytetramethylene polyoxypropylene glycol, trimethylolpropane-tris(polyoxytetramethylene-polyoxypropylene) ether, polyoxyethylene-bisphenol A ether, polyoxypropylene-bisphenol A ether, polyoxyethylene-polyoxypropylene-bisphenol A ether, 1-thioglycerol, polyoxypropylene diglyceryl ether, polyoxypropylene sorbitol, polyoxybutylene polyoxyethylene pentaerythritol ether, polyoxyethylene methyl glucoside, polyoxypropylene methyl glucoside, or the like.

The fatty acid can be a saturated fatty acid such as hexanoic acid, heptanoic acid, octanoic acid, nonanoic acid, capric acid, lauric acid, myristic acid, palmitic acid, or stearic acid; a monounsaturated fatty acid such as crotonic acid, myristoleic acid, palmitoleic acid, sapienic acid, oleic acid, elaidic acid, gadoleic acid, or eicosenic acid; a diunsaturated fatty acid such as linoleic acid, eicosadienoic acid, or docosadienoic acid; a triunsaturated fatty acid such as linolenic acid, pinolenic acid, eleostearic acid, or eicosatrienoic acid; a tetraunsaturated fatty acid such as stearidonic acid, arachidonic acid, or eicosatetraenoic acid; or the like.

Moreover, in consideration of industrial uniformity in synthesis or acquisition of the higher fatty acid ester as an additive, polyhydric alcohols having a high degree of symmetry are preferable from among polyhydric alcohols. Specifically, a polyhydric alcohol that has a higher degree of symmetry than C₂ symmetry or C₃ symmetry is preferable, a polyhydric alcohol that has a higher degree of symmetry than C₂ symmetry or C₃ symmetry and that does not have stereoisomers is more preferable, a polyhydric alcohol that has a higher degree of symmetry than C₂ symmetry or C₃ symmetry, that does not have stereoisomers, and in which all hydroxy groups are equivalent is even more preferable, and pentaerythritol is particularly preferable.

As previously described, the number of OH groups (hydroxy groups) in a molecule of the higher fatty acid ester is preferably two or fewer. The use of a higher fatty acid ester having such a molecular structure maintains good dispersion in the resin composition and makes cloudiness that is a cause of poorer haze less likely. In addition, mold staining due to bleed-out during molding can be inhibited.

The melting point of the higher fatty acid ester is preferably 0° C. or higher, more preferably 10° C. or higher, even more preferably 25° C. or higher, and particularly preferably 35° C. or higher. When the melting point is within any of these temperature regions, relaxation does not readily occur in a normal temperature environment, and it is possible inhibit mold staining by bleed-out during molding and reduction of mechanical strength.

In addition, the melting point of the higher fatty acid ester is preferably at least 10° C. lower than the glass-transition temperature (Tg) of the resin composition of the present embodiment (i.e., Tg−10° C. or lower), more preferably Tg−20° C. or lower, and particularly preferably Tg−30° C. or lower.

When the melting point of the higher fatty acid ester is within a temperature region such as set forth, deformation of shape of a molded product does not readily occur in a high temperature region where main chain relaxation of the resin occurs, and mold staining due to bleed-out during molding can be inhibited.

In an annealing step performed in a temperature region of roughly 40° C. lower than the glass-transition temperature of the resin composition, although it is possible to inhibit shape deformation of a molded product, the effect of relieving birefringence is typically small. However, when a higher fatty acid ester having a melting point within any of the temperature ranges set forth above is used, the higher fatty acid ester can freely move at the same temperature since the melting point thereof is exceeded and can promote relaxation of side chains or cyclic skeleton pulled out from the main chain of the resin to thereby bring about effective reduction of birefringence.

### (Other Additives)

The cycloolefin copolymer resin composition according to the present embodiment may contain various additives as necessary to the extent that the effects according to the present disclosure are not significantly impaired.

Examples of such additives include, but are not specifically limited to, the above-described higher fatty acid esters and also weathering stabilizers; heat resistance stabilizers; antioxidants; light stabilizers such as hindered amine light stabilizers; ultraviolet absorbers; mold release agents; lubricants; thermoplastic resins other than cycloolefin copolymers; metal deactivators; hydrochloric acid absorbers; slip agents; anti-blocking agents; anti-fogging agents; softeners such as synthetic oils, paraffin, organopolysiloxanes, and mineral oils; plasticizers; flame retardants; antistatic agents; reinforcers such as organic fibers, inorganic fillers such as pigments (iron oxide, etc.), glass fibers, carbon fibers, and metal whiskers; colorants; organophosphorus compounds such as phosphorus acid esters, phosphonites, and phosphoric acid esters; other additives; and mixtures of any of the preceding examples.

### <Production Method of Resin Composition>

No specific limitations are placed on the method by which the resin composition is produced other than being a method by which a resin composition that satisfies the requirements of the present disclosure can be obtained. For example, a method in which kneading is performed using a kneading machine such as an extruder, a heating roller, a kneader, a roller mixer, or a Banbury mixer may be adopted. In particular, kneading by an extruder is preferable from a perspective of productivity. The kneading temperature may be set in accordance with the preferred processing temperature of the polymer forming the methacrylic resin and any other resins that are mixed therewith. As a guideline, the kneading temperature may be within a range of 140° C. to 300° C., and is preferably within a range of 180° C. to 280° C. Moreover, it is preferable that the extruder includes a vent port in order to reduce volatile content.

The amount of remaining solvent (residual solvent content) in the resin composition forming the substrate section of the light-guiding member of the present embodiment is preferably less than 1,000 mass ppm, more preferably less than 800 mass ppm, and even more preferably less than 700 mass ppm.

The remaining solvent refers to polymerization solvent (excluding alcohols) that was used in polymerization and solvent used to redissolve and form a solution of the resin obtained through polymerization. Specifically, examples of the polymerization solvent include aromatic hydrocarbons such as toluene, xylene, ethylbenzene, and isopropylbenzene; ketones such as methyl isobutyl ketone, butyl cellosolve, methyl ethyl ketone, and cyclohexanone; polar solvents such as dimethylformamide and 2-methylpyrrolidone; and so forth, whereas examples of the solvent used in redissolving include toluene, methyl ethyl ketone, methylene chloride, and so forth.

The amount of remaining alcohol (residual alcohol content) in the resin composition is preferably less than 500 mass ppm, more preferably less than 400 mass ppm, and even more preferably less than 350 mass ppm.

The remaining alcohol refers to alcohol produced as a by-product in a cyclocondensation reaction, and specific examples thereof include aliphatic alcohols such as methanol, ethanol, and isopropanol.

The residual solvent content and the residual alcohol content can be measured by gas chromatography.

Whichever method is selected, the composition is preferably produced in a manner that reduces the content of oxygen and water as much as possible.

For example, the dissolved oxygen concentration in a polymerization solution in solution polymerization is preferably less than 300 ppm in the polymerization step. Moreover, the oxygen concentration inside of an extruder in a production method in which an extruder or the like is used is preferably less than 1 vol %, and more preferably less than 0.8 vol %. The water content of the methacrylic resin is preferably adjusted to 1,000 mass ppm or less, and more preferably 500 mass ppm or less.

Values within these ranges are preferable because it becomes comparatively easy to produce a composition satisfying the requirements of the present disclosure.

### <Properties of Resin Composition>

### —Glass-Transition Temperature—

The resin composition preferably has a glass-transition temperature (Tg) of 105° C. to 160° C. The glass-transition temperature of the resin composition is more preferably 110° C. to 155° C., even more preferably 115° C. to 150° C., and most preferably 120° C. to 150° C.

Note that the glass-transition temperature can be measured in accordance with JIS K7121 by the midpoint method. By setting the glass-transition temperature of the above-described resin composition as 105° C. or higher, heat resistance can be ensured even under heat generation from electronic devices of a head-mounted display and under high-temperature environments such as some outdoor or in-vehicle environment. This is also preferable from a viewpoint of improving close adherence in bonding with various optical films due to shape retention even at high temperature.

On the other hand, setting the glass-transition temperature (Tg) as 160° C. or lower makes it possible to avoid melt processing at an extremely high temperature, inhibit thermal decomposition of the resin, etc., and obtain a good product. From a viewpoint of obtaining the above-described effects to an even greater extent, the glass-transition temperature (Tg) is preferably 155° C. or lower, more preferably 150° C. or lower, and even more preferably 140° C. or lower.

When the glass-transition temperature exceeds 150° C., a high mold temperature needs to be maintained in a subsequently described injection molding step in order to reduce birefringence of a resin light-guiding member, and it becomes necessary to lengthen the cooling time to suppress deformation such as sink marks when removing the light-guiding member, which prolongs the cycle time. In addition, the temperature difference from room temperature makes it easier for strain to remain in the light-guiding member due to rapid cooling, and this is also undesirable from a viewpoint of sufficiently reducing birefringence of the light-guiding member.

—Photoelastic Coefficient CR—An absolute value |CR| of the photoelastic coefficient CR of the resin composition is preferably 10.0×10⁻¹² Pa⁻¹ or less, more preferably 5.0×10⁻¹² Pa⁻¹ or less, even more preferably 3.0×10⁻¹² Pa⁻¹ or less, and further preferably 1.0×10⁻¹² Pa⁻¹ or less. The photoelastic coefficient is described in various documents (for example, refer to Review of Chemistry, No. 39, 1998 (published by Publishing Center of the Chemical Society of Japan)) and is defined by the following formulae (i-a) and (i-b). The closer the value of the photoelastic coefficient CR is to zero, the smaller the change in birefringence caused by external force.

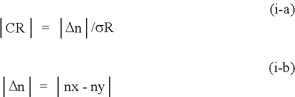

(In the formulae, CR indicates the photoelastic coefficient, σR indicates the tensile stress, |Δn| indicates the absolute value of birefringence, nx indicates the refractive index in the tensile direction, and ny indicates the refractive index in an in-plane direction orthogonal to the tensile direction.) When the absolute value |CR| of the photoelastic coefficient CR of the resin composition is 3.0×10⁻¹² Pa⁻¹ or less, stress arising when a lens is fixed or adhered to a lens barrel or jig and photoelastic birefringence arising in accompaniment dimension temperature change are sufficiently small, and a light-guiding member that provides a clear image can be obtained.

### —Molecular Weight and Molecular Weight Distribution—

The polymethyl methacrylate-equivalent weight-average molecular weight (Mw) of the resin composition measured by gel permeation chromatography (GPC) is preferably within a range of 80,000 to 170,000, more preferably within a range of 90,000 to 170,000, even more preferably within a range of 100,000 to 150,000, and further preferably within a range of 110,000 to 150,000. When the weight-average molecular weight (Mw) is within any of the ranges set forth above, the resin composition also has an excellent balance of mechanical strength and fluidity.

Note that the weight-average molecular weight (Mw), number-average molecular weight (Mn), and Z-average molecular weight (Mz) of the resin composition can be measured by the following device and conditions.
Measurement device: Gel permeation chromatograph (HLC-8320GPC) produced by Tosoh Corporation
Measurement conditions
   Column: TSKguardcolumn SuperH-H×1, TSKgel SuperHM-M×2, and TSKgel SuperH2500×1 connected in order in series
   Column temperature: 40° C.
   Eluent solvent: Tetrahydrofuran at flow rate of 0.6 mL/min with 0.1 g/L of 2,6-di-t-butyl-4-methylphenol (BHT) added as internal standard
   Detector: RI (differential refraction) detector
   Detection sensitivity: 3.0 mV/min
   Sample: Solution of 0.02 g of light-guiding member in 20 mL of tetrahydrofuran
   Injection volume: 10 μL
   Standard samples for calibration curve preparation: Following 10 types of polymethyl methacrylate (PMMA Calibration Kit M-M-10 produced by Polymer Laboratories Ltd.) of differing molecular weight, each having a known monodisperse weight peak molecular weight
Weight peak molecular weight (Mp)

| | |
|---|---|
| Standard sample 1 | 1,916,000 |
| Standard sample 2 | 625,500 |
| Standard sample 3 | 298,900 |
| Standard sample 4 | 138,600 |
| Standard sample 5 | 60,150 |
| Standard sample 6 | 27,600 |
| Standard sample 7 | 10,290 |
| Standard sample 8 | 5,000 |
| Standard sample 9 | 2,810 |
| Standard sample 10 | 850 |

The RI detection intensity relative to the elution time of the light-guiding member is measured under the conditions indicated above.

The weight-average molecular weight (Mw), number-average molecular weight (Mn), and Z-average molecular weight (Mz) of the light-guiding member are determined based on calibration curves obtained through measurement of the standard samples for calibration curve preparation, and these values are used to determine the molecular weight distributions (Mw/Mn) and (Mz/Mw).

### —Saturated Water Absorption—

The saturated water absorption of the resin composition can be measured by a measurement method subsequently described in the EXAMPLES section.

The saturated water absorption is preferably within a range of 0.005% to 3%, more preferably within a range of 0.007% to 2.5%, and even more preferably within a range of 0.01% to 2.0%. By forming the substrate section of the light-guiding member using a resin composition having a saturated water absorption within any of the ranges set forth above, it is possible to maintain a good state of close adherence with an anti-reflection coating and a mirror coating and also to maintain high surface accuracy even after high temperature and high humidity testing.

### —Melt Viscosity—

The resin composition preferably has low viscosity and high fluidity in a state corresponding to that during injection in order to increase lens shape transferability. Accordingly, the melt viscosity of the resin composition at 270° C. and 1,000 s⁻¹ is preferably 20 Pa·s to 235 Pa·s, more preferably 20 Pa·s to 230 Pa·s, even more preferably 30 Pa·s to 180 Pa·s, and particularly preferably 50 Pa·s to 150 Pa·s When the melt viscosity is less than 20 Pa·s, it is difficult to control flow of the resin during injection, and problems arise such as deterioration of surface accuracy (deviation from a design value or radius of curvature serving as a reference) as holding pressure does not act well and deterioration of surface accuracy caused by sink marks or the like in a lens after molding. On the other hand, when the melt viscosity is larger than 235 Pa·s, reduction of fluidity of the resin causes deterioration of lens shape transferability and, in particular, makes it significantly more difficult to shape a thin wall lens. Moreover, attempting to force the resin into a mold leads to problems such as sticking of the light-guiding member to the mold, the occurrence of chipping or splitting or the need to deal with issues during demolding, and also coloring and formation of burnt foreign substances due to resin burning, for example.

Note that the melt viscosity is a value measured in accordance with JIS-K7199.

### [Production Method of Light-Guiding Member]

The light-guiding member of the present embodiment is obtained by molding the resin composition described above and adhering together various members. It is preferable to adopt injection molding or injection compression molding as the production method of the light-guiding member of present embodiment from a viewpoint of productivity.

In general, an injection molding method includes (1) an injection step of melting the resin and loading molten resin into a cavity of a mold that is subject to temperature control, (2) a pressure holding step of applying pressure inside of the cavity until gate sealing occurs and injecting resin corresponding to an amount of contraction of the molten resin loaded in the injection step as it comes into contact with and is cooled by the mold, (3) a cooling step of releasing the holding pressure and holding a molded article until after the resin has cooled, and (4) a step of opening the mold and removing the cooled molded article.

In the present embodiment, the temperature setting from a nozzle tip to the center of a cylinder of an injection molding machine, as based on the glass-transition temperature (Tg) of the used methacrylic resin composition, is Tg+120° C. to Tg+180° C., preferably within a range of Tg+100° C. to Tg+160° C., and more preferably within a range of Tg+110° C. to Tg+150° C.

The molding temperature indicates the control temperature of a band heater that is wrapped around the injection nozzle. Through setting within any of the temperature ranges set forth above, it is possible to perform molding in a state in which there is sufficient fluidity of molten resin and in which degradation due to thermal decomposition of the resin is inhibited. The adoption of a high molding temperature increases fluidity of the resin and makes orientation birefringence less likely to arise, but thermal decomposition of the resin at high temperature has a negative influence on color tone, transmittance, and haze and also causes the formation of gas during injection molding. The formed gas takes up space inside of the mold, and gas that has been compressed into uneven sections during resin loading is not expelled and impedes loading of resin, resulting in a poorer mold transfer rate. An appropriate molding temperature should be selected in view of the state of the light-guiding member.

Raising the mold temperature to a temperature in proximity to Tg can reduce birefringence of the light-guiding member. Moreover, it is preferable that the actual surface temperature is set as the desired temperature rather than the temperature setting of the mold. Specifically, the mold temperature in injection molding of the light-guiding body of the present embodiment is preferably set within a range of (Tg−30)° C. to (Tg+10)° C. relative to the glass-transition temperature (Tg) of the used resin composition. The mold temperature is more preferably (Tg−25)° C. to (Tg+5)° C., and even more preferably (Tg−20)° C. to (Tg° C.) By setting the mold temperature within any of the ranges set forth above, it is possible to reduce birefringence of the resin composition and also to inhibit warping and obtain a light-guiding member having good surface accuracy. A mold temperature of lower than (Tg−30)° C. tends to increase orientation and birefringence. This also reduces fluidity of the resin inside of the mold, and thus tends to result in non-uniformity of thickness and deterioration of surface accuracy of the light-guiding member. On the other hand, a mold temperature of higher than (Tg+10)° C. results in poorer surface accuracy caused by sticking to the mold and the occurrence of shrinkage or warping due to heat, and thus a mold temperature that is within any of the ranges set forth above is preferable.

Although the cooling time during injection molding can be set as appropriate, it is preferable to set as long a cooling time as is possible. Slow cooling tends to reduce birefringence due to strain arising in molding being relieved through an annealing effect.

An annealing step may be performed in production of the light-guiding member of the present embodiment in order to relieve residual stress arising during injection molding and reduce birefringence of the light-guiding body. The temperature during annealing, as based on the glass-transition temperature (Tg) of the resin composition, is preferably within a range of (Tg−50)° C. to (Tg)° C., more preferably (Tg−40)° C. to (Tg−5)° C., and more preferably within a range of (Tg−30)° C. to (Tg−10° C.) An annealing temperature that is within any of the ranges set forth above makes it possible to remove residual stress without deformation of shape of the light-guiding body. It is also possible to perform annealing once at high temperature, followed by gradual cooling to a low temperature of roughly Tg−50° C., and then perform additional annealing. In some resin compositions, sudden cooling from high temperature results in strong expression of birefringence due to internal strain arising during this cooling. Moreover, annealing in a temperature region of roughly Tg−50° C. is particularly effective for a resin composition that has a photoelastic coefficient of 3×10⁻¹² Pa⁻¹ or more and in which a large amount of a plasticizer (0.5 parts by mass or more relative to 100 parts by mass of resin) has been added since the plasticizer moves in the same temperature region to display an effect of promoting relaxation of internal strain and reducing birefringence of the resin.

Moreover, in the case of a resin composition in which a large amount of a plasticizer (0.5 parts by mass or more relative to 100 parts by mass of resin) has been added, annealing at roughly (Tg−50)° C. to (Tg−20)° C. in proximity to the melting point of the plasticizer is also effective. In this case, the plasticizer moves as previously described to promote relaxation of internal strain of the resin in the same temperature region, and change of surface shape at high temperature can be inhibited while also reducing birefringence through annealing.

The injection rate can be selected as appropriate depending on the thickness and dimensions of the light-guiding member that is to be obtained and can, for example, be selected as appropriate from a range of 2 mm/s to 1,000 mm/s. In the case of thin wall molding with a thinnest section of approximately 1 mm, it is preferable to set a fast injection rate in order that injection is completed prior to skin layer formation, whereas setting the injection rate as 1 mm/s to 20 mm/s is preferable in a case in which the thinnest section is 4 mm or more. Moreover, it is preferable that the injection rate is changed as appropriate between a gate passing time and thereafter in order to suppress a sudden change of the rate at which the resin composition flows into the mold at a thin wall section such as a gate section of the mold.

The pressure for pressure holding can be selected as appropriate according to the shape of the light-guiding member that is to be obtained and can, for example, be selected as appropriate from a range of 30 MPa to 120 MPa. The pressure for pressure holding is pressure that is maintained by a screw in order to further feed molten resin from the gate after molten resin has been loaded.

In a situation in which the light-guiding member is molded by injection molding, the temperature with which each surface is in contact with may not be uniform even with a molded product that has cooled to around room temperature, and this temperature difference may lead to changes of surface shape of the molded product and changes accompanied by anisotropy.

Particularly in the case of a complicated surface shape, dimensional change with strong anisotropy arises as stress remaining from molding relaxes over time, which makes it difficult to obtain a light-guiding member that is capable of wave guiding without image distortion.

For this reason, it is preferable that once the light-guiding member has been removed from the mold after injection molding, the light-guiding member is held such that each surface that is subject to optical design is not brought into contact with a metal or other thermally conductive object for a certain time, such as one day, for example. Specifically, in a state in which a gate has not been cut and in which a runner and a sprue are retained, the sprue may be inserted into and held by a test tube rack or the sprue section may be taped to a tray, for example, so as to maintain a state in which optically effective surfaces are held in air for one day, and thereby obtain a uniform temperature distribution at each surface, make it difficult for changes of surface shape to arise even a number of days after molding, and obtain a molded article having good surface accuracy.

### [Head-Mounted Display]

A feature of a head-mounted display of the present embodiment is that it includes the light-guiding member of the present embodiment.

Since the light-guiding member of the present embodiment can provide an image while also inhibiting faults such as non-uniformity of brightness, non-uniformity of color, and rainbow effect, a head-mounted display that includes this light-guiding member can also provide an image while also inhibiting faults such as non-uniformity of brightness, non-uniformity of color, and rainbow effect.

In the head-mounted display of the present embodiment, it is preferable that at either or both of the light output section and the eye side wave-guiding section, the reflectance of S-polarized light is larger than the reflectance of P-polarized light at an incident angle of 30° and that the difference between the reflectance of S-polarized light and the reflectance of P-polarized light is 5% or more. It is more preferable that the reflectance of S-polarized light is larger than the reflectance of P-polarized light at an incident angle of 30° and that the difference between the reflectance of S-polarized light and the reflectance of P-polarized light is 10% or more, and more preferable that this difference is 15% or more.

In the head-mounted display of the present embodiment, it is preferable that a partial reflecting mirror that transmits a portion and reflects a remaining portion of light is formed on part or all of both of the two surfaces of the wave-guiding section in the light-guiding member. Moreover, this partial reflecting mirror may be formed on part or the whole of one of the two surfaces of the wave-guiding section or may be formed on the whole of the two surfaces of the wave-guiding section.

In the head-mounted display of the present embodiment, it is preferable that light is guided at a larger incident angle than the substrate section, and in a situation in which sufficient light utilization efficiency can be ensured, it is preferable that light is guided at a smaller incident angle than the critical angle of the substrate section of the light-guiding member.

In the head-mounted display of the present embodiment, it is preferable that a linear polarizing plate is included on a straight line that joins an eyeball of an observer and the output coupler of the light-guiding member and that extends to the outside world as illustrated in FIG. 6. A head-mounted display having a configuration such as described above functions as polarizing sunglasses.

Moreover, in a head-mounted display having a configuration such as described above, the head-mounted display may include a half-wave element or a retardation layer that imparts half-wave retardation in addition to the linear polarizing plate. It is preferable that the head-mounted display includes the linear polarizing plate and the half-wave plate or retardation layer imparting half-wave retardation in order from the outside world on a straight line that joins an eyeball of an observer and the output coupler of the light-guiding member and that extends to the outside world as illustrated in FIG. 7. By adjusting reflectance characteristics of the partial reflecting mirror, using a partial reflecting mirror having high polarized light reflectance of S-polarized light relative to the wave-guiding section at the output coupler and the outer side wave-guiding section, and using an image display element that emits light that is S-polarized light (relative to the wave-guiding section), it is possible to design a configuration in which high transmittance is displayed with respect to light entering from the outside world, whereas high reflectance is displayed with respect to image light guided inside of the light-guiding member.

The head-mounted display of the present embodiment can be produced by a commonly known method using the light-guiding member of the present embodiment.

### EXAMPLES

The following provides a description through specific examples and comparative examples. However, the present disclosure is not limited to the following examples.

### (Evaluation of Resin Composition and Light-Guiding Member)

The following describes measurement methods for properties of a resin composition and a light-guiding member that is formed from a resin composition.

### <Measurement of Flexural Strength and Flexural Modulus>

Pellets of a resin composition produced in a subsequently described synthesis example were dried at 80° C. to 100° C. for 24 hours. In the case of a methacrylic resin composition, an A-type dumbbell test specimen (ISO 3167) with a thickness of 4.0 mm was produced by injection molding in accordance with JIS-K6717 using an injection molding machine (EX-100SX produced by Toshiba Machine Co., Ltd.). Moreover, in the case of a cycloolefin copolymer resin composition, an A-type dumbbell test specimen (ISO 3167) with a thickness of 4.0 mm was produced by injection molding in accordance with JIS-K7152-1 using an injection molding machine (J100ADS-110U produced by The Japan Steel Works, Ltd.).

A central portion of this test specimen was cut out to prepare a molded piece with a length of 80 mm, a width of 10 mm, and a thickness of 4.0 mm. A flexural test was performed in accordance with ISO 178 using a universal testing machine for low loads (produced by Instron) with a measurement temperature of 23° C., a test speed of 2 mm/min, and a distance between support points of 64 mm. Six measurements were made, and the flexural strength (MPa) was calculated as an average value of the measurements.

### <Analysis of Structural Units>

A substrate section of a light-guiding member produced in a subsequently described example or comparative example was finely cut up, and, unless otherwise specified, structural units in the resin composition of the finely cut product were identified by ¹H-NMR and ¹³C-NMR measurements, and the amounts of these structural units that were present were calculated. The measurement conditions of ¹H-NMR and ¹³C-NMR measurements were as follows.
Measurement instrument: JNM-ECZ400S produced by JEOL Ltd.
Measurement solvent: CDCl₃ or d₆-DMSO
Measurement temperature: 40° C.

Note that in a case in which a cyclic structure included in a main chain of a methacrylic resin was a lactone ring structure, this was confirmed by a method described in JP 2001-151814 A and JP 2007-297620 A.

### <Determination of Proportion of Cyclic Structure in Cycloolefin Copolymer>

A substrate section of a light-guiding member produced in a subsequently described example or comparative example was finely cut up, structural units in the resin composition of the finely cut product were identified by ¹³C-NMR measurement, and the abundances of these structural units were calculated.

First, 5.0 g of a cycloolefin resin composition was dissolved through addition of 50 mL of cyclohexane, reprecipitation was then performed through addition of 300 mL of methanol, and then filtration was performed to collect methanol-insoluble content. The solvent was volatilized to collect solid content. The solid content was quantified and 1.0 mL of o-dichlorobenzene-d₄ was added so as to give a sample concentration of 5.0 wt/vol %, the sample was left at room temperature for at least 16 hours to cause complete dissolution, and then the sample was measured by ¹³C-NMR.

In quantification, ratios of CH and CH₂ were calculated from a ratio of the total k of integrated values for all peaks observed in a range of 51.2 ppm to 36.8 ppm and the total 1 of integrated values of all peaks observed in a range of 36.8 ppm to 29.3 mm, and the following formula (i) was used to confirm that specific amounts of an olefin and tetracyclo[4.4.0.1^{2,5}.1^{7,10}]-3-dodecene had been copolymerized in a molar ratio of n % of the olefin and (100−n) % of the tetracyclo[4.4.0.1^{2,5}.1^{7,10}-3-dodecene.

$$n ( \% ) = ( 4 \times 1 - 2 \times k ) / ( 4 \times 1 - k ) \times 100 \qquad ( i )$$

Note that the measurement conditions of ¹³C-NMR were as follows.
Measurement instrument: AVANCE3 500HD Prodigy produced by Bruker Biospin
Measurement solvent: o-Dichlorobenzene-d₄
Measurement temperature: 25° C.
Observation frequency: 125 MHz
Pulse sequence: ¹³C quantification
Cumulative number: 700 times
Relaxation time: 10 s
Sample concentration: 5.0 wt/vol %

### <Measurement of Plasticizer Content in Resin Composition>

The amount of an additive in a light-guiding member produced in a subsequently described example or comparative example was analyzed by the following operations.

First, a substrate section of the light-guiding member was cut out, 5.0 g of the resin composition forming the substrate was added to 100 mL of chloroform (50 mL of cyclohexane in the case of a cycloolefin copolymer), and at least 1 hour of stirring was performed at 40° C. to cause dissolution.

Thereafter, the solution was loaded into a dropping funnel and was added dropwise into 1 L of methanol that was being stirred by a stirring bar over approximately 0.5 hours to 1 hour to perform reprecipitation. After the entire solution had been dripped into the methanol and then been left for 1 hour at rest, vacuum filtration was performed using a membrane filter (T05A090C produced by Advantec Toyo Kaisha, Ltd.) as a filter.

After removing the solvent from the filtrate using a rotary evaporator with a bath temperature of 40° C. and a degree of vacuum that was initially set as 390 Torr and then gradually lowered to a final value of 30 Torr, soluble content remaining in the rotary evaporator flask was collected and taken to be methanol-soluble content. The solid content was measured and 1.0 mL of CDCl₃ was added such as to give a sample concentration of 5.0 wt/vol %. The sample was left at room temperature for at least 30 minutes to cause complete dissolution, 1,000 ppm (weight taken to be (w) mg) of DMSO was added as an internal standard, and the sample was measured by ¹H-NMR.

In quantification, a value determined by subtracting the same value as an integrated value (b) originating from components such as heat stabilizers (for example, pentaerythritol tetrakis[3-(3,5-di-tert-butyl-4-hydroxyphenyl)propionate](Irganox 1010 produced by BASF Corporation) and tris(2,4-di-t-butylphenyl) phosphite (Irgafos 168 produced by BASF Corporation)) and other mold release agents observed at 2.79 ppm to 2.88 ppm from an integrated value (a) at 2.56 ppm to 2.65 ppm originating from DMSO was taken to be an integrated value (a−b) of a 6H component of only DMSO. Moreover, the contained percentage (x) of each compound was quantified by the following formula (ii) using an integrated value (y) for peaks observed in a chemical shift range indicated below, the molecular weight (M) of the additive, and the number (z) of equivalent proton peaks.

$$x ( \% ) = ( w / 78.1 \times y / ( a - b ) \times 6 / z \times M ) / 5000 \times 100 \qquad ( ii )$$

Particularly in the case of an additive that was a higher fatty acid ester, quantification by formula (ii) was performed by using an integrated value of peaks originating from α-hydrogen in a higher fatty acid moiety observed at 2.0 ppm to 2.5 ppm as y, the molecular weight M, and the number of hydrogens z originating from equivalent α-hydrogens. The integration range, M, and z for additives that are applicable in the examples are presented below.

### Pentaerythritol Distearate

Integration range: 2.27 ppm to 2.38 ppm
M=669.09
z=4

### Pentaerythritol Tetrastearate

Integration range: 2.27 ppm to 2.38 ppm
M=1201.99
z=8

Note that the measurement conditions of ¹H-NMR were as follows.
Measurement instrument: AVANCE3 500HD Prodigy produced by Bruker Biospin
Measurement solvent: CDCl₃
Measurement temperature: 25° C.
Observation frequency: 500 MHz
Cumulative number: 128 times
Sample concentration: 5.0 wt/vol %

### <Molecular Weight and Molecular Weight Distribution (1)>

The weight-average molecular weight (Mw), number-average molecular weight (Mn), and Z-average molecular weight (Mz) of a portion cut out from a light-guiding member produced in a subsequently described example or comparative example were measured with the following device and conditions. Note that in a case in which the light-guiding member was produced using a resin composition containing a cycloolefin copolymer that was a copolymer of ethylene or an α-olefin with a cycloolefin and in which the cycloolefin constituted a cyclic structure included in a main chain, measurement was performed with conditions described in the subsequent

### <Molecular Weight and Molecular Weight Distribution (2)> Section.

### Measurement Device: Gel Permeation Chromatograph (HLC-8320GPC) Produced by Tosoh Corporation

### Measurement Conditions

Column: TSKguardcolumn SuperH-H×1, TSKgel SuperHM-M×2, and TSKgel SuperH2500×1 connected in order in series
Column temperature: 40° C.
Eluent solvent: Tetrahydrofuran at flow rate of 0.6 mL/min with 0.1 g/L of 2,6-di-t-butyl-4-methylphenol (BHT) added as internal standard
Detector: RI (differential refraction) detector
Detection sensitivity: 3.0 mV/min
Sample: Solution of 0.02 g of methacrylic resin composition in 20 mL of tetrahydrofuran
Injection volume: 10 μL
Standard samples for calibration curve preparation: Following 10 types of polymethyl methacrylate (PMMA Calibration Kit M-M-10 produced by Polymer Laboratories Ltd.) of differing molecular weight, each having a known monodisperse weight peak molecular weight
Weight peak molecular weight (Mp)

| | |
|---|---|
| Standard sample 1 | 1,916,000 |
| Standard sample 2 | 625,500 |
| Standard sample 3 | 298,900 |
| Standard sample 4 | 138,600 |
| Standard sample 5 | 60,150 |
| Standard sample 6 | 27,600 |
| Standard sample 7 | 10,290 |
| Standard sample 8 | 5,000 |
| Standard sample 9 | 2,810 |
| Standard sample 10 | 850 |

The RI detection intensity relative to the elution time of the methacrylic resin composition was measured under the conditions indicated above.

The weight-average molecular weight (Mw), number-average molecular weight (Mn), and Z-average molecular weight (Mz) of the methacrylic resin composition were determined based on calibration curves obtained through measurement of the standard samples for calibration curve preparation, and these values were used to determine the molecular weight distributions (Mw/Mn) and (Mz/Mw).

### <Molecular Weight and Molecular Weight Distribution (2)>

Among light-guiding members produced in the subsequently described examples and comparative examples, for those in which the used resin composition was a resin composition containing a cycloolefin copolymer that was a copolymer of ethylene or an α-olefin with a cycloolefin and in which the cycloolefin constituted a cyclic structure included in a main chain, the weight-average molecular weight (Mw), number-average molecular weight (Mn), and Z-average molecular weight (Mz) of a portion cut out from the light-guiding member were measured with a device and conditions indicated below.

### Measurement Device: Agilent (PL-GPC220)

### Measurement Conditions

Column: TSKguardcolumn GMHHR-H(20)HT (7.8 mm I.D.×30 cm)×2 connected in series
Column temperature: 145° C.
Eluent solvent: o-Dichlorobenzene containing 0.05% of 2,6-di-t-butyl-4-methylphenol (BHT)
Detector: RI (differential refraction) detector
Detection sensitivity: 3.0 mV/min
Sample: Sample weighed out into high temperature filtration device and dissolved through addition of 5 mL of eluent, heating at 145° C. for 30 minutes, and shaking for 1 hour to give solution concentration of 1 mg/mL
Injection volume: 500 μL
Flow rate: 0.7 mL/min
Standard samples for calibration curve preparation: Following 10 types of polystyrene of differing molecular weight, each having a known monodisperse weight peak molecular weight
Weight peak molecular weight (Mp)

| | |
|---|---|
| Standard sample 1 | 6,570,000 |
| Standard sample 2 | 2,703,000 |
| Standard sample 3 | 729,500 |
| Standard sample 4 | 301,600 |
| Standard sample 5 | 133,500 |
| Standard sample 6 | 70,500 |
| Standard sample 7 | 27,810 |
| Standard sample 8 | 9,570 |
| Standard sample 9 | 3,090 |
| Standard sample 10 | 580 |

The RI detection intensity relative to the elution time of the resin lens was measured under the conditions indicated above.

The weight-average molecular weight (Mw), number-average molecular weight (Mn), and Z-average molecular weight (Mz) of the resin were determined based on calibration curves obtained through measurement of the standard samples for calibration curve preparation, and these values were used to determine the molecular weight distributions (Mw/Mn) and (Mz/Mw).

### <Measurement of Glass-Transition Temperature>

Measurement of glass-transition temperature (Tg) (° C.) was performed in accordance with JIS-K7121.

First, from among light-guiding members produced in the subsequently described examples and comparative examples that had undergone conditioning (left for 1 week at 23° C.) in a standard state (23° C., 50% RH), four samples (four locations), each in an amount of approximately 10 mg, were cut out from a section of the light-guiding member as test specimens.

In the case of a DSC curve that was plotted using a differential scanning calorimeter (Diamond DSC produced by PerkinElmer Japan) under a nitrogen gas flow rate of 25 mL/min while heating the specimen from room temperature (23° C.) to 200° C. at 10° C./min (primary heating), holding the specimen at 200° C. for 5 minutes to completely melt the specimen, cooling the specimen from 200° C. to 40° C. at 10° C./min, holding the specimen at 40° C. for 5 minutes, and then reheating the specimen under the aforementioned heating conditions (secondary heating), the intersection point (glass-transition temperature of the methacrylic resin composition) of a stair-shaped change section of the DSC curve during the secondary heating and a straight line that was equidistant in a vertical axis direction from each extrapolated baseline was then measured in accordance with JIS-K7121.

In the case of a DSC curve that was plotted using a differential scanning calorimeter (DSC 8000 produced by PerkinElmer Japan) under a nitrogen gas flow rate of 25 mL/min while heating the specimen from room temperature (23° C.) to 200° C. at 10° C./min (primary heating), holding the specimen at 200° C. for 5 minutes to completely melt the specimen, cooling the specimen from 200° C. to 40° C. at 10° C./min, holding the specimen at 40° C. for 5 minutes, and then reheating the specimen under the aforementioned heating conditions (secondary heating), the intersection point (midpoint glass-transition temperature) of a stair-shaped change section of the DSC curve during the secondary heating and a straight line that was equidistant in a vertical axis direction from each extrapolated baseline was measured as the glass-transition temperature (Tg) (° C.). Four points were measured per sample, and the arithmetic mean (rounded to nearest whole number beyond the decimal point) for the four points was taken to be the measured value.

### <Measurement of Absolute Value of Photoelastic Coefficient (CR)>

A substrate section of a light-guiding member produced in a subsequently described example or comparative example was finely cut up and was made into a pressed film by a vacuum compression molding machine to obtain a measurement sample.

As the specific measurement conditions, a vacuum compression molding machine (SFV-30 manufactured by Shinto Metal Industries Corporation) was used to perform 10 minutes of preheating at 260° C. under vacuum (approximately 10 kPa) and subsequently compress pieces cut out from the light-guiding member at 260° C. and approximately 10 MPa for 5 minutes. After release of the vacuum and pressing pressure, the product was transferred to a compression molding machine for cooling and was subjected to cooling and solidification. The resultant pressed film was cured for at least 24 hours in a constant temperature and constant humidity chamber adjusted to a temperature of 23° C. and a humidity of 60%, and then a test specimen for measurement (thickness: approximately 150 μm; width: 6 mm) was cut out therefrom.

The photoelastic coefficient CR (Pa⁻¹) was measured using a birefringence measurement device that is described in detail in Polymer Engineering and Science 1999, 39, 2349-2357.

The film-shaped test specimen was set in a film tensing device (manufactured by Imoto Machinery Co., Ltd.) set up in the same manner in a constant temperature and constant humidity chamber such that the chuck separation was 50 mm. Next, a birefringence measurement device (RETS-100 manufactured by Otsuka Electronics Co., Ltd.) was set up such that the laser light path of the device was positioned in a central portion of the film. The birefringence of the test specimen was measured while applying tensile stress with a strain rate of 50%/min (chuck separation: 50 mm; chuck movement speed: 5 mm/min).

The photoelastic coefficient (CR) (Pa⁻¹) was calculated by making a least squares approximation of the relationship between the measured birefringence (Δn) and the tensile stress (σR) and then determining the gradient of the resultant straight line. This calculation was performed using data in a tensile stress range of 2.5 MPa≤σR≤10 MPa.

$$CR = Δ n / σ R$$

Note that the birefringence (An) is a value indicated below.

$$Δ n = n x - n y$$

(nx: refractive index of tension direction; ny: refractive index of in-plane direction perpendicular to tension direction)

### <Retardation in Effective Area of Light-Guiding Member>

A light-guiding member obtained in an example or comparative example was arranged with one of the two surfaces constituting a wave-guiding section as a lower surface, a birefringence evaluation system PA-300-L produced by Photonic Lattice, Inc. was used to measure a surface distribution of retardation in an effective area at a wavelength of 520 nm, a region was designated in the effective area, and an average (nm) of the absolute value of retardation was determined.

### <Measurement of Surface Accuracy PV Value of Light-Guiding Member>

An Ultra-precision point autofocus probe 3D measuring instrument NH-3SPs (produced by Mitaka Kohki Co., Ltd.) was used to measure surface accuracy with a test subject surface arranged facing toward an objective lens of the NH-3SPs using a fixing jig. A lens having a magnification of ×100 was used as the objective lens. In a case in which the shape of the light-guiding member included a protruding part and in which measurement of shape was difficult due to interference with the objective lens, measurement was performed after cutting off the protruding part or using a rotating stage.

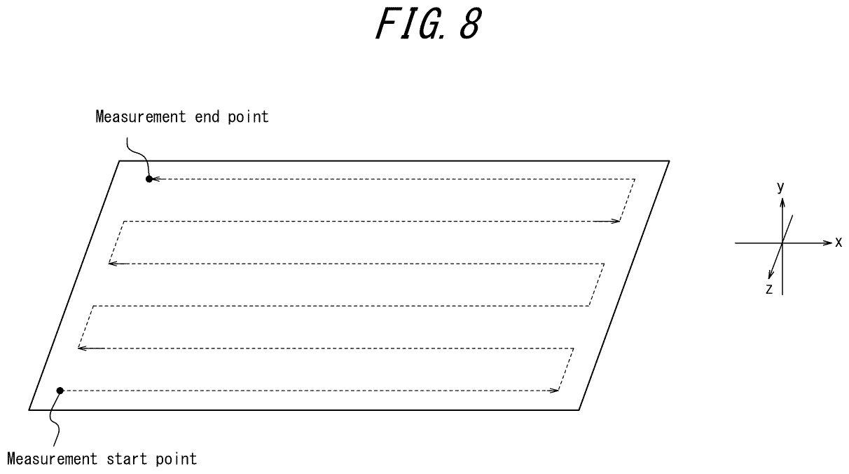

In an arrangement illustrated in FIG. 8, measurement in an x-axis direction and a z-axis direction was performed by turning back inward by 1/50^{th} of the length in a z-axis direction (transverse direction) from the perimeter of the light-guiding body. PV value measurement was performed for all surfaces that contribute to guiding image light, and the value of a surface having a largest PV value was taken to be the PV value of the light-guiding body.

Measurement was performed with the measurement pitch m in the x-axis direction set as 1/1000^{th} of a longest section of the light-guiding body in the x-axis direction and the measurement pitch in the z-axis direction set as 1/10^{th} of a longest section of the light-guiding body in the z-axis direction. Note that in a case in which a site having a diffraction function was present at the surface of the light-guiding body, the PV value was determined by measuring the surface exclusive of that site.

A smaller PV value indicates that the light-guiding body has higher flatness, has good external appearance with suppressed warping and non-uniformity of thickness, and provides excellent image quality.

Note that in the case of a light-guiding body having a large area, such as a case in which the length in the z-axis direction was 50 mm and extended outside of an operating region of the stage in the z-axis direction, for example, measurement was performed with the length in the z-axis direction split into 25 mm portions such that the measurement region was equally divided, and an average of results of these measurements was taken to be the PV value.

### <Polarized Light Reflectance Characteristics of Partial Reflecting Mirror of Light-Guiding Member>

The polarized light reflectance of a partial reflecting mirror formed in a light-guiding member obtained in an example or comparative example was measured using an apparatus where a spectrophotometer UV-2600 produced by Shimadzu Corporation was equipped with a large sample chamber, an incident angle variation device, a light-guiding member installation axle, and a large polarizer Assy.

The reflectance was measured by using an aperture mask for incident light having a 5 mm square aperture, adjusting the incident angle relative to the partial reflecting mirror surface to an angle of from 150 to 60°, and installing an adjustable angle integrating sphere at an angle at which reflected light entered. In order that reflected light of other surfaces of the sample did not affect measurement, surfaces other than the measurement surface were sanded using sand paper and were then completely colored black before performing measurement.

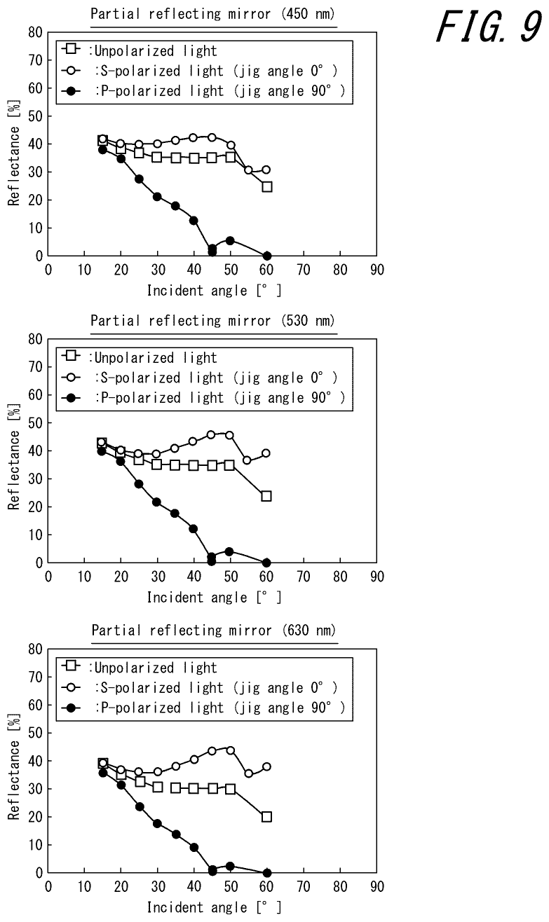

FIG. 9 illustrates one example of measurement results when coating was performed with the reflectance of the partial reflecting mirror set as 35%.

The reflectance of polarized light is confirmed to vary depending on the incident angle at wavelengths corresponding to blue (450 nm), green (530 nm), and red (630 nm).

With regards to reflectance at an incident angle of 30°, the difference between Rs and Rp was approximately 17% and Rs/Rp was 1.8.

### <Polarization Retention Characteristics (Tp/Tc) of Light-Guiding Member>

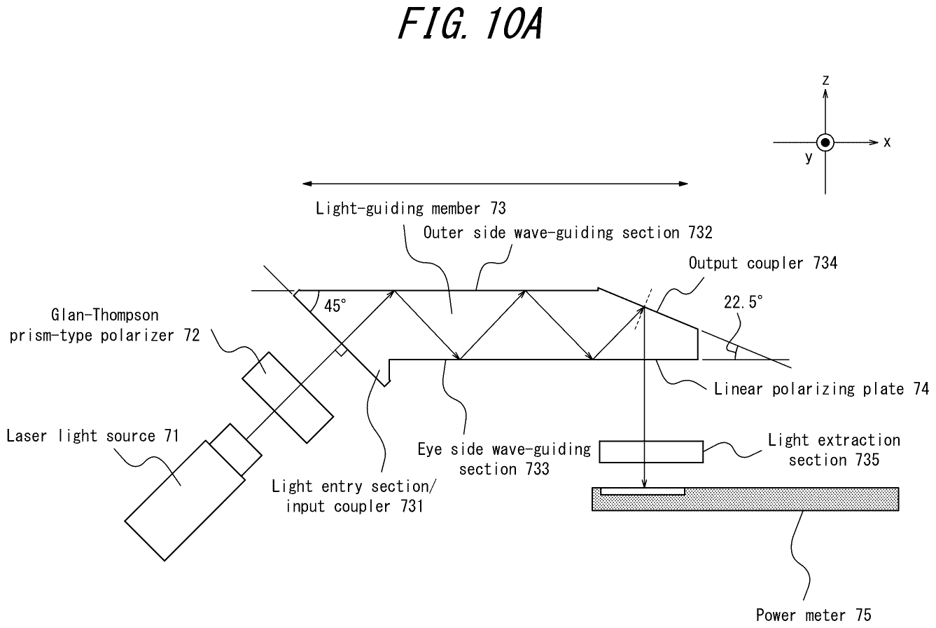

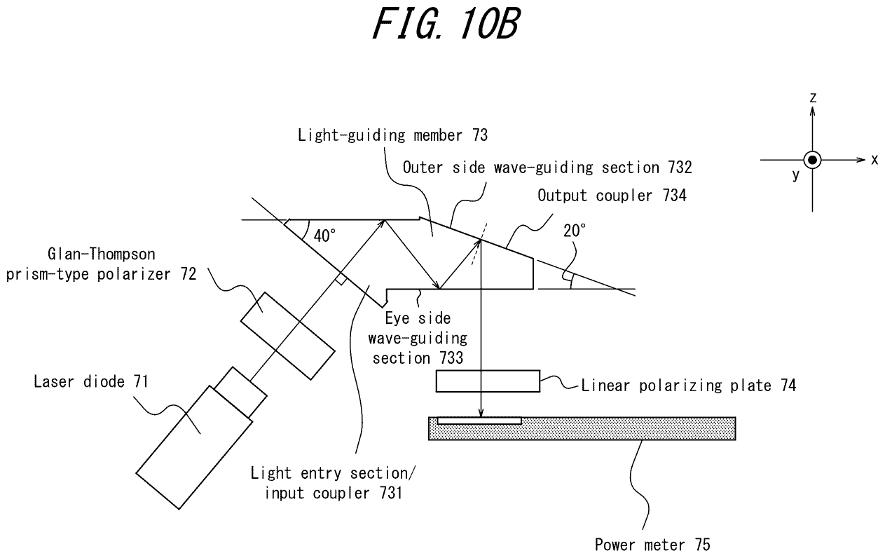

Polarization retention characteristics (Tp/Tc) of a light-guiding member obtained in an example or comparative example were measured with members arranged in a positional relationship illustrated in FIG. 10A or FIG. 10B.

A Glan-Thompson polarizer 72 (polarizer that transmits linearly polarized light having a specific vibration and does not transmit (absorbs or scatters) linearly polarized light vibrating along an axis orthogonal to the vibration axis of the aforementioned linearly polarized light) was arranged as a linear polarizing plate such as to be orthogonal to the axis of a light beam of a laser light source 71 (laser light source of blue, green, or red used depending on measurement wavelength; hereinafter, also abbreviated as blue LD, green LD, and red LD), the light-guiding member 73 was arranged such that light of the laser light source 71 entered in a direction perpendicular to a light entry section 731 of the light-guiding member 73, and laser light was irradiated into the aforementioned member. The laser light was guided by an outer side wave-guiding section 732 and an eye side wave-guiding section 733 of the light-guiding member, and then for light that had been extracted by an output coupler 734, light output was measured using a power meter 75 arranged with a linear polarizing plate 74 (SPF-50C-32 produced by Sigmakoki Co., Ltd.; extinction ratio at 500 nm of 104 or more) in-between.

A polarization retention characteristic (Tp/Tc) of S-polarized light was determined by, for a situation in which the linear polarizing plate 72 was arranged such that incident light was S-polarized light having a vibration axis perpendicular to the plane of incidence at the wave-guiding section of the light-guiding body, taking light output when the transmission axis of the linear polarizing plate 74 was also arranged so as to transmit the same S-polarized light to be Tp and taking light output measured when the linear polarizing plate 74 was rotated by 900 and arranged so as to transmit P-polarized light to be Tc. Moreover, in order to make an evaluation in which the influence of the difference between reflectance of S-polarized light and reflectance of P-polarized light by the partial reflecting mirror at an incident angle of 30° was eliminated, a value determined by dividing the obtained polarization retention characteristic (Tp/Tc) of S-polarized light by the ratio of polarized light reflectance (Rs/Rp) was taken as a measurement value. Note that in a case in which a plurality of partial reflecting mirror reflectances are designed, a value determined when Tp/Tc was divided by a largest value for the ratio of polarized light reflectance (Rs/Rp) was taken as a measurement value.

Likewise, a polarization retention characteristic (Tp/Tc) of P-polarized light was determined by, for a situation in which the linear polarizing plate 72 was arranged such that incident light was P-polarized light having a vibration axis parallel to the plane of incidence at the wave-guiding section of the light-guiding body, taking light output when the transmission axis of the linear polarizing plate 74 was also arranged so as to transmit the same P-polarized light to be Tp and taking light output measured when the linear polarizing plate 74 was rotated by 90° and arranged so as to transmit S-polarized light to be Tc.

Moreover, in order to make an evaluation in which the influence of the difference between reflectance of S-polarized light and reflectance of P-polarized light by the partial reflecting mirror at an incident angle of 30° was eliminated, a value determined by multiplying the obtained polarization retention characteristic (Tp/Tc) of S-polarized light by the ratio of polarized light reflectance (Rs/Rp) was taken as a measurement value. Note that in a case in which a plurality of partial reflecting mirror reflectances are designed, a value determined when Tp/Tc was multiplied by a largest value for the ratio of polarized light reflectance (Rs/Rp) was taken as a measurement value.

Measurements were performed using lasers having wavelengths corresponding to blue, green, and red.

### <Light Extraction Efficiency of Light-Guiding Member>

Light utilization efficiency of a light-guiding member obtained in an example or comparative example was measured in a positional relationship illustrated in FIG. 10A or FIG. 10B in which the previously described polarization retention characteristics (Tp/Tc) were measured.

First, in the arrangement illustrated in FIG. 10A or FIG. 10B, a power meter 75 was installed at a location ahead of a light beam of a laser light source 71 outputting green light and a Glan-Thompson prism-type polarizer 72 and directly before entry onto the light-guiding member, and light output T₀ was measured.

Thereafter, members were arranged in the positional relationship in FIG. 10A or FIG. 10B in the same manner as in measurement of polarization retention characteristics (Tp/Tc) described above, light from the green laser light source was caused to enter the light-guiding member, and the light intensity of laser light exiting from the light extraction section was measured by a power meter 75 with a linear polarizing plate 74 in-between.

The light extraction efficiency was measured from a light output ratio of light output Tp measured at the light extraction section relative to the initial light output T₀ entering the light-guiding member. S-polarized light Tp/To for conditions where S-polarized light relative to a reflecting surface of the wave-guiding section entered the light-guiding member and P-polarized light Tp/To for conditions where P-polarized light relative to a reflecting surface of the wave-guiding section entered the light-guiding member were each measured.

### <Observed Image Evaluation>

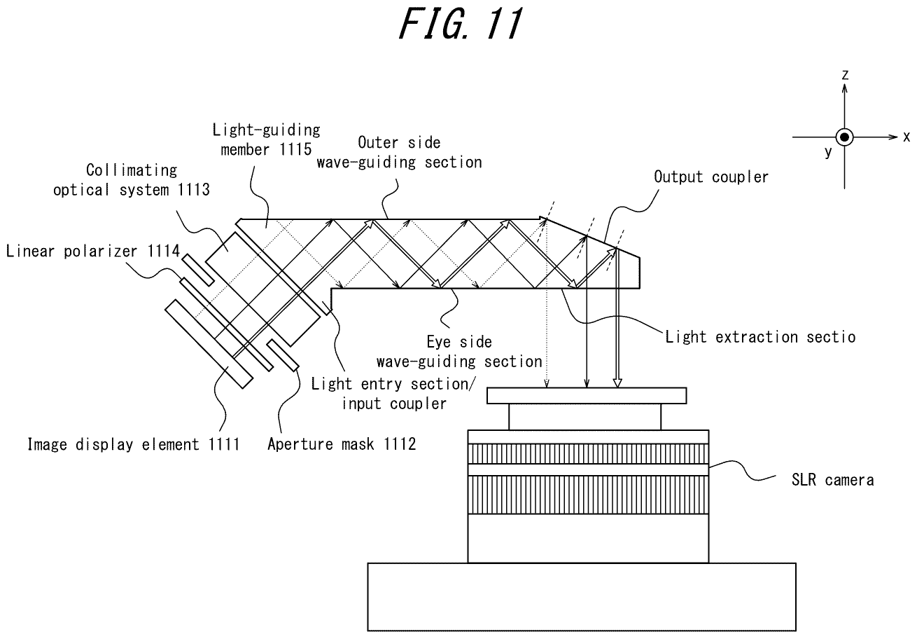

A light-guiding member obtained in an example or comparative example was used to evaluate an image. A simulation device based on the principle of an AR head-mounted display was prepared in a dark room as illustrated in FIG. 11.

In this simulation device, a micro OLED panel 111 (SY103WAM13-00 produced by Seeya) was arranged and output an image. The image was set as white screen display. Image light was caused to enter a light-guiding member 115 through a light entry section 1151 thereof, via an aperture mask 112, a collimating optical system 113, and a linear polarizing plate 114. Next, the image light was guided by the wave-guiding section, and then image light that was output from the light-guiding member at the output coupler, via the light output section, was recorded using an imaging camera.

The recorded image was evaluated by the following standard from a viewpoint of non-uniformity of brightness, non-uniformity of color, and rainbow effect as condition 1.
Non-uniformity of brightness, non-uniformity of color, and rainbow effect not observed: A
Slight non-uniformity of brightness observed: B
Non-uniformity of brightness and non-uniformity of color observed: C
Non-uniformity of brightness, non-uniformity of color, and rainbow effect observed: D

Next, the recorded image was evaluated by the following standard for the presence of image distortion as condition 2.
Image distortion not observed: A
Slight image distortion observed: B
Image distortion observed: C
Strong image distortion observed: D

### [Raw Materials]

Raw materials used in the subsequently described examples and comparative examples were as follows.

### [[Monomers Forming Methacrylic Resin]]

Methyl methacrylate (MMA): produced by Asahi Kasei Corporation
N-Phenylmaleimide (PMI): produced by Nippon Shokubai Co., Ltd.
N-Cyclohexylmaleimide (CMI): produced by Nippon Shokubai Co., Ltd.
Styrene: produced by FUJIFILM Wako Pure Chemical Corporation
α-Methylstyrene: produced by FUJIFILM Wako Pure Chemical Corporation
Methyl 2-(hydroxymethyl)acrylate (MHMA): produced by Combi-Blocks Inc.

### [[Organic Solvents]]

Meta-xylene (mXy): produced by Mitsubishi Gas Chemical Company, Ltd.
Methyl isobutyrate: produced by Kanto Chemical Co., Inc.
Toluene: produced by FUJIFILM Wako Pure Chemical Corporation

### [[Polymerization Initiators]]

1,1-Di(t-butylperoxy)cyclohexane: produced by NOF Corporation
t-Amyl peroxy-2-ethylhexanoate: Luperox 575 produced by Arkema Yoshitomi, Ltd.
t-Amyl peroxyisononanoate: produced by Arkema Yoshitomi, Ltd.

### [[Chain Transfer Agents]]

n-Octyl mercaptan: produced by Chevron Phillips Chemical LLC.
n-Dodecyl mercaptan: produced by FUJIFILM Wako Pure Chemical Corporation

### [[Additives]]

Pentaerythritol tetrakis[3-(3,5-di-tert-butyl-4-hydroxyphenyl)propionate]: Irganox 1010 produced by BASF Corporation
Tris(2,4-di-t-butylphenyl) phosphite: Irgafos 168 produced by BASF Corporation
RIKEMAL H-100: produced by Riken Vitamin Co., Ltd.
ADK STAB 2112: produced by Adeka Corporation
Stearyl phosphate/distearyl phosphate mixture: produced by Sakai Chemical Industry Co., Ltd.
ADK STAB PEP-36: produced by Adeka Corporation Octadecyl-3-(3,5-di-tert-butyl-4-hydroxyphenyl)-propionate: Irganox 1076 produced by BASF Corporation
Monomethylamine: produced by Mitsubishi Gas Chemical Company, Ltd.
Dimethyl carbonate: produced by FUJIFILM Wako Pure Chemical Corporation
Triethylamine: produced by FUJIFILM Wako Pure Chemical Corporation
Pentaerythritol distearate: UNISTER H-476D produced by NOF Corporation
Pentaerythritol tetrastearate: UNISTER H-476 produced by NOF Corporation

### Synthesis Example 1 [Methacrylic Resin Composition A]

A mixed monomer solution was obtained by measuring out 318.7 kg of methyl methacrylate (hereinafter, denoted as MMA), 35.5 g of N-phenylmaleimide (hereinafter, denoted as PMI), 63.7 kg of N-cyclohexylmaleimide (hereinafter, denoted as CMI), 0.341 kg of n-octyl mercaptan as a chain transfer agent, and 225.1 kg of meta-xylene (hereinafter, denoted as mXy), adding these materials into a 1.25 m³ reactor equipped with a stirring blade and a temperature controller functioning through use of a jacket, and then stirring these materials.

Next, 116.9 kg of mXy was measured out and was added into a first tank to prepare a supplemental solvent.

In addition, 104.5 kg of MMA and 85.5 kg of mXy were measured out in a second tank and were stirred to obtain a supplemental MMA solution.

Liquid contained in the reactor was subjected to 1 hour of nitrogen bubbling at a rate of 30 L/min, and liquids contained in the first tank and the second tank were also each subjected to 30 minutes of nitrogen bubbling at a rate of 10 L/min so as to remove dissolved oxygen.

Thereafter, the temperature of the solution in the reactor was raised to 125° C. by blowing steam into the jacket, and the solution was stirred at 50 rpm while adding a polymerization initiator solution of 0.457 kg of 1,1-di(t-butylperoxy)cyclohexane dissolved in 2.67 kg of mXy at a rate of 1 kg/hr to initiate polymerization. Note that the temperature of the solution in the reactor was controlled to 125±2° C. through the jacket during polymerization. At 30 minutes after the start of polymerization, the addition rate of the polymerization initiator solution was reduced to 0.25 kg/hr, and mXy was further added from the first tank for 3.5 hours at 29.24 kg/hr.

Next, at 4 hours after the start of polymerization, the addition rate of the polymerization initiator solution was raised to 0.75 kg/hr, and the supplemental MMA solution was added from the second tank for 2 hours at 95 kg/hr.

Moreover, the addition rate of the polymerization initiator solution was reduced to 0.25 kg/hr at 6 hours after the start of polymerization, and addition was stopped at 7 hours after the start of polymerization.

A polymerization solution containing a methacrylic resin was obtained once 8 hours had passed from the start of polymerization. With respect to this solution, 0.261 kg of Irganox 1010 and 0.784 kg of Irgafos 168 as antioxidants, and 0.784 kg of RIKEMAL H-100 as a mold release agent were added.

Next, the resultant polymerization solution was fed into a concentrating device comprising a vaporization tank and a tubular heat exchanger that had been pre-heated to 250° C. and was subjected to devolatilization. The condition of degree of vacuum in the vaporization tank was 10 Torr to 15 Torr. The resin flowing down the vaporization tank was discharged with a screw pump, extruded through a strand die, cooled with water, and subsequently pelletized to obtain pellets of a methacrylic resin composition A including N-substituted maleimide structural units.

The obtained pellets had a glass-transition temperature (Tg) of 133° C. and a flexural strength of 66 MPa. Other properties are summarized in the tables. Moreover, the oxygen weight proportion determined from a monomer composition ratio determined from ¹H-NMR composition was 29 wt %.

### Synthesis Example 2 [Methacrylic Resin Composition B]

A monomer composition containing 75.000 mol % of MMA, 24.998 mol % of styrene, and 0.002 mol % of t-amyl peroxy-2-ethylhexanoate as a polymerization initiator was continuously supplied to a 10 L fully mixed tank equipped with a helical ribbon impeller at 1 kg/hr, and continuous polymerization was performed with an average residence time of 2.5 hours at a polymerization temperature of 150° C. The liquid level in the polymerization tank was maintained constant by continuous withdrawal from the bottom, and the withdrawn material was fed into a concentrating device comprising a tubular heat exchanger and a vaporization tank and was subjected to devolatilization. The condition of degree of vacuum in the vaporization tank was 10 Torr to 15 Torr. The resin flowing down the vaporization tank was discharged with a screw pump, extruded through a strand die, cooled with water, subsequently pelletized, and then introduced into a solvent removal device to obtain a pelletized methyl methacrylate-styrene copolymer.

This copolymer was dissolved in methyl isobutyrate to prepare a 10 mass % methyl isobutyrate solution. A 1,000 mL autoclave was charged with 500 parts by mass of the 10 mass % methyl isobutyrate solution of the copolymer and 1 part by mass of 10 mass % Pd/C (produced by N.E. Chemcat Corporation) as a hydrogenation catalyst. Aromatic double bonds of the styrene portion of the copolymer were hydrogenated by maintaining a hydrogen pressure of 9 MPa and temperature of 200° C. for 15 hours. The hydrogenation catalyst was removed using a filter, 0.04 parts by mass of RIKEMAL H-100 was added and mixed into the polymer solution, and then the polymer solution was fed into a concentrating device comprising a tubular heat exchanger and a vaporization tank and was subjected to devolatilization. The condition of degree of vacuum in the vaporization tank was 10 Torr to 15 Torr. The resin flowing down the vaporization tank was discharged with a gear pump, extruded from a strand die, cooled with water, and subsequently pelletized to obtain pellets of a methacrylic resin composition B.

The obtained pellets had a glass-transition temperature (Tg) of 119° C. and a flexural strength of 95 MPa. Other properties are summarized in the tables. Moreover, the oxygen weight proportion determined from a monomer composition ratio determined from ¹H-NMR composition was 24 wt %.

### Synthesis Example 3 [Methacrylic Resin Composition C]

A 30 L reaction vessel equipped with a stirring device having a paddle blade, a temperature sensor, a condenser, and a nitrogen feeding tube was charged with 2.25 kg of methyl methacrylate, 0.32 kg of methyl 2-(hydroxymethyl)acrylate, 0.024 kg of styrene, 0.025 parts by mass of n-dodecyl mercaptan as chain transfer agent per 100 parts by mass of the total amount of all monomers finally charged to the reaction vessel, 0.025 parts of ADK STAB 2112, and 5.39 kg of toluene, and these materials were heated to 105° C. under stirring while passing nitrogen.

A solution containing 0.20 kg of toluene and 0.014 kg of t-amyl peroxyisononanoate was added dropwise into the polymerization tank as an initial initiator over 10 minutes while performing polymerization at 105° C. to 110° C. Then, after 10 minutes, a solution containing 0.26 kg of toluene and 0.017 kg of t-amyl peroxyisononanoate was added dropwise over 3 hours. Concurrently to the addition of this initiator solution, a solution containing 2.75 kg of methyl methacrylate, 0.40 kg of methyl 2-(hydroxymethyl)acrylate, and 0.24 kg of styrene was also added dropwise over 3 hours while performing polymerization at a polymerization temperature of 105° C. to 110° C. This was followed by a further 2 hours of aging.

A mixed solution of 4.5 g of a stearyl phosphate/distearyl phosphate mixture and 72 g of toluene was added to the resultant polymer solution, and a cyclocondensation reaction was performed at 90° C. to 110° C. for 1.5 hours. Thereafter, 0.10 parts by mass of RIKEMAL H-100 per 100 parts by mass of the total amount of all monomers finally charged to the reaction vessel was added and mixed by stirring.

A φ42 mm devolatilization extruder having four front vents and one rear vent was used to perform a cyclocondensation reaction and devolatilization treatment of the resultant polymerization solution at a barrel temperature of 220° C., 120 rpm, and 5 kg/hr in terms of amount of resin, and to obtain pellets of a methacrylic resin composition C.

The obtained pellets had a glass-transition temperature (Tg) of 127° C. and a flexural strength of 98 MPa. Moreover, the oxygen weight proportion determined from a monomer composition ratio determined from ¹H-NMR composition was 31 wt %.

### Synthesis Example 4 [Methacrylic Resin Composition D]

Polymethyl methacrylate that had a weight-average molecular weight of 108,000 and that contained 0.1 parts by mass of RIKEMAL H-100 relative to 100 parts by mass of the mass of the overall polymer was fed at 20 kg/hr from a hopper to a co-rotating twin-screw extruder with a screw diameter of 40 mm in which the cylinder temperature of the extruder was set to 275° C. and the screw rotation speed was set as 150 rpm, and nitrogen was also caused to flow inside of the extruder at a flow rate of 200 mL/min. After melting and filling of the resin by a kneading block, 1.8 parts by mass of monomethylamine relative to 100 parts by mass the raw material resin was injected from a nozzle to thereby cause an imidization reaction. A reverse flight was inserted at the end of the reaction zone (upstream of the vent port) to cause filling of the resin. Any by-products and excess monomethylamine after the reaction were removed by reducing the pressure of the vent port to 50 Torr. Resin that was discharged as strands from a die disposed at the outlet of the extruder was cooled in a water tank and then pelletized by a pelletizer to thereby obtain an imide resin.

Next, the resultant imide resin was fed at 20 kg/hr to a co-rotating twin-screw extruder with a screw diameter of 40 mm in which the cylinder temperature was set as 255° C. and the screw rotation speed was set at 150 rpm. After melting and filling of resin by a kneading block, a mixture of dimethyl carbonate and triethylamine as esterification agents was injected from a nozzle to decrease the amount of carboxyl groups in the resin. The amount of dimethyl carbonate was 3.2 parts by mass and the amount of triethylamine was 0.8 parts by mass relative to 100 parts by mass of the imide resin. Any by-products and excess dimethyl carbonate after the reaction were removed by reducing the pressure of the vent port to 50 Torr. Resin that was discharged as strands from a die disposed at the outlet of the extruder was cooled in a water tank and then pelletized by a pelletizer to thereby obtain pellets of a methacrylic resin composition D including a glutarimide structure.

The obtained pellets had a glass-transition temperature (Tg) of 122° C. and a flexural strength of 127 MPa. Moreover, the oxygen weight proportion determined from a monomer composition ratio determined from ¹H-NMR composition was 31 wt %.

### Synthesis Example 5 [Methacrylic Resin Composition E]

A mixed monomer solution was prepared by measuring out 298.5 kg of MMA, 37.0 kg of PMI, 104.5 kg of CMI, 0.23 kg of n-octyl mercaptan as a chain transfer agent, and 247.0 kg of mXy, adding these materials into a 1.25 m³ reactor equipped with a stirring blade and a temperature controller functioning through use of a jacket, and then stirring these materials.

Next, 123.0 kg of mXy was measured out and was added into a first tank.

In addition, 110.0 kg of MMA and 80.0 kg of mXy were measured out into a second tank and were stirred to obtain a supplemental monomer solution.

Liquid contained in the reactor was subjected to 1 hour of nitrogen bubbling at a rate of 30 L/min, and liquids contained in the first tank and the second tank were also each subjected to 30 minutes of nitrogen bubbling at a rate of 10 L/min so as to remove dissolved oxygen.

Thereafter, the temperature of the solution in the reactor was raised to 124° C. by blowing steam into the jacket, and the solution was stirred at 50 rpm while adding a polymerization initiator solution of 0.35 kg of 1,1-di(t-butylperoxy)cyclohexane dissolved in 4.652 kg of mXy at a rate of 1 kg/hr to initiate polymerization and while also adding mXy from the first tank for 4 hours at 30.75 kg/hr.

Note that the temperature of the solution in the reactor was controlled to 124±2° C. through the jacket during polymerization.

Between 4 hours and 6 hours thereafter, the monomer solution containing MMA was added from the second tank at a rate of 95 kg/hr.

The addition rate of the polymerization initiator solution was reduced to 0.25 kg/hr at 0.5 hours after the start of polymerization, 0.75 kg/hr at 4 hours after the start of polymerization, and 0.5 kg/hr at 6 hours after the start of polymerization. At 7 hours after the start of polymerization, addition of the polymerization initiator solution was stopped and polymerization was continued for a further 3 hours to obtain a polymerization solution containing a methacrylic resin including a cyclic structural unit in a main chain.

With respect to this polymerization solution, 0.83 kg of ADK STAB PEP-36, 0.28 kg of Irgafos 168, 0.44 kg of Irganox 1076, and 1.10 kg of RIKEMAL H-100 were added under stirring.

Next, the resultant polymerization solution was fed into a concentrating device comprising a vaporization tank and a tubular heat exchanger that had been pre-heated to 260° C. and was subjected to devolatilization. The condition of degree of vacuum in the vaporization tank was 10 Torr to 15 Torr. The resin flowing down the vaporization tank was discharged with a screw pump, extruded through a strand die, cooled with water, and subsequently pelletized to obtain pellets of a methacrylic resin E including N-substituted maleimide structural units.

The obtained pellets had a glass-transition temperature (Tg) of 146° C., a melt viscosity of 210 Pa·s, and a flexural strength of 59 MPa. Moreover, the oxygen weight proportion determined from a monomer composition ratio determined from ¹H-NMR composition was 28 wt %.

### Synthesis Example 6 [Resin Composition F of Cycloolefin Copolymer]

First, VO(OC₂H₅)Cl₂ was diluted with cyclohexane to prepare a vanadium catalyst having a vanadium concentration of 6.7 mmol/L-cyclohexane. Ethylaluminum sesquichloride (Al(C₂H₅)_{1.5}Cl_{1.5}) was diluted with cyclohexane to prepare an organoaluminum compound catalyst having an aluminum concentration of 107 mmol/L-cyclohexane.

Next, a stirred polymerization vessel (inner diameter: 500 mm; reaction volume: 100 L) was used to continuously perform a copolymerization reaction of ethylene and tetracyclo[4.4.0.1^{2,5}.1^{7,10}]-3-dodecene. Ethylene was supplied into the polymerization vessel together with hydrogen gas. The flow rate of hydrogen gas was adjusted so as to achieve the desired molecular weight. In performing this copolymerization reaction, the vanadium catalyst prepared by the method described above was supplied into the polymerization vessel in an amount such that the concentration of the vanadium catalyst relative to cyclohexane used as a polymerization solvent in the polymerization vessel was 0.6 mmol/L. In addition, the organoaluminum compound (ethylaluminum sesquichloride) was supplied into the polymerization vessel in an amount such that Al/V=18.0. The copolymerization reaction was performed continuously with the polymerization temperature set as 8° C. and the polymerization pressure set as 1.8 kg/cm²G.

Water and sodium hydroxide aqueous solution of 25 mass % in concentration as a pH modifier were added to a solution of a copolymer of ethylene and tetracyclo[4.4.0.1^{2,5}.1^{7,10}]-3-dodecene that was withdrawn from the polymerization vessel so as to stop the polymerization reaction. Also, catalyst residue present in the copolymer was removed (deashed) from this copolymer solution. With respect to the cyclohexane solution (polymer concentration: 7.7 mass %) of the copolymer of ethylene and tetracyclo[4.4.0.1^{2,5}.1^{7,10}]-3-dodecene that had undergone the deashing treatment described above, Irganox 1010 was added as a stabilizer in an additive amount of 0.4 parts by mass relative to 100 parts by mass of the copolymer. Next, before starting a flash drying step, 1 hour of mixing was performed using a stirred tank having an effective volume of 1.0 m³.

The cyclohexane solution of the copolymer in which the concentration of the copolymer had been adjusted to 5 mass % was supplied at a rate of 150 kg/hr into a double-tube heater (outer tube diameter: 2B; inner tube diameter: ¾B; length: 21 m) in which 20 kg/cm²G of steam was used as a heat source and was heated to 180° C.

A double-tube flash dryer (outer tube diameter: 2B; inner tube diameter: ¾B; length: 27 m) and a flash hopper (volume: 200 L) in which 25 kg/cm²G of steam was used as a heat source were used to remove cyclohexane serving as a polymerization solvent and the majority of unreacted monomer from the cyclohexane solution of the copolymer that had undergone the heating step described above and thereby obtain a random copolymer (cycloolefin copolymer) of ethylene and tetracyclo[4.4.0.1^{2,5}.1^{7,10}]-3-dodecene in a molten state that had undergone flash drying.

The cycloolefin copolymer was extruded using a vented twin-screw kneading extruder and was pelletized by an underwater pelletizer attached to an outlet of the extruder. The resultant pellets were dried by hot air at a temperature of 100° C. for 4 hours to obtain a cycloolefin copolymer resin composition F.

Upon confirmation of the composition ratio of the cycloolefin copolymer by ¹³C-NMR measurement, copolymerization of a specific amount of an olefin in a molar ratio of 62 mol % and tetracyclo[4.4.0.1^{2,5}.1^{7,10}]-3-dodecene in a ratio of 38 mol % was confirmed from a ratio of CH and CH₂. The obtained pellets had a glass-transition temperature (Tg) of 142° C. and a flexural strength of 78 MPa. The oxygen weight proportion determined from the monomer composition ratio was 0 wt %. Other properties are recorded in the tables.

### Synthesis Example 7 [Methacrylic Resin Composition G]

A 30 L reaction vessel equipped with a stirring device having a paddle blade, a temperature sensor, a condenser, and a nitrogen feeding tube was charged with 2.25 kg of methyl methacrylate, 1.25 kg of methyl 2-(hydroxymethyl)acrylate, 0.025 parts by mass of n-dodecyl mercaptan as chain transfer agent per 100 parts by mass of the total amount of all monomers, 0.025 parts of ADK STAB 2112, and 6.25 kg of toluene, and these materials were heated to 105° C. under stirring while passing nitrogen.

Under reflux, 0.05 parts by mass of t-amyl peroxyisononanoate was added into the polymerization tank relative to 100 parts by mass of the total amount of all monomers, 0.1 parts by mass of t-amyl peroxyisononanoate was further added dropwise over 2 hours while performing polymerization under reflux at a polymerization temperature of 105° C. to 110° C., and then the polymerization reaction was continued for a further 6 hours.

Next, 6.3 g of a stearyl phosphate/distearyl phosphate mixture was added to the resultant polymer solution, and a cyclocondensation reaction was carried out at 90° C. to 110° C. for 5 hours. Thereafter, 0.15 parts by mass of RIKEMAL H-100 was added relative to 100 parts by mass of the total amount of all monomers and was mixed by stirring.

A φ42 mm devolatilization extruder having four front vents and one rear vent was used to perform a cyclocondensation reaction and devolatilization treatment of the resultant polymerization solution at 120 rpm and 2.2 kg/hr in terms of amount of resin and to obtain pellets of a methacrylic resin composition H.

The obtained pellets had a glass-transition temperature (Tg) of 133° C. and a flexural strength of 71 MPa. Moreover, the oxygen weight proportion determined from a monomer composition ratio determined from ¹H-NMR composition was 33 wt %.

### Synthesis Example 8 [Methacrylic Resin Composition J]

A mixed monomer solution was obtained by measuring out 381 kg of MMA, 0 kg of PMI, 37 kg of CMI, 0.38 kg of n-octyl mercaptan as a chain transfer agent, and 225.1 kg of mXy, adding these materials into a 1.25 m³ reactor equipped with a stirring blade and a temperature controller functioning through use of a jacket, and then stirring these materials. With the exception of the above, pellets of a resin composition J were obtained in the same way as in Synthesis Example 1.

The obtained pellets had a glass-transition temperature (Tg) of 124° C. and a flexural strength of 110 MPa. Moreover, the oxygen weight proportion determined from a monomer composition ratio determined from ¹H-NMR composition was 30.9 wt %.

### Example 1

### [Molding of Light-Guiding Member]

The methacrylic resin composition A obtained in Synthesis Example 1 was used to perform injection molding in an injection molding machine (S-2000i50B produced by FANUC Corporation; screw diameter: 26 mm). A mold for obtaining a light-guiding member having a shape illustrated in FIG. 10A (thickness between wave-guiding sections: 2.9 mm; wave-guiding distance of principal ray inside of light-guiding member: 21 mm; projection length in wave-guiding direction: 18 mm) was used. The light entry section, the outer side wave-guiding section, the eye side wave-guiding section (inclusive of light exit section), and the output coupler are each a flat surface.

A substrate section of the light-guiding member was molded with the cylinder temperature set as 120° C. higher than Tg of the used resin composition and with the mold temperature set such that the actual temperature was 15° C. lower than Tg of the used resin composition. The holding pressure was set as 105 MPa for 5 seconds in a first stage and was subsequently set as 70 MPa for 3 seconds in a second stage in order to relieve stress and strain inside of the molded article. Moreover, injection molding was implemented with the injection rate set as an initial rate of 5 mm/s, reduced to 1 mm/s at a gate section, and with filling at 4 mm/s after passing the gate so as to obtain a light-guiding member according to Example 1.

The surface shape of the resultant molded piece was measured, and then the molded piece was placed at rest on a metal tray. The shape of each surface of the light-guiding member was measured using an NH-3SPs (produced by Mitaka Kohki Co., Ltd.), and the molding conditions were adjusted as appropriate for obtaining a specific shape so as to obtain a light-guiding member having the specific shape.

Next, the light-guiding member was washed by ultrasonication using water and a surfactant as a washing liquid. The light-guiding member was vacuum dried at 70° C. for 6 hours, and then vapor deposition was performed for an anti-reflection coating at the light entry section and a partial reflecting mirror having a reflectance of unpolarized light set as 35% at each of the outer side wave-guiding section, the eye side wave-guiding section, and the output coupler. At a wavelength of 530 nm, the partial reflecting mirror had an Rs/Rp of 1.8 and a reflectance difference between Rs and Rp of 17% at an incident angle of 300.

Moreover, the in-plane retardation in a wave-guiding section effective area (measurement performed with projected area of measurement area occupied at measurement subject surface set as 90% relative to projected area of entire measurement subject surface) was 13 nm. The PV values of various surfaces were 2 μm for the light entry section, 7.1 μm for the outer side wave-guiding section, 12.3 μm for the eye side wave-guiding section, and 10.4 μm for the output coupler.

Other evaluation results for evaluation as a light-guiding member are shown in Table 1.

Note that the PV values of various surfaces the day after molding were 1.3 μm for the light entry section, 4.5 μm for the outer side wave-guiding section, 5.6 μm for the eye side wave-guiding section, and 4.6 μm for the output coupler, and the PV values of the various surfaces after 5 days had passed were 2.2 μm for the light entry section, 6.7 μm for the outer side wave-guiding section, 11.5 μm for the eye side wave-guiding section, and 10.5 μm for the output coupler.

### Example 2

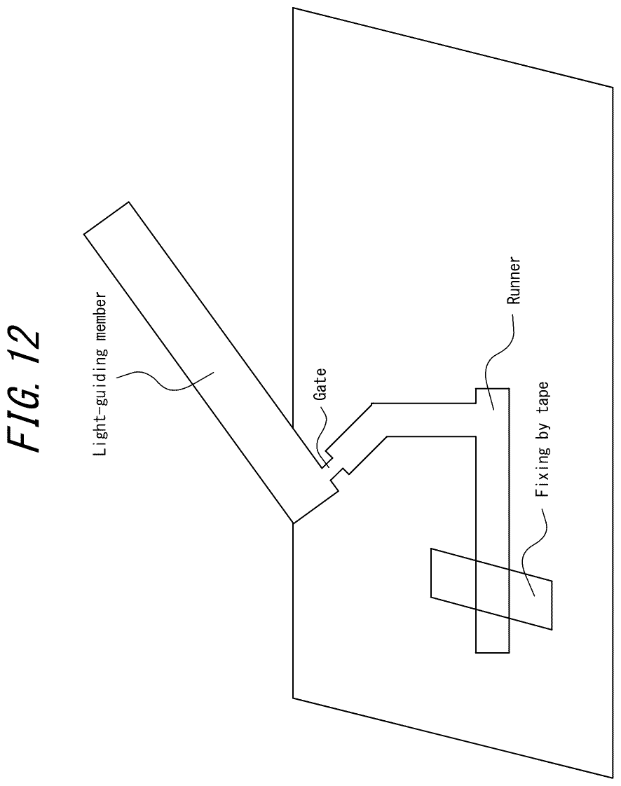

After performing injection molding in Example 1, the molded piece, while still in a state with the runner and the sprue remaining without cutting off the gate, was left for 1 day inside of a room controlled to a temperature of 23° C. with the sprue in a plastic tray and the runner section fixed by cellophane tape such that the light-guiding member was held up in the air as illustrated in FIG. 12. Thereafter, vapor deposition was performed in the same way as in Example 1, and various measurements were conducted.

The PV values of various surfaces were 0.9 μm for the light entry section, 1.4 μm for the outer side wave-guiding section, 3.6 μm for the eye side wave-guiding section, and 4.2 μm for the output coupler.

Other evaluation results for evaluation as a light-guiding member are shown in Table 1.

### Example 3

A light-guiding member was produced in the same way as in Example 2 with the exception that a partial reflecting mirror setting reflectance of the outer side wave-guiding section, the eye side wave-guiding section, and the output coupler as 40% was provided. At a wavelength of 530 nm, the partial reflecting mirror had an Rs/Rp of 1.4 and a reflectance difference between Rs and Rp of 13% at an incident angle of 30°.

Other evaluation results for evaluation as a light-guiding member are shown in Table 1.

### Example 4

A light-guiding member was produced in the same way as in Example 2 with the exception that a partial reflecting mirror setting reflectance of the outer side wave-guiding section, the eye side wave-guiding section, and the output coupler as 50% was provided. At a wavelength of 530 nm, the partial reflecting mirror had an Rs/Rp of 1.3 and a reflectance difference between Rs and Rp of 15% at an incident angle of 30°.

Other evaluation results for evaluation as a light-guiding member are shown in Table 1.

### Example 5

A light-guiding member was produced in the same way as in Example 2 with the exception that a mold for obtaining a light-guiding member having a shape in Example 10B (thickness between wave-guiding sections: 5.0 mm; wave-guiding distance of principal ray inside of light-guiding member: approximately 21 mm; projection length in wave-guiding direction: 30 mm) was used, and a partial reflecting mirror was provided such that the reflectance of the outer side wave-guiding section, the eye side wave-guiding section, and the output coupler was 50% and, at a wavelength of 530 nm, the partial reflecting mirror had an Rs/Rp of 3.0 and a reflectance difference between Rs and Rp of 50% at an incident angle of 30° and had a reflectance difference between Rs and Rp of 30% at an incident angle of 5°.

Other evaluation results for evaluation as a light-guiding member are shown in Table 1.

### Example 6

A light-guiding member was produced in the same way as in Example 2 with the exception that the light-guiding member obtained after injection molding was subjected to 1 hour of annealing at 115° C. prior to moving on to the step of performing vapor deposition on various surfaces.

The PV values of various surfaces were 2.1 μm for the light entry section, 3.2 μm for the outer side wave-guiding section, 8.5 μm for the eye side wave-guiding section, and 8.1 μm for the output coupler.

Other evaluation results for evaluation as a light-guiding member are shown in Table 1.

### Example 7

A light-guiding member was produced in the same way as in Example 2 with the exception that the light-guiding member obtained after injection molding was subjected to 4 hours of annealing at 85° C. prior to moving on to the step of performing vapor deposition on various surfaces.

The PV values of various surfaces were 1.0 μm for the light entry section, 2.2 μm for the outer side wave-guiding section, 5.1 μm for the eye side wave-guiding section, and 4.5 μm for the output coupler.

Other evaluation results for evaluation as a light-guiding member are shown in Table 1.

### Example 8

Dry blending was performed with respect to 100 parts by mass of the methacrylic resin composition A obtained in Synthesis Example 1 and 1.3 parts by mass of pentaerythritol tetrastearate (UNISTER H-476 produced by NOF Corporation), which is a fatty acid ester of a tetrahydric alcohol and a fatty acid. Using a vented twin-screw extruder (screw diameter: 30 mm; L/D=60; Omega 30H produced by STEER JAPAN Co., Ltd.), the obtained blended pellets were supplied into a hopper under a nitrogen atmosphere and were subjected to melt kneading at a cylinder temperature of 250° C. and a rate of a resin pressure of 10 kg/hr. The melt kneaded product was water cooled in a water bath and was subsequently pelletized by a pelletizer to obtain a resin composition H.

The obtained pellets had a weight-average molecular weight of 123,000 and a residual pentaerythritol tetrastearate content of 0.8 wt %. Production of a light-guiding member was then performed under the same conditions as in Example 2 with the exception that the resin composition obtained in this manner was used.

Other evaluation results for evaluation as a light-guiding member are shown in Table 1.

### Example 9

A light-guiding member was produced in the same way as in Example 8 with the exception that the light-guiding member obtained after injection molding was subjected to 4 hours of annealing at 85° C. prior to moving on to the step of performing vapor deposition on various surfaces.

Other evaluation results for evaluation as a light-guiding member are shown in Table 1.

### Examples 10 to 13

Production of a light-guiding member was performed under the same conditions as in Example 1 with the exception that the resin compositions B to E obtained in various synthesis examples were used.

Evaluation results for evaluation as a light-guiding member are shown in Table 2.

### Example 14

Dry blending was performed with respect to 100 parts by mass of the methacrylic resin composition F obtained in Synthesis Example 6 and 1.2 parts by mass of pentaerythritol distearate (UNISTER H-476D produced by NOF Corporation), which is a fatty acid ester of a tetrahydric alcohol and a fatty acid. Using a vented twin-screw extruder (screw diameter: 30 mm; L/D=60; Omega 30H produced by STEER JAPAN Co., Ltd.), the obtained blended pellets were supplied into a hopper under a nitrogen atmosphere and were subjected to melt kneading at a cylinder temperature of 250° C. and a rate of a resin pressure of 10 kg/hr. The melt kneaded product was water cooled in a water bath and was subsequently pelletized by a pelletizer to obtain a resin composition I.

The obtained pellets had a weight-average molecular weight of 90,000 and a residual pentaerythritol distearate content of 0.9 wt %. Other properties are recorded in the Table 2.

It was confirmed that in the cycloolefin copolymer of the obtained pellets, a specific amount of an olefin and tetracyclo[4.4.0.1^{2,5}.1^{7,10}]-3-dodecene were copolymerized in proportions of 62 mol % and 38 mol %, respectively. Moreover, the obtained pellets had a glass-transition temperature (Tg) of 137° C. and a flexural strength of 77 MPa. Furthermore, the oxygen weight proportion determined from the monomer composition ratio was 0 wt %.

The resin composition I obtained in this manner was injection molded in an injection molding machine (S-2000i50B produced by FANUC Corporation; screw diameter: 26 mm). A mold for a light-guiding member having the shape illustrated in FIG. 10A was used. The light entry section, the outer side wave-guiding section, the eye side wave-guiding section (inclusive of light exit section), and the output coupler are each a flat surface.

Molding of the light-guiding member was performed with the cylinder temperature set as 120° C. higher than Tg of the used resin composition and with the mold temperature set such that the actual temperature was 15° C. lower than Tg of the used resin composition. The holding pressure was set as 125 MPa for 5 seconds in a first stage and was subsequently set as 90 MPa for 3 seconds in a second stage in order to relieve stress and strain inside of the molded article. Moreover, injection molding was implemented with the injection rate set as an initial rate of 5 mm/s, reduced to 1 mm/s at a gate section, and with filling at 4 mm/s after passing the gate.

The obtained molded piece, while still in a state with the runner and the sprue remaining without cutting off the gate, was left for 1 day with the light-guiding member portion held in the air by hanging the sprue section on a test tube rack.

Thereafter, vapor deposition was performed in the same way as in Example 1, and various measurements were conducted.

The obtained molded piece was washed by ultrasonication using water and a surfactant as a washing liquid. The molded piece was vacuum dried at 80° C. for 6 hours and was then subjected to annealing. The molded piece was held inside of an oven at 130° C. for 2 hours, was then gradually cooled to 90° C. over 1 hour, was held for a further 1 hour after reaching 90° C., and was then removed from the oven. Vapor deposition was performed for an anti-reflection coating at the light entry section and a partial reflecting mirror having a reflectance of unpolarized light set as 35% at each of the outer side wave-guiding section, the eye side wave-guiding section, and the output coupler. At a wavelength of 530 nm, the partial reflecting mirror had an Rs/Rp of 1.8 and a reflectance difference between Rs and Rp of 17% at an incident angle of 30°. PV values of various surfaces were 1.8 μm for the light entry section, 3.3 μm for the outer side wave-guiding section, 6.5 μm for the eye side wave-guiding section, and 6.2 μm for the output coupler.

Other evaluation results for evaluation as a light-guiding member are shown in Table 2.

### Example 15

A light-guiding member was obtained in the same way as in Example 14 with the exception that conditions in the annealing step of Example 14 were changed to 4 hours of holding at 90° C.

The in-plane retardation in a wave-guiding section effective area (measurement performed with projected area of measurement area occupied at measurement subject surface set as 90% relative to projected area of entire measurement subject surface) was 5 nm. Moreover, the PV values of various surfaces were 1.0 μm for the light entry section, 1.2 μm for the outer side wave-guiding section, 3.6 μm for the eye side wave-guiding section, and 4.5 μm for the output coupler.

Other evaluation results for evaluation as a light-guiding member are shown in Table 2.

### Example 16

Production of a light-guiding member was performed under the same conditions as in Example 1 with the exception that the resin composition J obtained in Synthesis Example 8 was used. Evaluation results for evaluation as a light-guiding member are shown in Table 2.

### Comparative Example 1

A light-guiding member was produced in the same way as in Example 2 with the exception that the resin composition G obtained in Synthesis Example 7 was used.

The evaluation results are shown in Table 2.

### Comparative Example 2

A light-guiding member was produced in the same way as in Example 14 with the exception that the resin composition F obtained in Synthesis Example 6 was used in that form without compounding with pentaerythritol distearate, and an annealing step was not performed.

Evaluation results for evaluation as a light-guiding member are shown in Table 2.

### Comparative Example 3

A light-guiding member was produced in the same way as in Example 2 with the exception that ZEONEX K22R produced by Zeon Corporation was used as the resin composition.

Evaluation results for evaluation as a light-guiding member are shown in Table 2.

TABLE 1

| | | Exam- | Exam- | Exam- | Exam- | Exam- |
|---|---|---|---|---|---|---|
| | | ple 1 | ple 2 | ple 3 | ple 4 | ple 5 |
| Resin composition | — | A | A | A | A | A |
| Shape of light-guiding body | — | FIG. 10A | FIG. 10A | FIG. 10A | FIG. 10A | FIG. 10B |
| Polarized light reflectance of partial reflecting mirror | % | 35 | 35 | 40 | 50 | 50 |
| Flexural strength | MPa | 66 | 66 | 66 | 66 | 66 |
| Weight-average molecular weight | — | 125,000 | 125,000 | 125,000 | 125,000 | 125,000 |
| Glass-transition temperature (Tg) | ° C. | 133 | 133 | 133 | 133 | 133 |
| Absolute value of photoelastic coefficient (CR) | ×10⁻¹² | 0.2 | 0.2 | 0.2 | 0.2 | 0.2 |
| | Pa⁻¹ | | | | | |
| Retardation in effective area of light-guiding member | nm | 13 | 12 | 11 | 10 | 10 |
| Measurement of PV value of light-guiding member (light extraction section) | μm | 2.0 | 0.9 | 0.8 | 1.0 | 2.3 |
| Measurement of PV value of light-guiding member (outer side wave-guiding | μm | 7.1 | 1.4 | 1.5 | 1.6 | 3.2 |
| section) | | | | | | |
| Measurement of PV value of light-guiding member (eye side wave-guiding | μm | 12.3 | 3.6 | 3.7 | 3.7 | 4.7 |
| section) | | | | | | |
| Measurement of PV value of light-guiding member (output coupler) | μm | 10.4 | 4.2 | 4.5 | 4.7 | 4.9 |
| Polarized light reflectance ratio (Rs/Rp) of partial reflecting mirror | — | 1.8 | 1.8 | 1.4 | 1.3 | 3.0 |
| S-polarized light polarization retention characteristic (Tp/Tc) [blue LD] ÷ | % | 32 | 35 | 43 | 48 | 21 |
| (Rs/Rp) | | | | | | |
| S-polarized light polarization retention characteristic (Tp/Tc) [green LD] ÷ | % | 489 | 500 | 661 | 723 | 313 |
| (Rs/Rp) | | | | | | |
| S-polarized light polarization retention characteristic (Tp/Tc) [red LD] ÷ | % | 194 | 206 | 257 | 281 | 110 |
| (Rs/Rp) | | | | | | |
| P-polarized light polarization retention characteristic (Tp/Tc) [blue LD] × | % | 36 | 41 | 31 | 27 | 63 |
| (Rs/Rp) | | | | | | |
| P-polarized light polarization retention characteristic (Tp/Tc) [green LD] × | % | 95 | 101 | 80 | 73 | 168 |
| (Rs/Rp) | | | | | | |
| P-polarized light polarization retention characteristic (Tp/Tc) [red LD] × | % | 54 | 56 | 42 | 40 | 93 |
| (Rs/Rp) | | | | | | |
| S-polarized light Tp/T₀ [green LD] | % | 25 | 26 | 25 | 24 | 15 |
| P-polarized light Tp/T₀ [green LD] | % | 15 | 16 | 22 | 24 | 1 |
| Observed image evaluation (condition 1) | — | B | B | B | B | B |
| Observed image evaluation (condition 2) | — | D | A | A | A | B |

| | | Exam- | Exam- | Exam- | Exam- |
|---|---|---|---|---|---|
| | | ple 6 | ple 7 | ple 8 | ple 9 |
| Resin composition | — | A | A | H | H |
| Shape of light-guiding body | — | FIG. 10A | FIG. 10A | FIG. 10A | FIG. 10A |
| Polarized light reflectance of partial reflecting mirror | % | 35 | 35 | 35 | 35 |
| Flexural strength | MPa | 66 | 66 | 66 | 66 |
| Weight-average molecular weight | — | 125,000 | 125,000 | 123,000 | 123,000 |
| Glass-transition temperature (Tg) | ° C. | 133 | 133 | 133 | 133 |
| Absolute value of photoelastic coefficient (CR) | ×10⁻¹² | 0.2 | 0.2 | 0.1 | 0.1 |
| | Pa⁻¹ | | | | |
| Retardation in effective area of light-guiding member | nm | 3 | 9 | 3 | 18 |
| Measurement of PV value of light-guiding member (light extraction section) | μm | 2.1 | 1.0 | 0.8 | 1.0 |
| Measurement of PV value of light-guiding member (outer side wave-guiding | μm | 3.2 | 2.2 | 1.4 | 1.2 |
| section) | | | | | |
| Measurement of PV value of light-guiding member (eye side wave-guiding | μm | 8.5 | 4.9 | 3.3 | 3.6 |
| section) | | | | | |
| Measurement of PV value of light-guiding member (output coupler) | μm | 8.1 | 4.5 | 3.9 | 4.5 |
| Polarized light reflectance ratio (Rs/Rp) of partial reflecting mirror | — | 1.8 | 1.8 | 1.8 | 1.8 |
| S-polarized light polarization retention characteristic (Tp/Tc) [blue LD] ÷ | % | 43 | 36 | 36 | 49 |
| (Rs/Rp) | | | | | |
| S-polarized light polarization retention characteristic (Tp/Tc) [green LD] ÷ | % | 611 | 528 | 600 | 656 |
| (Rs/Rp) | | | | | |
| S-polarized light polarization retention characteristic (Tp/Tc) [red LD] ÷ | % | 228 | 211 | 211 | 250 |
| (Rs/Rp) | | | | | |
| P-polarized light polarization retention characteristic (Tp/Tc) [blue LD] × | % | 45 | 43 | 43 | 50 |
| (Rs/Rp) | | | | | |
| P-polarized light polarization retention characteristic (Tp/Tc) [green LD] × | % | 112 | 104 | 104 | 117 |
| (Rs/Rp) | | | | | |
| P-polarized light polarization retention characteristic (Tp/Tc) [red LD] × | % | 63 | 58 | 58 | 65 |
| (Rs/Rp) | | | | | |
| S-polarized light Tp/T₀ [green LD] | % | 27 | 26 | 26 | 28 |
| P-polarized light Tp/T₀ [green LD] | % | 16 | 16 | 16 | 17 |
| Observed image evaluation (condition 1) | — | A | B | B | A |
| Observed image evaluation (condition 2) | — | C | B | A | A |

TABLE 2

| | | Exam- | Exam- | Exam- | Exam- | Exam- |
|---|---|---|---|---|---|---|
| | | ple 10 | ple 11 | ple 12 | ple 13 | ple 14 |
| Resin composition | — | B | C | D | F | I |
| Shape of light-guiding body | — | FIG. 10A | FIG. 10A | FIG. 10A | FIG. 10A | FIG. 10A |
| Polarized light reflectance of partial reflecting mirror | % | 35 | 35 | 35 | 35 | 35 |
| Flexural strength | MPa | 95 | 98 | 127 | 59 | 77 |
| Weight-average molecular weight | — | 148,000 | 83,000 | 93,000 | 141,000 | 90,000 |
| Glass-transition temperature (Tg) | ° C. | 119 | 127 | 122 | 146 | 137 |
| Absolute value of photoelastic coefficient (CR) | ×10⁻¹² | 4.1 | 3.3 | 3.3 | 0.1 | 9.3 |
| | Pa⁻¹ | | | | | |
| Retardation in effective area of light-guiding member | nm | 18 | 4 | 5 | 8 | 3 |
| Measurement of PV value of light-guiding member (light extraction section) | μm | 1.4 | 1.7 | 1.3 | 2.5 | 1.8 |
| Measurement of PV value of light-guiding member (outer side wave-guiding | μm | 2 | 2.2 | 1.8 | 4.2 | 3.3 |
| section) | | | | | | |
| Measurement of PV value of light-guiding member (eye side wave-guiding | μm | 4.1 | 4.7 | 3.8 | 4.5 | 6.5 |
| section) | | | | | | |
| Measurement of PV value of light-guiding member (output coupler) | μm | 4.8 | 4.5 | 4.9 | 4.7 | 6.2 |
| Polarized light reflectance ratio (Rs/Rp) of partial reflecting mirror | — | 1.8 | 1.8 | 1.8 | 1.8 | 1.8 |
| S-polarized light polarization retention characteristic (Tp/Tc) [blue LD] ÷ | % | 28 | 28 | 28 | 28 | 33 |
| (Rs/Rp) | | | | | | |
| S-polarized light polarization retention characteristic (Tp/Tc) [green LD] ÷ | % | 306 | 333 | 417 | 233 | 433 |
| (Rs/Rp) | | | | | | |
| S-polarized light polarization retention characteristic (Tp/Tc) [red LD] ÷ | % | 139 | 147 | 183 | 110 | 161 |
| (Rs/Rp) | | | | | | |
| P-polarized light polarization retention characteristic (Tp/Tc) [blue LD] × | % | 27 | 29 | 36 | 22 | 38 |
| (Rs/Rp) | | | | | | |
| P-polarized light polarization retention characteristic (Tp/Tc) [green LD] × | % | 76 | 77 | 90 | 68 | 94 |
| (Rs/Rp) | | | | | | |
| P-polarized light polarization retention characteristic (Tp/Tc) [red LD] × | % | 45 | 47 | 54 | 34 | 52 |
| (Rs/Rp) | | | | | | |
| S-polarized light Tp/T₀ [green LD] | % | 24 | 23 | 24 | 23 | 25 |
| P-polarized light Tp/T₀ [green LD] | % | 14 | 12 | 14 | 13 | 15 |
| Observed image evaluation (condition 1) | — | B | B | B | B | B |
| Observed image evaluation (condition 2) | — | A | A | A | B | C |

| | | | | Compar- | Compar- | Compar- |
|---|---|---|---|---|---|---|
| | | | | ative | ative | ative |
| | | Exam- | Exam- | Exam- | Exam- | Exam- |
| | | ple 15 | ple 16 | ple 1 | ple 2 | ple 3 |
| Resin composition | — | I | J | G | F | ZEONEX |
| | | | | | | K22R |
| Shape of light-guiding body | — | FIG. 10A | FIG. 10A | FIG. 10A | FIG. 10A | FIG. 10A |
| Polarized light reflectance of partial reflecting mirror | % | 35 | 35 | 35 | 35 | 35 |
| Flexural strength | MPa | 77 | 110 | 71 | 78 | 115 |
| Weight-average molecular weight | — | 90,000 | 105,000 | 140,000 | 101,000 | — |
| Glass-transition temperature (Tg) | ° C. | 137 | 124 | 133 | 142 | — |
| Absolute value of photoelastic coefficient (CR) | ×10⁻¹² | 9.3 | 2.3 | 15 | 10.2 | 6.3 |
| | Pa⁻¹ | | | | | |
| Retardation in effective area of light-guiding member | nm | 5 | 20 | 41 | 36 | 95 |
| Measurement of PV value of light-guiding member (light extraction section) | μm | 1.0 | 3.0 | 2.1 | 1.5 | 1.3 |
| Measurement of PV value of light-guiding member (outer side wave-guiding | μm | 1.2 | 4.2 | 3.7 | 2.5 | 3.7 |
| section) | | | | | | |
| Measurement of PV value of light-guiding member (eye side wave-guiding | μm | 3.6 | 5.2 | 5.3 | 4.5 | 7.8 |
| section) | | | | | | |
| Measurement of PV value of light-guiding member (output coupler) | μm | 4.5 | 5.1 | 5.2 | 4.8 | 6.8 |
| Polarized light reflectance ratio (Rs/Rp) of partial reflecting mirror | — | 1.8 | 1.8 | 1.8 | 1.8 | 1.8 |
| S-polarized light polarization retention characteristic (Tp/Tc) [blue LD] ÷ | % | 31 | 11 | 4.4 | 6.7 | 2.8 |
| (Rs/Rp) | | | | | | |
| S-polarized light polarization retention characteristic (Tp/Tc) [green LD] ÷ | % | 372 | 82 | 2.5 | 17 | 1.8 |
| (Rs/Rp) | | | | | | |
| S-polarized light polarization retention characteristic (Tp/Tc) [red LD] ÷ | % | 133 | 40 | 1.1 | 7.2 | 0.4 |
| (Rs/Rp) | | | | | | |
| P-polarized light polarization retention characteristic (Tp/Tc) [blue LD] × | % | 34 | 13 | 8.1 | 16 | 5.9 |
| (Rs/Rp) | | | | | | |
| P-polarized light polarization retention characteristic (Tp/Tc) [green LD] × | % | 86 | 37 | 4.5 | 5.4 | 1.8 |
| (Rs/Rp) | | | | | | |
| P-polarized light polarization retention characteristic (Tp/Tc) [red LD] × | % | 50 | 31 | 4.0 | 5.0 | 2.7 |
| (Rs/Rp) | | | | | | |
| S-polarized light Tp/T₀ [green LD] | % | 24 | 23 | 22 | 22 | 21 |
| P-polarized light Tp/T₀ [green LD] | % | 14 | 11 | 9 | 9 | 8 |
| Observed image evaluation (condition 1) | — | B | B | D | C | D |
| Observed image evaluation (condition 2) | — | A | B | C | B | C |

It can be seen from Tables 1 and 2 that the light-guiding member of the present embodiment can provide a high-resolution image without image distortion while also inhibiting faults such as non-uniformity of brightness, non-uniformity of color, and rainbow effect even when a partial reflecting mirror having polarization selective reflectance characteristics is provided at an input coupler, a wave-guiding section, and/or an output coupler.

### Example 17

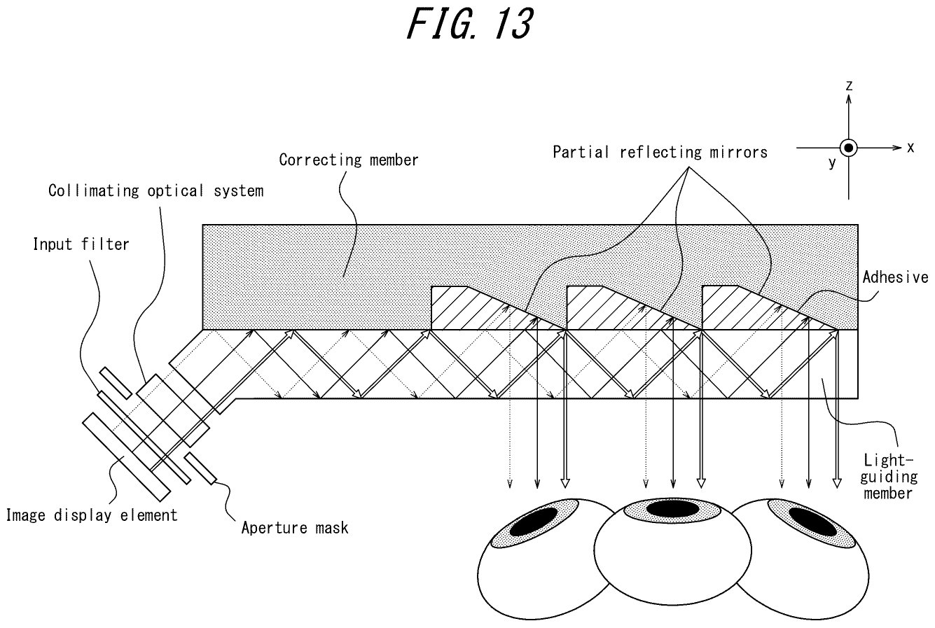

The methacrylic resin composition A obtained in Synthesis Example 1 was injection molded in an injection molding machine (S-2000i50B produced by FANUC Corporation; screw diameter: 26 mm). A mold for obtaining a light-guiding member (thickness between wave-guiding sections: 2.0 mm; projection length of light-guiding member in wave-guiding direction: 26 mm) and a correcting member having shapes illustrated in FIG. 13 was used. The light entry section, the outer side wave-guiding section, the eye side wave-guiding section (inclusive of light exit section), and the output coupler are each a flat surface.

Molding was performed with the cylinder temperature set as 125° C. higher than Tg of the used resin composition and with the mold temperature set such that the actual temperature was 15° C. lower than Tg of the used resin composition. The holding pressure was set as 105 MPa for 5 seconds in a first stage and was subsequently set as 70 MPa for 3 seconds in a second stage in order to relieve stress and strain inside of the molded article. Moreover, injection molding was implemented with the injection rate set as an initial rate of 5 mm/s, reduced to 1 mm/s at a gate section, and with filling at 4 mm/s after passing the gate so as to obtain the target light-guiding member and correcting member. The obtained molded piece, while still in a state with the runner and the sprue remaining without cutting off the gate, was left for 1 day inside of a room controlled to a temperature of 23° C. with the sprue in a plastic tray and the runner section fixed by cellophane tape such that the light-guiding member was held up in the air as illustrated in FIG. 12. The shape of each surface of the light-guiding member and correcting member was measured using an NH-3SPs (produced by Mitaka Kohki Co., Ltd.), and the molding conditions were adjusted as appropriate for obtaining a specific shape so as to obtain a light-guiding member having the specific shape.

Next, the light-guiding member was washed by ultrasonication using water and a surfactant as a washing liquid. The light-guiding member was vacuum dried at 70° C. for 6 hours, and then vapor deposition was performed for an anti-reflection coating at the light entry section of the light-guiding member and a partial reflecting mirror having a reflectance of unpolarized light set as 35% at each of the outer side wave-guiding section, the eye side wave-guiding section, and the output coupler of the light-guiding member. At a wavelength of 530 nm, the partial reflecting mirror had an Rs/Rp of 1.8 and a reflectance difference between Rs and Rp of 17% at an incident angle of 30°.

The light-guiding member and the correcting member were bonded together using an adhesive. When an image display element, an input filter, a collimating optical system, and an aperture mask were arranged and an image was viewed, it was possible to observe a good image from multiple eyepoints.

This application claims the benefit of foreign priority to Japanese Patent Application No. JP2024-177492, filed Oct. 9, 2024, which is incorporated by reference in its entirety.

### INDUSTRIAL APPLICABILITY

The light-guiding member according to the present disclosure can suitably be used as a light-guiding member for head-mounted displays and other such ocular optical system applications.

1. An injection molded light-guiding member used in an image display device having an ocular optical system that guides light toward an eyeball of an observer from an image display element, the injection molded light-guiding member comprising:
a substrate section;
an input coupler for causing light from the image display element to enter into a light-guiding body;
two surfaces of a wave-guiding section that are opposite to each other and that guide incident light through repeated reflection; and
an output coupler for extracting light toward an eye of the observer from the light-guiding member through any function among refraction, diffraction, and reflection of guided light, wherein
an absolute value of a photoelastic coefficient is 10×10⁻¹² Pa⁻¹ or less,
a partial reflecting mirror that transmits a portion and reflects a remaining portion of light is formed at at least one surface among a total of three surfaces consisting of the two surfaces of the wave-guiding section and a surface of the output coupler,
the partial reflecting mirror has a difference of reflectance of not less than 10% and less than 40% between first polarized light that is S-polarized light upon reflection by the partial reflecting mirror and P-polarized light that is second polarized light orthogonal to the first polarized light at an incident angle of 30°,
the wave-guiding section has an in-plane retardation of 20 nm or less in an effective area thereof, and
the substrate section is formed from a thermoplastic resin composition having a cyclic structure in a main chain or a side chain and has a glass-transition temperature (Tg) of 115° C. to 150° C.

2. The injection molded light-guiding member according to claim 1, wherein
a minimum distance between the two surfaces of the wave-guiding section is not less than 0.6 mm and not more than 25 mm,
a projection length of the light-guiding member in a wave-guiding direction is not less than 10 mm and not more than 50 mm, and
the two surfaces of the wave-guiding section each have a PV value of 10.0 μm or less in an effective area where light is guided.

3. The injection molded light-guiding member according to claim 1, wherein
one of the two surfaces of the wave-guiding section is an outer side wave-guiding section, and
the partial reflecting mirror that transmits a portion and reflects a remaining portion of light is formed at the outer side wave-guiding section.

4. The injection molded light-guiding member according to claim 1, wherein, in a situation in which first polarized light having a wavelength of 500 nm to 600 nm that is S-polarized light in reflection by the wave-guiding section enters, is guided by the wave-guiding section, and is subsequently extracted from a light extraction section via the output coupler, a value determined when a ratio Tp/Tc of an amount of light Tp that is extracted via a polarizing plate arranged with a transmission axis matching an axis of the first polarized light and an amount of light Tc that is extracted via a polarizing plate arranged with a transmission axis orthogonal to the axis of the first polarized light is divided by a ratio Rs/Rp of reflectance of S-polarized light and reflectance of P-polarized light by the partial reflecting mirror at a surface where the ratio Rs/Rp is largest is 5 or more.

5. The injection molded light-guiding member according to claim 4, wherein the value determined when the ratio Tp/Tc is divided by the ratio Rs/Rp at the surface where the ratio Rs/Rp is largest is 10 or more.

6. The injection molded light-guiding member according to claim 1, wherein the partial reflecting mirror that transmits a portion and reflects a remaining portion of light is formed at the output coupler.

7. The injection molded light-guiding member according to claim 1, wherein the thermoplastic resin composition contains 0.5 mass % to 2.8 mass % of a higher fatty acid ester.

8. The injection molded light-guiding member according to claim 1, wherein the thermoplastic resin composition is a methacrylic resin composition.

9. A head-mounted display comprising the injection molded light-guiding member according to claim 1.

10. The head-mounted display according to claim 9, wherein at either or both of a light output section and an eye side wave-guiding section, reflectance of S-polarized light is larger than reflectance of P-polarized light at an incident angle of 5°, and a difference between the reflectance of S-polarized light and the reflectance of P-polarized light is 5% or more.

11. The head-mounted display according to claim 9, wherein
the partial reflecting mirror that transmits a portion and reflects a remaining portion of light is formed at part or all of both of the two surfaces of the wave-guiding section, and
light is guided at an incident angle that is smaller than a critical angle of the substrate section.

12. The head-mounted display according to claim 9, wherein a linear polarizing plate is included on a straight line that joins the eyeball of the observer and the output coupler of the light-guiding member and that extends to the outside world.

13. The head-mounted display according to claim 9, wherein a linear polarizing plate and a half-wave plate or a retardation layer that imparts half-wave retardation are included in order from an outside world side on a straight line that joins the eyeball of the observer and the output coupler of the light-guiding member and that extends to the outside world.

14. The injection molded light-guiding member according to claim 2, wherein
one of the two surfaces of the wave-guiding section is an outer side wave-guiding section, and
the partial reflecting mirror that transmits a portion and reflects a remaining portion of light is formed at the outer side wave-guiding section.

15. The injection molded light-guiding member according to claim 2, wherein, in a situation in which first polarized light having a wavelength of 500 nm to 600 nm that is S-polarized light in reflection by the wave-guiding section enters, is guided by the wave-guiding section, and is subsequently extracted from a light extraction section via the output coupler, a value determined when a ratio Tp/Tc of an amount of light Tp that is extracted via a polarizing plate arranged with a transmission axis matching an axis of the first polarized light and an amount of light Tc that is extracted via a polarizing plate arranged with a transmission axis orthogonal to the axis of the first polarized light is divided by a ratio Rs/Rp of reflectance of S-polarized light and reflectance of P-polarized light by the partial reflecting mirror at a surface where the ratio Rs/Rp is largest is 5 or more.

16. The injection molded light-guiding member according to claim 2, wherein the partial reflecting mirror that transmits a portion and reflects a remaining portion of light is formed at the output coupler.

17. The injection molded light-guiding member according to claim 2, wherein the thermoplastic resin composition contains 0.5 mass % to 2.8 mass % of a higher fatty acid ester.

18. The injection molded light-guiding member according to claim 2, wherein the thermoplastic resin composition is a methacrylic resin composition.

19. A head-mounted display comprising the injection molded light-guiding member according to claim 2.

20. The head-mounted display according to claim 19, wherein:
at either or both of a light output section and an eye side wave-guiding section, reflectance of S-polarized light is larger than reflectance of P-polarized light at an incident angle of 5°, and a difference between the reflectance of S-polarized light and the reflectance of P-polarized light is 5% or more;
the partial reflecting mirror that transmits a portion and reflects a remaining portion of light is formed at part or all of both of the two surfaces of the wave-guiding section, and light is guided at an incident angle that is smaller than a critical angle of the substrate section;
a linear polarizing plate is included on a straight line that joins the eyeball of the observer and the output coupler of the light-guiding member and that extends to the outside world; or
a linear polarizing plate and a half-wave plate or a retardation layer that imparts half-wave retardation are included in order from an outside world side on a straight line that joins the eyeball of the observer and the output coupler of the light-guiding member and that extends to the outside world.
